(19) United States
(12) Patent Application Publication
(10) Pub. No.: US 2016/0290036 A1
(43) Pub. Date: Oct. 6, 2016

(54) HEAT-SHIELDING MATERIAL AND WINDOW GLASS

(71) Applicant: FUJIFILM Corporation, Tokyo (JP)

(72) Inventors: Katsuyuki NUKUI, Ashigarakami-gun (JP); Yuki NAKAGAWA, Ashigarakami-gun (JP); Hideki YASUDA, Ashigarakami-gun (JP)

(73) Assignee: FUJIFILM Corporation, Tokyo (JP)

(21) Appl. No.: 15/185,742

(22) Filed: Jun. 17, 2016

Related U.S. Application Data
(63) Continuation of application No. PCT/JP2014/083084, filed on Dec. 15, 2014.

(30) Foreign Application Priority Data
Dec. 18, 2013 (JP) 2013-261826

(51) Int. Cl. E06B 5/00; G02B 5/28; E06B 9/24; C09D 175/04; C09D 4/00

(52) U.S. Cl. CPC E06B 5/00; C09D 175/04; C09D 4/00; E06B 9/24; G02B 5/281; E06B 2009/2417

(57) ABSTRACT

Provided is a heat-shielding material including a substrate; a metal particle-containing layer which contains flat metal particles with a hexagonal shape or a circular shape; and a low refractive index layer with a refractive index of 1.45 or less, in which flat metal particles in which a principle planar surface of the flat metal particles is set with a planar orientation in a range of 0° to ±30° on average with respect to the other surface of the metal particle-containing layer are 50% by number or more of all the flat metal particles, the low refractive index layer is arranged on an uppermost surface on an indoor side when installing the heat-shielding material on a window glass, and the heat-shielding performance, visible light transmittance, and lightfastness in the heat-shielding material are excellent; and a window glass.

### CROSS-REFERENCE TO RELATED APPLICATIONS

This application is a Continuation of PCT International Application No. PCT/JP2014/083084, filed on Dec. 15, 2014, which claims priority under 35 U.S.C. Section 119(a) to Japanese Patent Application No. 2013-261826 filed on Dec. 18, 2013. Each of the above applications is hereby expressly incorporated by reference, in its entirety, into the present application.

### BACKGROUND OF THE INVENTION

1. Field of the Invention

The present invention relates to a heat-shielding material and a window glass. In particular, the present invention relates to a heat-shielding material in which the heat-shielding performance, visible light transmittance, and lightfastness are excellent, and a window glass which has the heat-shielding material.

2. Description of the Related Art

In recent years, materials with a heat-shielding property for car or building windows have been developed as an energy saving measure for reducing carbon dioxide. From the point of view of the heat-shielding property (the solar heat gain coefficient), a heat-reflecting material, with which there is no reradiation, is more desirable than a heat-absorbing material with which there is reradiation (an amount of approximately ⅓ of the absorbed solar radiation energy) of the absorbed light into a room, and various such materials have been proposed. In a case where the application to car or building windows is considered, it is preferable that the appearance is highly transparent, the heat-shielding performance is high, and the transmittance of useful electric waves emitted by mobile phones or the like is excellent. Furthermore, heat-shielding materials which have excellent durability are preferable. In terms of the durability, a performance known as lightfastness is particularly important and it is preferable that sunlight does not cause the material itself to easily deteriorate and become brittle and also that the sunlight does not cause the heat-shielding performance itself to easily decrease.

JP2011-221149A discloses producing a heat-shielding material by setting the planar orientation of flat metal particles on a substrate and including a heterocyclic compound of which the silver interaction potential EAg is less than −1 mV in the heat-shielding material. Due to this, an effect of improving lightfastness is obtained.

JP2007-248841A discloses a near infrared absorbing antireflection film which has a near infrared absorbing layer on a substrate, which is formed by providing a hard coat layer and a low refractive index layer in order on the opposite side of the substrate to the surface on which the near infrared absorbing layer is provided, and which is able to be used in a plasma display panel. In JP2007-248841A, a highly transparent infrared absorbing antireflection film is obtained by applying a low refractive index layer as an antireflection layer. However, the antireflection film in JP2007-248841A absorbs infrared rays and, in a case where the near infrared ray absorbing antireflection film in JP2007-248841A is used as a heat-shielding material for rays of sunlight in a window glass such as a housing construction material, the near infrared ray absorbing antireflection film has high solar absorptivity and reaches high temperatures since the near infrared ray absorbing antireflection film absorbs some of the rays of sunlight. Therefore, in a case of installing the near infrared ray absorbing antireflection film in JP2007-248841A on a window glass for construction materials or the like, the window glass of a portion which comes into contact with a high temperature film reaches high temperatures while the window glass portion (a glass portion which is incorporated into a sash frame) on which the film is not installed does not reach high temperatures. Thus, there is a difference in temperature in the window glass between the portion where the film is installed and the sash frame portion, there is a difference in the thermal expansion, and the window glass is cracked by the resulting mechanical distortion, leading to so-called heat cracking, which is not preferable.

### SUMMARY OF THE INVENTION

In recent years, there has been a demand for a heat-shielding material which has a higher heat-shielding performance and higher visible light transmittance than in the related art and, in a case of producing a high performance heat-shielding material using flat metal particles, the thickness of the flat metal particles needs to be thinner. This is due to the fact that the visible light absorbance is reduced by the flat metal particles and that it is possible to expect an effect of reducing the light scattering of the visible light due to the flat metal particles. However, it has become clear from the research of the present inventors that, in a case where the flat metal particles are simply made to be thin in order to obtain a heat-shielding material with higher performance, there is a new problem in that the lightfastness of the heat-shielding material deteriorates as the thickness of the particles is reduced.

The problem that the present invention is to solve is to provide a heat-shielding material in which the heat-shielding performance, visible light transmittance, and lightfastness are excellent.

When the present inventors researched the method described in JP2011-221149A in order to solve the problem described above, it was understood that, in a case of making flat metal particles thin in order to obtain a heat-shielding material of which the lightfastness is able to be improved while having higher visible light transmittance, it is not possible to obtain a heat-shielding material which has sufficient lightfastness simply by applying only the technique in JP2011-221149A.

When the present inventors carried out further intensive research, it was discovered that, in a heat-shielding material which has a metal particle-containing layer where the planar orientation of flat metal particles with a specific shape is set, by providing a low refractive index layer of which the refractive index is in a specific range on the uppermost surface on the indoor side when installing the heat-shielding material on a window glass, it is possible to provide a heat-shielding material in which the heat-shielding performance, visible light transmittance, and lightfastness are excellent compared to the techniques in the related art, and the present invention was completed.

The present invention, which is a specific means for solving the problem described above, is as follows.

[1] A heat-shielding material comprising a substrate, a metal particle-containing layer which contains flat metal particles with a hexagonal shape to a circular shape, and a low refractive index layer with a refractive index of 1.45 or less, in which flat metal particles in which a planar orientation of a principle planar surface of the flat metal particles is set in a range of 0° to ±30° on average with respect to the other surface of the metal particle-containing layer are 50% by number or more of all the flat metal particles, and the low refractive index layer is arranged on an uppermost surface on an indoor side when installing the heat-shielding material on a window glass.
[2] The heat-shielding material according to [1], in which an average particle thickness of the flat metal particles is preferably 11 nm or less.
[3] The heat-shielding material according to [1] or [2], in which a refractive index n and a thickness d of the low refractive index layer preferably satisfies a relationship of Formula (1) below,

(550 nm÷4)×0.70<n×d<(550 nm÷4)×1.3. Formula (1)

[4] The heat-shielding material according to any one of [1] to [3], in which an aspect ratio of the flat metal particles is preferably 2 to 80.
[5] The heat-shielding material according to any one of [1] to [4], further comprising low refractive index particles in the low refractive index layer, in which the low refractive index particles are preferably hollow particles or porous particles.
[6] The heat-shielding material according to [5], in which the low refractive index particles are preferably silica.
[7] The heat-shielding material according to any one of [1] to [6], in which the low refractive index layer is preferably formed by curing a curable resin composition which includes a fluorine-containing polyfunctional monomer, the fluorine-containing polyfunctional monomer preferably has three or more polymeric groups selected from a (meth)acryloyl group, an allyl group, an alkoxysilyl group, an α-fluoroacryloyl group, an epoxy group, and —C(O)OCH═CH₂, a fluorine content ratio is preferably 35.0 mass % or more of molecular weight of the fluorine-containing polyfunctional monomer, a calculated value of all of the molecular weight between crosslinks is preferably 300 or less when polymerizing the polymeric groups, and the heat-shielding material is preferably represented by Formula (1) below,

Rf{-(L)ₘ-Y}ₙ Formula (1):

in the formula, Rf represents a n-valent group selected from f-1 to f-10 below, n represents an integer of 3 or greater, L represents any of an alkylene group with 1 to 10 carbon atoms, an arylene group with 6 to 10 carbon atoms, —O—, —S—, —N(R)—, a group which is obtained by combining an alkylene group with 1 to 10 carbon atoms with —O—, —S—, or —N(R)—, or a group which is obtained by combining an arylene group with 6 to 10 carbon atoms and —O—, —S—, or —N(R)—, here, R represents a hydrogen atom or an alkyl group with 1 to 5 carbon atoms, m represents 0 or 1, Y represents a polymeric group selected from a (meth)acryloyl group, an allyl group, an alkoxysilyl group, an α-fluoroacryloyl group, an epoxy group, and —C(O)OCH═CH₂;

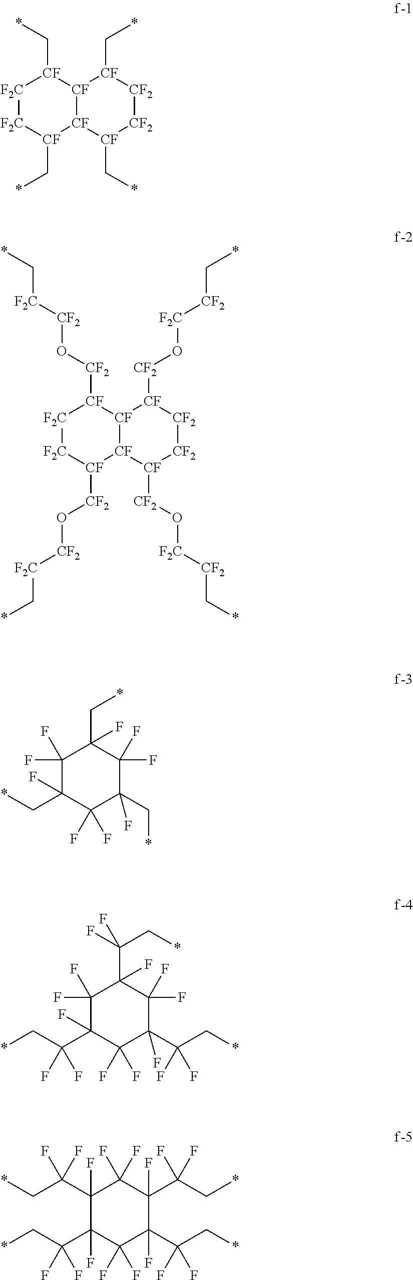

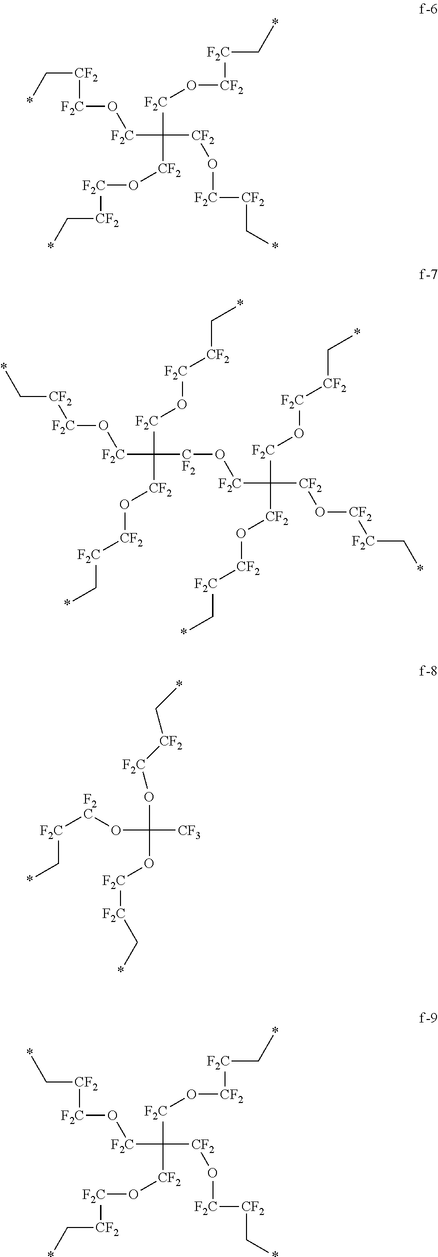 [SMILES: *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C* ; *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C* ; *CC(F)(F)C(F)(F)OC(OC(F)(F)C(F)(F)C*)(OC(F)(F)C(F)(F)C*)C(F)(F)F ; *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C*]

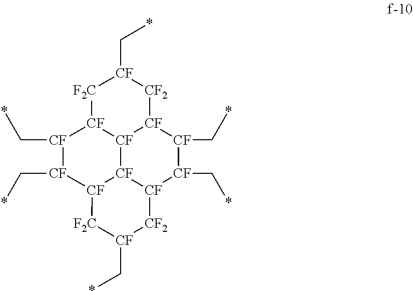

in f-1 to f-10, * represents a position where -(L)ₘ-Y is bonded.

[8] The heat-shielding material according to any one of [1] to [7], in which the low refractive index layer, the substrate, and the metal particle-containing layer are preferably laminated in this order.
[9] The heat-shielding material according to any one of [1] to [8], in which the low refractive index layer, the substrate, the metal particle-containing layer, and a glass for a window glass are preferably laminated in this order.
[10] The heat-shielding material according to any one of [1] to [9], preferably further comprising a hard coat layer between the low refractive index layer and the substrate.
[11]A window glass comprising the heat-shielding material according to any one of [1] to [10].

### Effects of the Invention

According to the present invention, it is possible to provide a heat-shielding material in which the heat-shielding performance, visible light transmittance, and lightfastness are excellent.

### BRIEF DESCRIPTION OF THE DRAWINGS

FIG. 1 is a schematic diagram which illustrates an example of a heat-shielding material of the present invention.

FIG. 2 is a schematic diagram which illustrates another example of the heat-shielding material of the present invention.

FIG. 3 is a schematic diagram which illustrates another example of the heat-shielding material of the present invention.

FIG. 4A is a schematic diagram which illustrates another example of the heat-shielding material of the present invention.

FIG. 4B is a schematic diagram which illustrates another example of the heat-shielding material of the present invention.

FIG. 5A is a schematic diagram which illustrates an example of the heat-shielding material of the present invention where an overcoat layer and an adhesive layer are installed on the heat-shielding material seen in FIG. 1 to FIG. 4B.

FIG. 5B is a schematic diagram which illustrates an example where the heat-shielding material seen in FIG. 5A is installed on a window glass.

FIG. 6A is a schematic cross-sectional diagram which illustrates a state in which a metal particle-containing layer which includes flat metal particles is present in the heat-shielding material of the present invention and illustrates a diagram which illustrates an angle (θ) between the metal particle-containing layer (also in parallel with the planar surface of the substrate) which includes flat metal particles and the principle planar surface (a surface which determines a circle equivalent diameter D) of flat metal particles.

FIG. 6B is a schematic cross-sectional diagram which illustrates a state in which a metal particle-containing layer which includes flat metal particles is present in the heat-shielding material of the present invention and a diagram which illustrates a region in which the flat metal particles are present in the depth direction of the heat-shielding material of the metal particle-containing layer.

FIG. 6C is a schematic cross-sectional diagram which illustrates another example of the state in which the metal particle-containing layer which includes the flat metal particles is present in the heat-shielding material of the present invention.

FIG. 6D is a schematic cross-sectional diagram which illustrates another example of the state in which the metal particle-containing layer which includes the flat metal particles is present in the heat-shielding material of the present invention.

FIG. 6E is a schematic cross-sectional diagram which illustrates another example of the state in which the metal particle-containing layer which includes the flat metal particles is present in the heat-shielding material of the present invention.

FIG. 6F is a schematic cross-sectional diagram which illustrates another example of the state in which the metal particle-containing layer which includes the flat metal particles is present in the heat-shielding material of the present invention.

FIG. 7A is a schematic perspective diagram which illustrates an example of a shape of a flat metal particle which is preferably used for the heat-shielding material of the present invention and illustrates a flat metal particle with a circular shape.

FIG. 7B is a schematic perspective diagram which illustrates an example of a shape of a flat metal particle which is preferably used for the heat-shielding material of the present invention and illustrates a flat metal particle with a hexagonal shape.

### DESCRIPTION OF THE PREFERRED EMBODIMENTS

Detailed description will be given below of the heat-shielding material of the present invention.

The description of the constituent elements described below is based on representative embodiments of the present invention; however, the present invention is not limited to the embodiments. Here, the numeric value ranges which are represented by “to” in the present specification signify ranges which include the numeric values described before and after “to” as the lower limit value and the upper limit value.

[Heat-Shielding Material]

The heat-shielding material of the present invention has a substrate, a metal particle-containing layer which contains flat metal particles with a hexagonal shape to a circular shape, and a low refractive index layer with a refractive index of 1.45 or less, in which, in the flat metal particles, flat metal particles of which the principle planar surface is set to a planar orientation in a range of 0° to ±30° on average with respect to the other surface of the metal particle-containing layer are 50% by number or more of all of the flat metal particles, and the low refractive index layer is arranged on an uppermost surface on an indoor side when installing the heat-shielding material on a window glass.

By having this configuration, the heat-shielding performance, visible light transmittance, and lightfastness in the heat-shielding material are excellent.

A mechanism which is able to satisfy both the heat-shielding performance and the visible light transmittance is as follows. Light is reflected at an interface where the refractive index difference is great. For example, approximately 4% light reflection occurs at a wavelength of 550 nm at the interface of a medium with a refractive index of 1.5 and air (refractive index 1.0). When considering a case where a heat-shielding material is adhered to the indoor side of a window glass and light is incident from the outside of the room, light is reflected according to the refractive index difference of each of the interfaces of air/glass, glass/heat-shielding material, heat-shielding material/air, and the like. In particular, the visible light transmittance is lost due to light reflection by an interface of heat-shielding material/air. In order to obtain a highly transparent heat-shielding material, it is favorable to reduce light reflection at the interface of heat-shielding material/air and, in the present invention, it is considered that by providing an antireflection layer with a refractive index of n (for example, 1.45 or less) and a thickness d on the uppermost surface on the indoor side of the heat-shielding material, both the heat-shielding performance and the visible light transmittance are satisfied, that is, an improved visible light transmittance is realized in a case where a specific heat-shielding coefficient is exhibited.

In the present invention, by providing an antireflection layer on the uppermost surface on the indoor side of the heat-shielding material, it is possible to satisfy both the heat-shielding performance and the visible light transmittance at the same time and also to further improve the lightfastness of the heat-shielding material due to the flat metal particles. The details are not clear; however, it is assumed that the effects are obtained by the following mechanism. Regarding the flat metal particles, even light reflected by the air interface on the indoor side will cause light irradiation which will deteriorate the performance (photooxidation is generated in the metals which configure the flat metal particles, the shape of the flat metal particles changes from a flat form to a spherical form and, as a result, there is a decrease in the reflection of infrared light and an increase in the absorption of visible light). Installing an antireflection layer on the uppermost surface on the indoor side of the heat-shielding material reduces the light reflection at the air interface on the indoor side and, due to this, the amount of light with which the flat metal particles are irradiated is reduced. It is considered that, as a result, the lightfastness of the flat metal particles is improved.

<Characteristics of Heat-Shielding Material>

As the visible light transmittance of the heat-shielding material of the present invention, the visible light transmittance at a shielding coefficient of 0.690 is preferably 75% or more, more preferably 76% or more, particularly preferably 77% or more, more particularly preferably 78% or more, and even more particularly preferably 80% or more. When the visible light transmittance described above is 75% or more, for example, it is preferable from the point of view that it is easy to see the outside when being used as a glass for cars or glass for buildings.

The ultraviolet ray transmittance of the heat-shielding material of the present invention is preferably 5% or less and more preferably 2% or less.

In the heat-shielding material of the present invention, the infrared ray (also referred to as the infrared light or heat ray) maximum reflection rate at the early stage (before irradiating Xe in the lightfastness test which will be described below) in the range of 800 nm to 2,500 nm is preferably 20% or more, more preferably 25% or more, particularly preferably 26% or more, and more particularly preferably 27% or more.

In the heat-shielding material of the present invention, the lightfastness of the infrared ray maximum reflection rate in the range of 800 nm to 2,500 nm is high. In detail, the infrared ray maximum reflection rate after irradiating Xe in the lightfastness test which will be described below is preferably 24% or more, more preferably 25% or more, and particularly preferably 26% or more. In addition, the change of the infrared ray maximum reflection rate before irradiating Xe and after irradiating Xe in the lightfastness test which will be described below (a value obtained by subtracting the infrared ray maximum reflection rate after irradiating Xe from the infrared ray maximum reflection rate before irradiating Xe) is preferably less than 4.5%, more preferably less than 4%, particularly preferably less than 3%, more particularly preferably less than 2.5%, and even more particularly preferably less than 2%. The closer the absolute value of the change in the infrared ray maximum reflection rate is to 0%, the better the lightfastness.

In the heat-shielding material of the present invention, the maximum reflection wavelength is preferably in a band of 700 nm to 1,800 nm from the point of view of increasing the efficiency of the heat ray reflection. The maximum reflection wavelength described above is more preferably in a band of 750 nm to 1,400 nm and particularly preferably in a band of 800 nm to 1,100 nm. The maximum reflection wavelength refers to the wavelength when indicating the infrared ray maximum reflection rate.

In the heat-shielding material, the average heat ray reflection rate at 700 nm to 1,200 nm is preferably 5% or more, more preferably 7% or more, particularly preferably 8% or more, and more particularly preferably 10% or more.

In the heat-shielding material, at least one layer preferably has the lowest transmission spectrum peak in a region of 800 nm to 2,000 nm from the point of view of decreasing the heat transmittance. The lowest peak wavelength of the transmission spectrum described above is more preferably in a band of 750 nm to 1,400 nm and particularly preferably in a band of 800 nm to 1,100 nm. In addition, in the heat-shielding material, the metal particle-containing layer preferably has the lowest peak of the transmission spectrum in a region of 800 nm to 2,000 nm.

In the heat-shielding material of the present invention, the transmission haze at the early stage (before irradiating Xe in the lightfastness test which will be described below) is preferably 3% or less, more preferably 2.6% or less, particularly preferably 2% or less, and more particularly preferably less than 1.5%. The value of the transmission haze is preferably small since the contrast of the view seen through the heat-shielding material is increased.

In the heat-shielding material of the present invention, the lightfastness of the transmission haze is high. In detail, the transmission haze after irradiating Xe in the lightfastness test which will be described below is more preferably 2.6% or less, particularly preferably 2% or less, and more particularly preferably less than 1.5%. In addition, the change in the transmission haze before irradiating Xe and after irradiating Xe in the lightfastness test which will be described below (a value obtained by subtracting the transmission haze after irradiating Xe from the transmission haze before irradiating Xe) is preferably more than −0.5% to 0% or less, more preferably more than −0.3% to 0% or less, and even more particularly preferably −0.2% to 0%. The closer the absolute value of the change in the transmission haze is to 0%, the better the lightfastness.

<Configuration of Heat-Shielding Material>

The heat-shielding material of the present invention has a substrate, a metal particle-containing layer which contains flat metal particles with a hexagonal shape to a circular shape, and a low refractive index layer with a refractive index of 1.45 or less. Furthermore, aspects which have other layers such as an overcoat layer, an adhesive layer, an ultraviolet ray absorbing layer, a metal oxide particle-containing layer, a back coat layer, a hard coat layer, an infrared ray absorbing agent-containing hard coat layer, an insulating layer, a protective layer, an infrared ray absorbing compound-containing layer, a metal particle reflection adjusting refractive index layer, and a glass for a window glass as necessary are also preferable.

Description will be given below of a preferable configuration of the heat-shielding material of the present invention based on the diagrams.

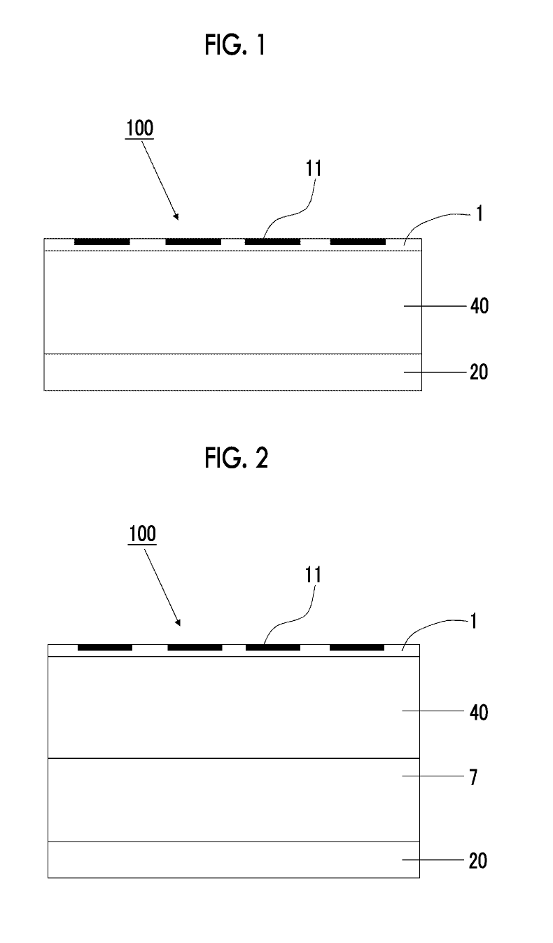

As in the example shown in FIG. 1, examples of the layer configuration of the heat-shielding material of the present invention include an aspect where a heat-shielding material 100 has a metal particle-containing layer 1 on one surface of a substrate 40 and has a low refractive index layer 20 on the surface on the opposite side of the surface of the substrate 40 which has a metal particle-containing layer 1. The metal particle-containing layer 1 contains flat metal particles 11 with a hexagonal shape to a circular shape.

FIG. 2 is another example of the present invention and is an aspect further having a hard coat layer 7 between the low refractive index layer 20 described above and the substrate 40 described above in the aspect in FIG. 1.

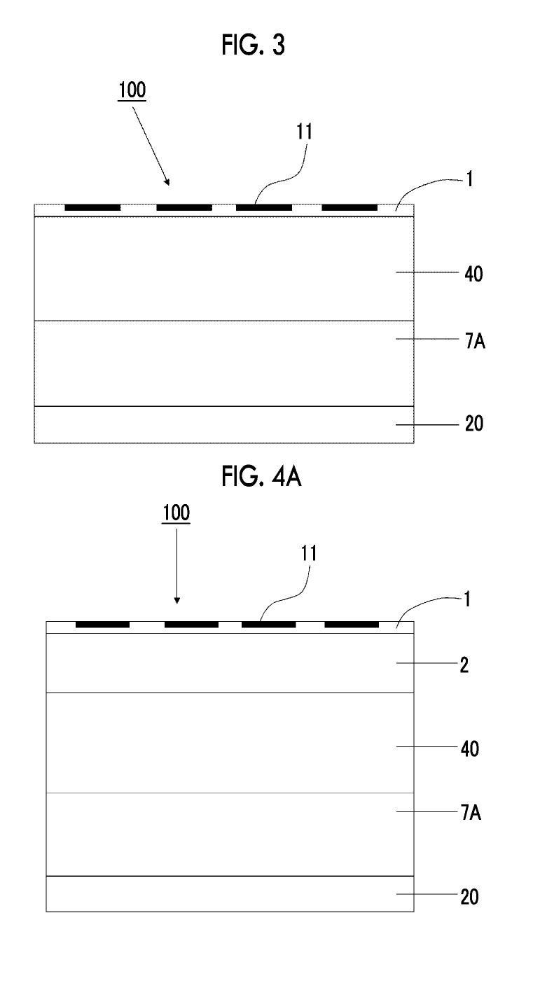

FIG. 3 is another example of the present invention and an aspect having an infrared ray absorbing agent-containing hard coat layer 7A instead of the hard coat layer 7 between the low refractive index layer 20 described above and the substrate 40 described above in the aspect in FIG. 2.

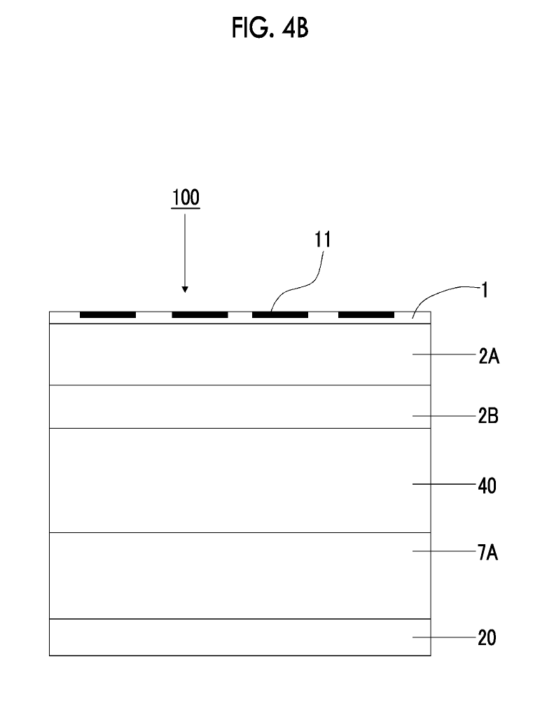

FIG. 4A is another example of the present invention and an aspect having a metal particle reflection adjusting refractive index layer 2 between the substrate 40 and the metal particle-containing layer 1 described above in the aspect in FIG. 3.

FIG. 4B is another example of the present invention, an aspect of an example where the metal particle reflection adjusting refractive index layer 2 in FIG. 4A has two or more layers, and an aspect where a second metal particle reflection adjusting refractive index layer 2B, a first metal particle reflection adjusting refractive index layer 2A, and the metal particle-containing layer 1 are laminated on the substrate 40 in this order.

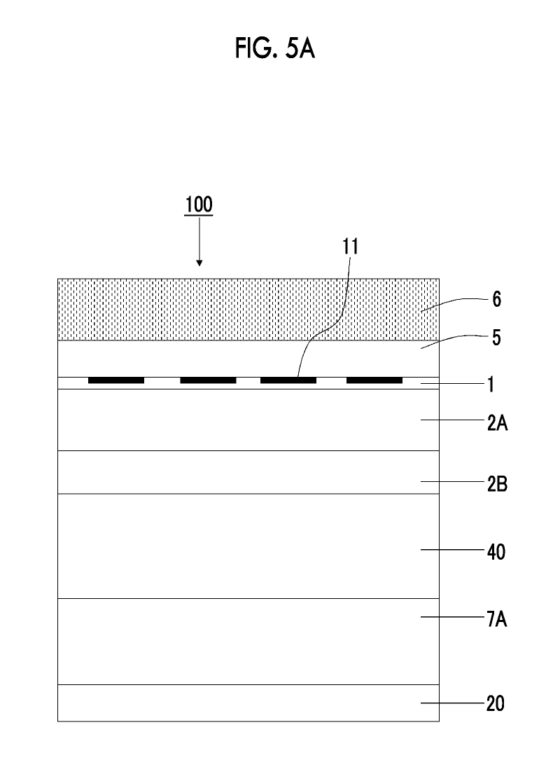

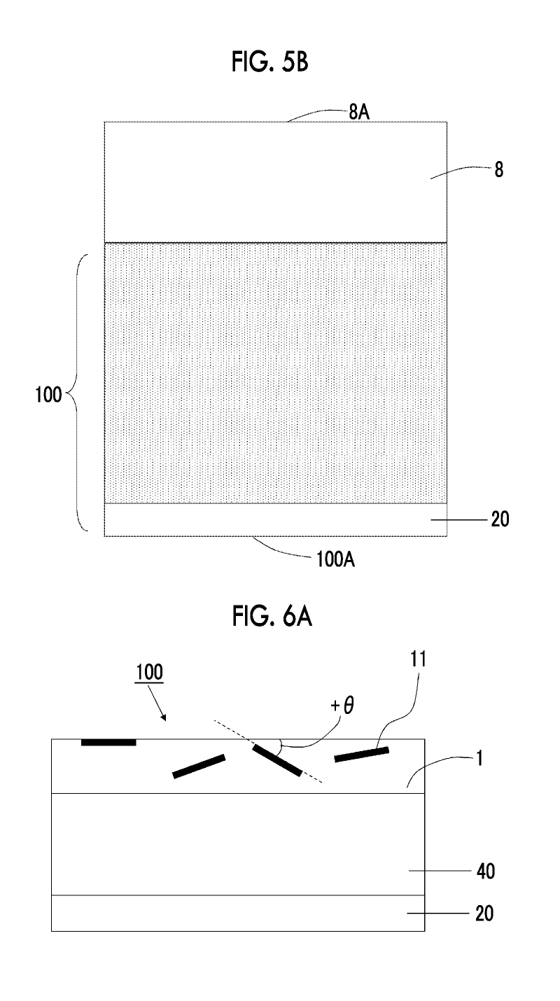

FIG. 5A is another example of the present invention and an aspect in a case of installing an overcoat layer 5 and an adhesive layer 6 in this order on a surface on the opposite side of the surface on the substrate side of the metal particle-containing layer 1 in the aspect in FIG. 4B. The aspect in FIG. 4B is used as a typical example; however, an aspect of installing the overcoat layer 5 and the adhesive layer 6 in the aspect in FIG. 1, FIG. 2, FIG. 3, and FIG. 4A is also preferable.

As shown in FIG. 5B, when adhering the heat-shielding material 100 to a window glass 8, the low refractive index layer 20 is arranged on the uppermost surface on the indoor side when installing the heat-shielding material 100 on the window glass 8.

Here, the installation is preferably carried out on the window glass 8 via an adhesive layer which is included in the heat-shielding material 100 and which is not shown in the diagram.

The upper parts in FIG. 5B are the outdoor side and the lower parts are the indoor side. That is, the surface 8A on the outdoor side of the window glass out of both surfaces of the window glass 8 is arranged outside and the low refractive index layer 20 is arranged on a surface 100A on the indoor side of the heat-shielding material.

<Metal Particle Reflection Adjusting Refractive Index Layer>

The heat-shielding material of the present invention is preferably formed by providing at least one or more metal particle reflection adjusting refractive index layers between the metal particle-containing layer described above and the substrate described above.

With the metal particle reflection adjusting refractive index layers, the heat-shielding performance is higher and the visible light transmittance is higher in the heat-shielding material.

The material which configures the metal particle reflection adjusting refractive index layer in the present invention may be any of a metal thin film, a metal oxide thin film, or a polymer-containing layer. From the point of view of electromagnetic wave transmittance, a metal oxide thin film or a polymer-containing layer is preferable, and, from the point of view of productivity, a polymer-containing layer on which water-based coating is easy is preferable. A polymer (a binder) which is used for the metal particle reflection adjusting refractive index layer is preferably a transparent polymer and examples of the polymer described above include a polyvinyl acetal resin, a polyvinyl alcohol resin, a polyvinyl butyral resin, a polyacrylate resin, a polymethyl methacrylate resin, a polycarbonate resin, a polyvinylchloride resin, a (saturated) polyester resin, a polyurethane resin, and polymers such as natural polymers such as gelatin and cellulose. Among these, in the present invention, the main polymer of the polymer described above is preferably a polyvinyl alcohol resin, a polyvinyl butyral resin, a polyvinylchloride resin, a (saturated) polyester resin, and a polyurethane resin and, among these, a (saturated) polyester resin and a polyurethane resin are preferable.

The polymer described above which is used for the metal particle reflection adjusting refractive index layer is preferably an aqueous dispersion from the point of view of the effect on the environment and in terms of reducing the coating cost.

As the polymer described above which is used for the metal particle reflection adjusting refractive index layer, it is possible to preferably use PLASCOAT Z-592 (produced by Goo Chemical Co., Ltd.) which is a water-soluble polyester resin, HYDRAN HW-350 (produced by DIC Corporation) which is a water-soluble polyurethane resin, or the like.

The thickness of the metal particle reflection adjusting refractive index layer is preferably 20 nm or more, more preferably 30 nm or more, and even more preferably 40 nm or more. The upper limit is 1,000 nm, but is not particularly limited.

Here, in a case where the metal particle reflection adjusting refractive index layer is formed of two or more layers, the total thickness of each of the layers is preferably within the ranges described above.

The heat-shielding material may have an infrared ray absorbing compound-containing layer. When the infrared ray absorbing compound-containing layer is included in the heat-shielding material, the metal particle-containing layer and the infrared ray absorbing compound-containing layer are preferably not adjacent and another layer is preferably inserted between the metal particle-containing layer and the infrared ray absorbing compound-containing layer. Furthermore, a filler is preferably contained in at least one of the inserted other layer and the infrared ray absorbing compound-containing layer. In such an aspect, it is possible to obtain a heat-shielding material with high visible light transmittance and excellent moisture and heat durability, which is preferable.

—Filler—

The heat-shielding material of the present invention preferably contains a filler in at least one of the metal particle reflection adjusting refractive index layer described above and the infrared ray absorbing compound-containing layer described above.

The filler described above is preferably selected from at least one or more from a group formed of titanium oxide, zirconium oxide, zinc oxide, amorphous synthetic silica, colloidal silica, hollow silica, porous silica, magnesium fluoride, and hollow magnesium fluoride. Among these, titanium oxide, zirconium oxide, hollow silica, and magnesium fluoride are preferably used.

Containing the filler described above in at least one of the metal particle reflection adjusting refractive index layer described above and the infrared ray absorbing compound-containing layer described above makes it possible to adjust the refractive index of the layer which contains the filler, which is preferable. It is preferable to impart a refractive index difference to between adjacent layers and it is possible to design a multilayer optical interference film by adjusting the refractive index differences and film thicknesses of each layer. Appropriately designing the multilayer optical interference film, for example, makes it possible to impart an effect of reducing the reflection in a visible light wavelength region or of increasing the reflection in an infrared ray wavelength region.

The average particle diameter of the filler which is used for the heat-shielding material of the present invention is 200 nm or less, preferably 100 nm or less, and more preferably 60 nm or less. When the average particle diameter of the filler is 200 nm or more, it is difficult to make the layer which contains the filler a thin film, which is not preferable in a case of considering the optical interference design.

The content of the filler in the metal particle reflection adjusting refractive index layer is preferably 10 mg/m² to 250 mg/m², more preferably 30 mg/m² to 150 mg/m², and even more preferably 40 mg/m² to 100 mg/m².

In a case of having a binder and a filler in the metal particle reflection adjusting refractive index layer, the mass ratio of the filler with respect to the binder is preferably 0.1 to 2.5, more preferably 0.1 to 2.0, and particularly preferably 0.5 to 1.5. When the mass ratio of the filler with respect to the binder is smaller than 0.1, the effect of preventing the infrared ray absorbing compound from permeating into the metal particle-containing layer is low, which is not preferable since the wet heat aging resistance is poor, and when the mass ratio of the filler with respect to the binder is larger than 2.5, the physical film strength of the metal particle reflection adjusting refractive index layer is weak, which is not preferable.

The metal particle reflection adjusting refractive index layer may have a multilayer structure with two or more layers by respectively laminating layers with different refractive indexes as shown in the example in FIG. 4B or FIG. 5A. Having layers with different refractive indexes makes it possible to impart an effect of reducing the reflection in a visible light wavelength region or of increasing the reflection in an infrared ray wavelength region. Examples of a method for adjusting layers with different refractive indexes include a method for laminating a layer which contains zirconium oxide with a high refractive index and a layer which contains hollow silica with a low refractive index, a method for laminating a layer which includes a binder with high refractive index and a layer which includes a binder with low refractive index, and the like.

Favorable examples of a preferable aspect of the metal particle reflection adjusting refractive index layer of the heat-shielding material of the present invention also include an aspect which has a first metal particle reflection adjusting refractive index layer of which the refractive index is n1 as a layer A, has a second metal particle reflection adjusting refractive index layer of which the refractive index is n2 as a layer B, has a layer C as a substrate, and satisfies Condition (1-1) or Condition (2-1) as shown in FIG. 4B or FIG. 5A.

Condition (1-1): n1<n2 and Formula (1-1) below is satisfied.

3λ/8+mλ/2−A<n1×d1<3λ/8+mλ/2+λ Formula (1-1)

(In Formula (1-1), m represents an integer of 0 or greater, λ represents a wavelength (unit: nm) where it is desired to prevent reflection, n1 represents the refractive index of the layer A, and d1 represents the thickness (unit: nm) of the layer A. n1×d1 is preferably a predetermined value ±A, A preferably represents either λ/8, λ/12, or λ/16, and A is preferably small since the smaller A is, the closer to the optimum conditions for obtaining an antireflection interference effect.)

Condition (2-1): n1>n2 and Formula (2-1) below is satisfied.

λ/8+mλ/2−A<n1×d1<λ/8+mλ/2+A Formula (2-1)

(In Formula (2-1), m represents an integer of 0 or greater, λ represents a wavelength (unit: nm) where it is desired to prevent reflection, n1 represents the refractive index of the layer A, and d1 represents the thickness (unit: nm) of the layer A. n1×d1 is preferably a predetermined value ±A, A preferably represents any of λ/8, λ/12, or λ/16, and A is preferably small since the smaller A is, the closer to the optimum conditions for obtaining an antireflection interference effect.)

Description will be given of preferable ranges of Condition (1-1) or Condition (2-1) described above. Here, the following preferable ranges of Condition (1-1) or Condition (2-1) described above are the same as in the heat-shielding material of the present invention other than the configurations in FIG. 4B or FIG. 5A. In Formula (1-1) described above and Formula (2-1) described above, m represents an integer of 0 or greater and is preferably an integer of 0 to 5 from the point of view of the manufacturing cost or robustness of the film thickness. m described above is more preferably an integer of 1 to 5 from the point of view that a design which suppresses the visible light reflection and increases the near infrared light reflection is possible when using a metal particle reflection adjusting refractive index layer with a multilayer structure as the heat-shielding material, and particularly preferably 1 from the point of view of suppressing the visible light reflection and increasing the reflection of near infrared rays in the vicinity of 1,000 nm. Here, it is possible to increase the reflection, by controlling the refractive index and the thickness of the layer B described above so as to satisfy Formula (5-1) which will be described below. In addition, since the film thickness is excessively large and precise control of the film thickness is difficult when m>5, m<=5 is preferable from the point of view of productivity. On the other hand, m described above is preferably 0 in some cases from the point of view of reducing hue changes in diagonal incident light or the point of view of suppressing increases in the reflected light.

In the configuration in FIG. 4B or FIG. 5A, the layer B described above preferably further satisfies Condition (3-1) or Condition (4-1) from the point of view of obtaining a better reflection prevention effect.

Condition (3-1): n1<n2 and Formula (3-1) below is satisfied

λ/4+Lλ/4−A≦n2×d2≦λ/4+Lλ/4+A Formula (3-1)

(In Formula (3-1), L represents an integer of 1 or greater, λ represents a wavelength (unit: nm) where it is desired to prevent reflection, n2 represents the refractive index of the layer B, and d2 represents the thickness (unit: nm) of the layer B. n2×d2 are preferably a predetermined value ±A, A preferably represents any of λ/8, λ/12, or λ/16, and A is preferably small since the smaller A is, the closer to the optimum conditions for obtaining an antireflection interference effect.)

Condition (4-1): n1<n2 and Formula (4-1) below is satisfied

Lλ/4−A≦n2×d2Lλ/4+A Formula (4-1)

(In Formula (4-1), L represents an integer of 1 or greater, λ represents a wavelength (unit: nm) where it is desired to prevent reflection, n2 represents the refractive index of the layer B, and d2 represents the thickness (unit: nm) of the layer B. n2×d2 are preferably a predetermined value ±A, A preferably represents any of λ/8, λ/12, or λ/16, and A is preferably small since the smaller A is, the closer to the optimum conditions for obtaining an antireflection interference effect.)

Description will be given of a preferable range of Condition (3-1) or Condition (4-1). Here, the following preferable range of Condition (3-1) or Condition (4-1) described above is the same as in the heat-shielding material of the present invention other than the configuration in FIG. 4B or FIG. 5A.

In Formula (3-1) described above or Formula (4-1) described above, L represents an integer of 1 or greater, preferably 1 to 5, and more preferably 1 from the point of view of reducing hue changes with respect to diagonal incident light.

In the configuration in FIG. 4B or FIG. 5A, the layer B described above preferably further satisfies Condition (5-1) or Condition (6-1) from the point of view of increasing reflection in a wavelength λ′ where strong reflection is desired.

λ/4+kλ′/4−B≦n2×d2≦λ/4+kλ′/4+B Formula (5-1)

(In Formula (5-1), k represents an integer of 1 or greater, λ′ represents a wavelength (unit: nm) where strong reflection is desired, n2 represents the refractive index of the layer B, and d2 represents the thickness (unit: nm) of the layer B. n2×d2 is preferably a predetermined value ±B, B preferably represents any of λ′/8, λ′/12, or λ′/16, and B is preferably small since the smaller B is, the closer to the optimum conditions for obtaining an reflection increasing interference effect.)

kλ′/4−B≦n2×d2≦kλ′/4+B Formula (6-1)

(In Formula (6-1), k represents an integer of 1 or greater, λ′ represents a wavelength (unit: nm) where strong reflection is desired, n2 represents the refractive index of the layer B, and d2 represents the thickness (unit: nm) of the layer B. n2×d2 is preferably a predetermined value ±B, B preferably represents any of λ′/8, λ′/12, or λ′/16, and B is preferably small since the smaller B is, the closer to the optimum conditions for obtaining an reflection increasing interference effect.)

Description will be given of a preferable range of Condition (5-1) or Condition (6-1) described above. Here, the following preferable range of Condition (5-1) or Condition (6-1) described above is the same as in the heat-shielding material of the present invention other than the configuration in FIG. 4B or FIG. 5A.

In Formula (5-1) described above or Formula (6-1) described above, k represents an integer of 1 or greater, preferably 1 to 5, and more preferably 1 from the point of view of reducing hue changes with respect to the diagonal incident light.

The wavelength λ where it is desired to prevent strong reflection described above is not particularly limited and examples thereof include visible light, ultraviolet rays of each band, and the like, and, among these, visible light is preferable from the point of view of increasing visible light transmittance, and, in the heat-shielding material of the present invention, the wavelength λ where it is desired to prevent strong reflection described above is preferably 250 nm to 800 nm, more preferably 400 nm to 700 nm, and particularly preferably 550±100 nm.

The wavelength λ′ where strong reflection is desired described above is not particularly limited and examples thereof include visible light, infrared light, ultraviolet rays of each band, and the like, and, among these, infrared light is preferable from the point of view of being used as a heat-shielding material, and, in the heat-shielding material of the present invention, the wavelength λ′ where reflection is desired described above is preferably 700 nm to 2,500 nm, more preferably 800 nm to 1,500 nm, and particularly preferably 900 nm to 1,200 nm.

When a wavelength of less than 700 nm has strong reflection, red reflected light strongly stands out, which causes reduction in the visible light transmittance. On the other hand, when a wavelength greater than 2,500 nm has reflection, the effect as a heat-shielding material is small since sunlight spectrum has hardly any energy at 2,500 nm or greater.

The metal particle reflection adjusting refractive index layer described above is not particularly limited and is able to be appropriately selected according to the purpose; however, for example, a matting agent and a surfactant may be contained and, moreover, other components may be contained as necessary.

<Laminate Configuration>

The heat-shielding material of the present invention has at least a substrate, a metal particle-containing layer which contains flat metal particles with a hexagonal shape to a circular shape, and a low refractive index layer with a refractive index of 1.45 or less.

In the heat-shielding material of the present invention, the low refractive index layer, the substrate, and the metal particle-containing layer are preferably laminated in this order.

In the heat-shielding material of the present invention, the low refractive index layer, the substrate, the metal particle-containing layer, and a glass for a window glass are preferably laminated in this order.

The heat-shielding material of the present invention preferably further has a hard coat layer between the low refractive index layer and the substrate.

The layer which is laminated between the substrate and the metal particle-containing layer may have a laminate configuration formed by one or more metal particle reflection adjusting refractive index layers, infrared ray absorbing compound-containing layers, and lower layers (which will be described below). When carrying out the laminating, regarding the substrate, the metal particle-containing layer, and the layers which are laminated between the metal particle-containing layer and another substrate thereof, it is preferable to design the refractive index and coating film thickness of each layer so as to satisfy any of the conditions of Formulas (1-1) to (6-1) described above from the point of view of reducing the reflection at a specific wavelength (when the reflection of visible light is reduced, the visible light transmittance is improved) and the point of view of increasing the reflection in the infrared ray wavelength region. It is preferable to satisfy any of the conditions of Formulas (1-1) to (6-1) described above, in particular, by applying as large a refractive index difference as possible between adjacent layers since it is possible to more strongly obtain the effects from the points of view described above.

<Low Refractive Index Layer>

The heat-shielding material of the present invention has a low refractive index layer with a refractive index of 1.45 or less and the low refractive index layer is arranged on the uppermost surface on the indoor side when installing the heat-shielding material on a window glass. Arranging the low refractive index layer on the uppermost surface on the indoor side reduces the refractive index difference at an interface between air and the heat-shielding material, which brings an effect of reducing the light reflection.

The refractive index of the low refractive index layer is 1.45 or less, preferably 1.40 or less, and more preferably 1.35 or less. The lower limit value of the refractive index of the low refractive index layer is not particularly limited and the refractive index of the low refractive index layer is preferably as low as possible from the point of view of reducing the refractive index difference at the interface between the air and the heat-shielding material.

In the heat-shielding material of the present invention, the refractive index n and the thickness d of the low refractive index layer preferably satisfy the relationship of Formula (1) below.

(550 nm÷4)×0.7<n×d<(550 nm÷4)×1.3 Formula (1)

The refractive index n and the thickness d of the low refractive index layer more preferably satisfy the relationship of Formula (1′) below.

(550 nm÷4)×0.8<n×d<(550 nm÷4)×1.2 Formula (1′)

The refractive index n and the thickness d of the low refractive index layer particularly preferably satisfy the relationship of Formula (1″) below.

(550 nm÷4)×0.9<n×d<(550 nm÷4)×1.1 Formula (1″)

Here, the thickness of the low refractive index layer is not particularly limited; however, from the point of view of easily satisfying the relationship of Formula (1) described above, 65 nm to 200 nm is preferable, and 75 nm to 150 nm is more preferable.

The low refractive index layer of the heat-shielding material of the present invention is not particularly limited as long as the refractive index after creating a film is 1.45 and the low refractive index layer is a layer formed by curing a composition which includes a thermoplastic polymer, a thermosetting polymer, an energy radiation curable polymer, an energy radiation curable monomer, and the like as a binder by heat drying or irradiating energy radiation and examples thereof include a layer where low refractive particles with a low refractive index are dispersed in a binder, a layer where low refractive particles with a low refractive index are polycondensed or cross-linked with a monomer and a polymerization initiator, a layer which includes a binder with a low refractive index, and the like.

As long as the refractive index is 1.45 or less, the film may be a film which is produced from a composition which is applied to the metal particle reflection adjusting refractive index layer described above and examples of the thermoplastic polymer are as described above. Examples of the energy radiation curable polymer are not particularly limited but include UNIDIC EKS-675 (an ultraviolet ray curable resin produced by DIC Corporation) and the like. The energy radiation curable monomer is not particularly limited; however, fluorine-containing polyfunctional monomers and the like which will be described below are preferable.

(Fluorine-Containing Polyfunctional Monomers)

Fluorine-containing polyfunctional monomers may be included in the composition which is used when providing the low refractive index layer which is used in the heat-shielding material of the present invention. The fluorine-containing polyfunctional monomer described above is a fluorine-containing compound which has an atomic group (also referred to below as a “fluorine-containing core section”) which is mainly formed by a plurality of fluorine atoms and carbon atoms (here, may include oxygen atoms and/or hydrogen atoms in a part) and which substantially does not contribute to polymerization and three or more polymeric groups which have a polymeric property such as a radical polymeric property, a cation polymeric property, a condensation polymeric property, or the like via a linking group such as an ester bond or an ether bond, and preferably has 5 or more polymeric groups, and more preferably 6 or more.

Furthermore, in the fluorine-containing polyfunctional monomers described above, the fluorine content is preferably 35 mass % or more of the fluorine-containing polyfunctional monomers described above, more preferably 40 mass % or more, and even more preferably 45 mass % or more. When the fluorine content in the fluorine-containing polyfunctional monomer described above is 35 mass % or more, it is possible to reduce the refractive index of the polymer and the average reflection rate of the coated film decreases, which is preferable.

The fluorine-containing polyfunctional monomer described above which has 3 or more polymeric groups may be a cross-linking agent where a polymeric group is a cross-linking group.

The fluorine-containing polyfunctional monomer described above is preferably represented by Formula (1′) below.

Rf′{-(L′)ₘ-Y′}ₙ Formula (1′)

In the formula, Rf′ represents a chain or cyclic n-valent fluorinated hydrocarbon group which includes at least a carbon atom and a fluorine atom and which may include an oxygen atom and/or a hydrogen atom and n represents an integer of 3 or greater. L′ represents a divalent linking group and m represents 0 or 1. Y′ represents a polymeric group.

More detailed description will be given below of a compound which is represented by Formula (1′).

Rf′ represents a “fluorine-containing core section” and represents a chain or cyclic n-valent fluorinated hydrocarbon group which includes at least a carbon atom and a fluorine atom and which may include an oxygen atom and/or a hydrogen atom.

The number of hydrogen atoms/the number of fluorine atoms in Rf′ is ¼ or less and preferably 1/9 or less. When the number of hydrogen atoms/the number of fluorine atoms in Rf′ is ¼ or less, the antifouling property is favorable, which is preferable. On the other hand, when the number of hydrogen atoms/the number of fluorine atoms in Rf′ exceeds ¼, the refractive index of the polymer increases and the average reflection rate of the coated film increases, which is not preferable. n represents an integer of 3 or greater and n is preferably 4 or greater and more preferably 5 or greater. Rf′ is preferably a group where the molecular weight between crosslinks in a case where all the polymeric groups are polymerized is all 300 or less and description will be given below of the molecular weight between crosslinks.

Specific examples of particular representatives of the “fluorine-containing core section” which is represented by Rf′ include the following.

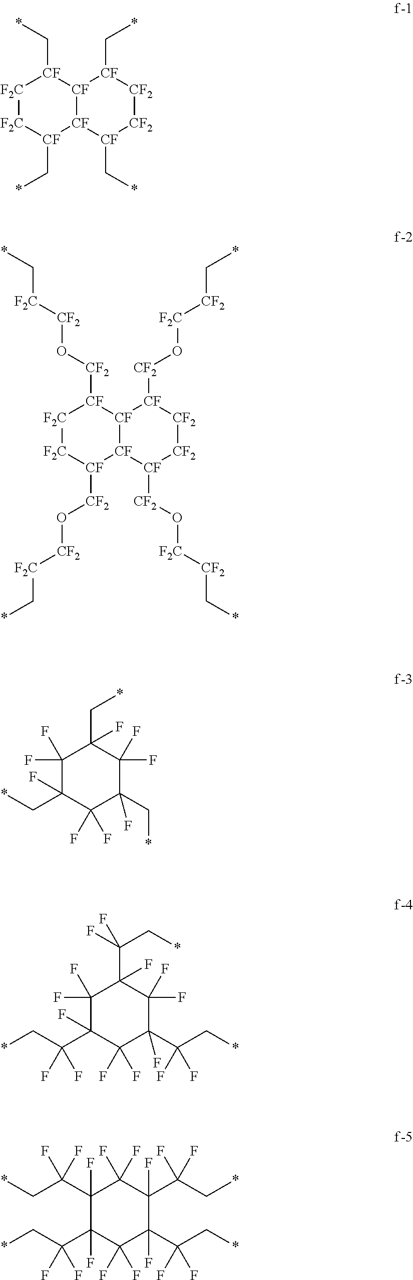

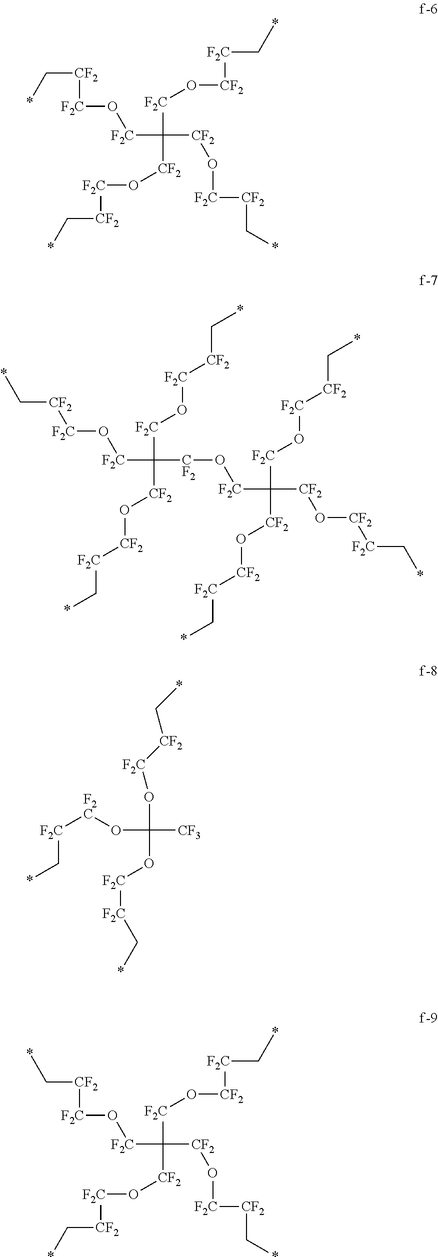

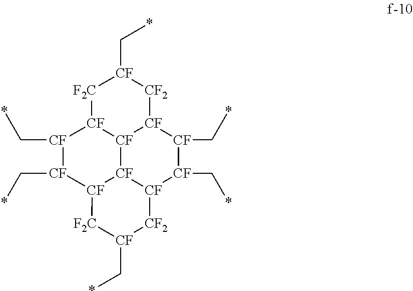

In f-1 to f-10, * represents a position at which -(L′)ₘ-Y′ or -(L)ₘ-Y in Formula (1) which will be described below is bonded.

Y′ is preferably a radical, cation, or condensed polymeric group and is particularly preferably selected from a (meth)acryloyl group, an allyl group, an alkoxysilyl group, an α-fluoroacryloyl group, an epoxy group, and —C(O)OCH═CH₂. Among these, from the point of view of the polymeric property, a (meth)acryloyl group, an allyl group, an α-fluoroacryloyl group, an epoxy group, and —C(O)OCH—CH₂ which have a radical or cation polymeric property are preferable, and a (meth)acryloyl group, an allyl group, an α-fluoroacryloyl group, and —C(O)OCH═CH₂ which have a radical polymeric property are more preferable.

L′ represents a divalent linking group and specifically represents an alkylene group with 1 to 10 carbon atoms, an arylene group with 6 to 10 carbon atoms, —O—, —S—, —N(R)—, a group which is obtained by combining an alkylene group with 1 to 10 carbon atoms with —O—, —S—, or —N(R)—, and a group which is obtained by combining an arylene group with 6 to 10 carbon atoms with —O—, —S—, or —N(R)—. R represents a hydrogen atom or an alkyl group with 1 to 5 carbon atoms. In a case where L′ represents an alkylene group or an arylene group, the alkylene group and the arylene group which are represented by L are preferably substituted by a halogen atom and preferably substituted by a fluorine atom.

More preferable fluorine-containing polyfunctional monomers described above are represented by Formula (1) from the point of view of the refractive index and the polymeric property.

Rf{-(L)ₘ-Y}ₙ Formula (1):

In the formula, Rf represents an n-valent group selected from f-1 to f-10 below, n represents an integer of 3 or greater, L represents any of an alkylene group with 1 to 10 carbon atoms, an arylene group with 6 to 10 carbon atoms, —O—, —S—, —N(R)—, a group which is obtained by combining an alkylene group with 1 to 10 carbon atoms with —O—, —S—, or —N(R)—, or a group which is obtained by combining an arylene group with 6 to 10 carbon atoms and —O—, —S—, or —N(R)—, here, R represents a hydrogen atom or an alkyl group with 1 to 5 carbon atoms, m represents 0 or 1, Y represents a polymeric group selected from a (meth)acryloyl group, an allyl group, an alkoxysilyl group, an α-fluoroacryloyl group, an epoxy group, and —C(O)OCH═CH₂;

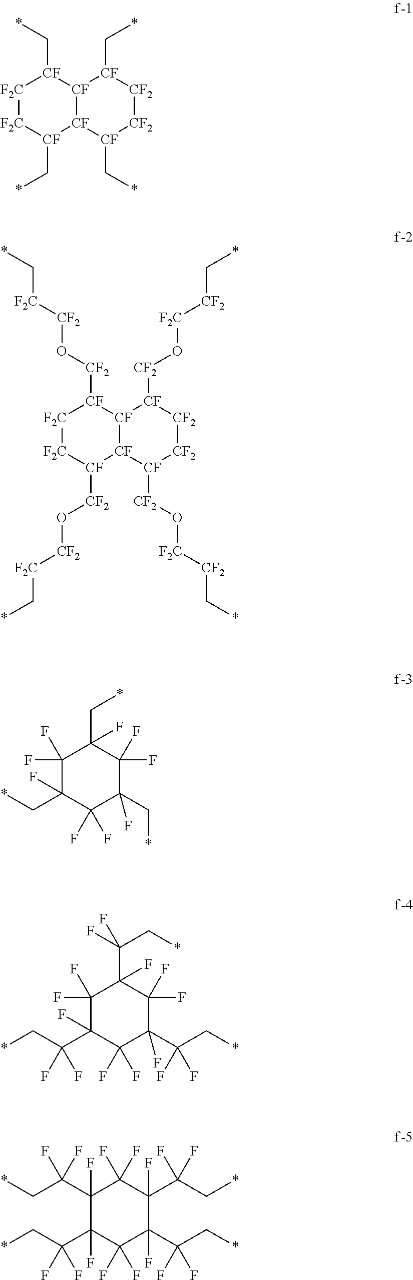

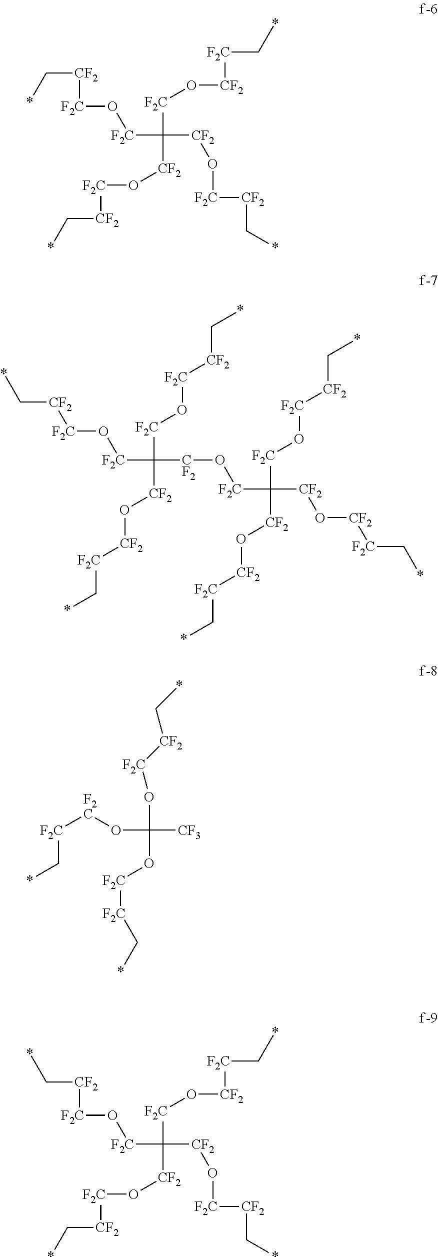

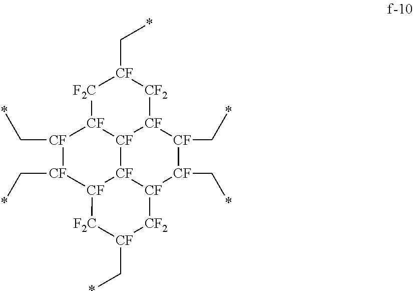

In f-1 to f-10, * represents a position at which -(L)ₘ-Y is bonded.

Even more preferable fluorine-containing polyfunctional monomers are represented by Formula (2) or (3) from the point of view of the refractive index and the polymeric property.

Rf′-{CH₂—OC(O)CH═CH₂}ₙ Formula (2)

Rf′-{C(O)OCHCH₂}ₙ Formula (3)

In the formulas described above, Rf′ and n represent the same as in Formula (1).

Preferable specific examples of the fluorine-containing monomers described above will be given below; however, the present invention is not limited thereto.

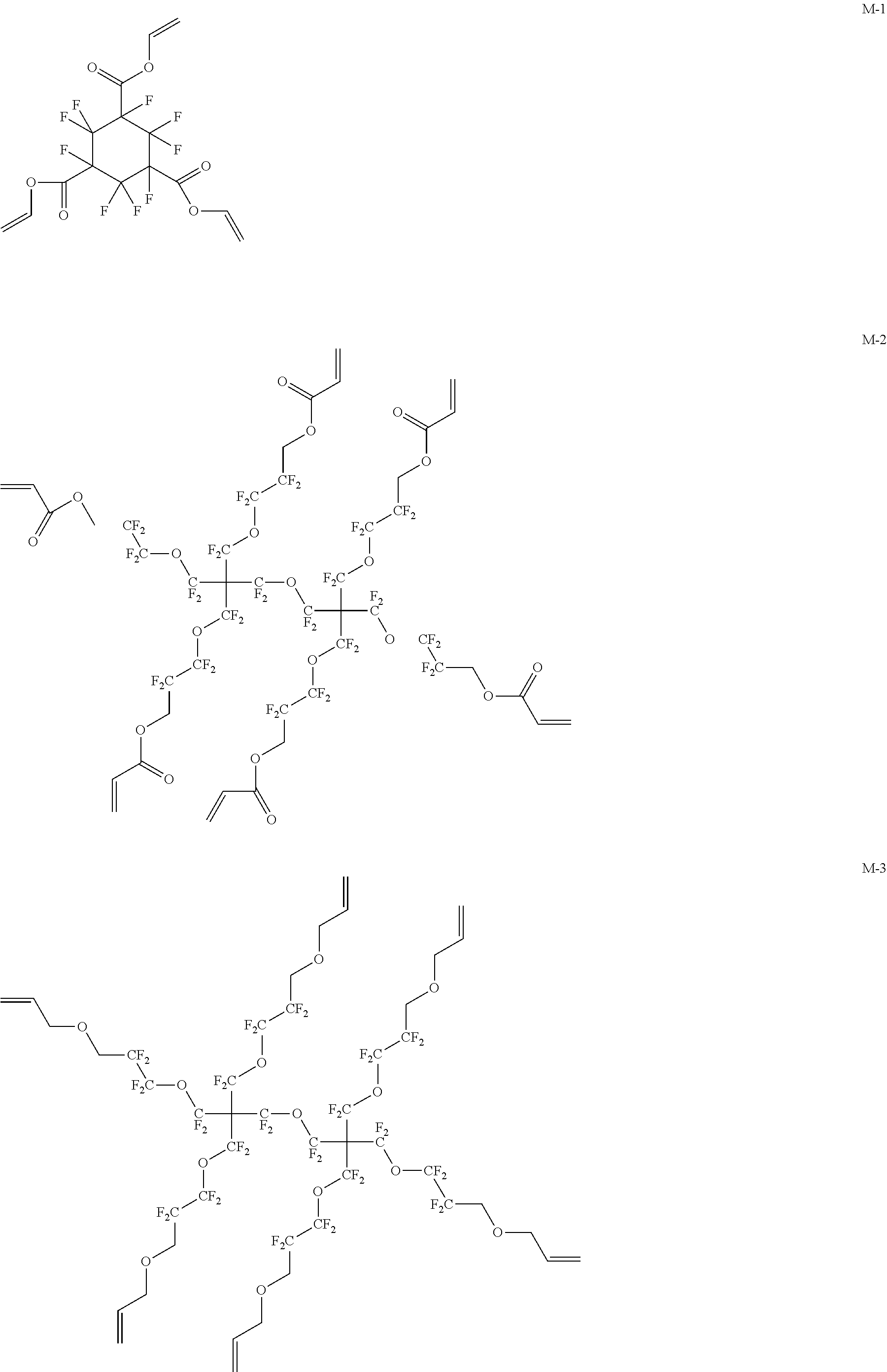

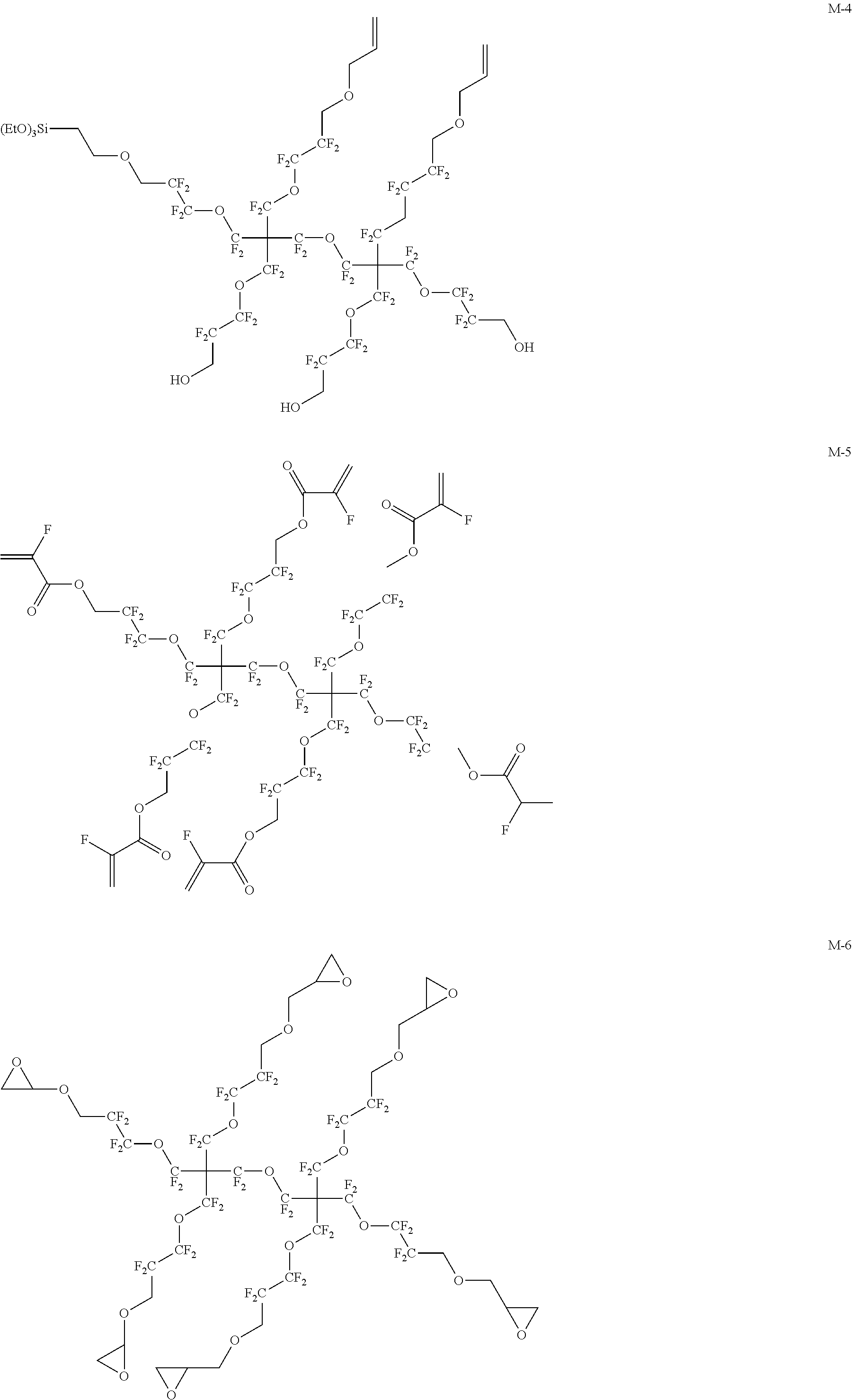

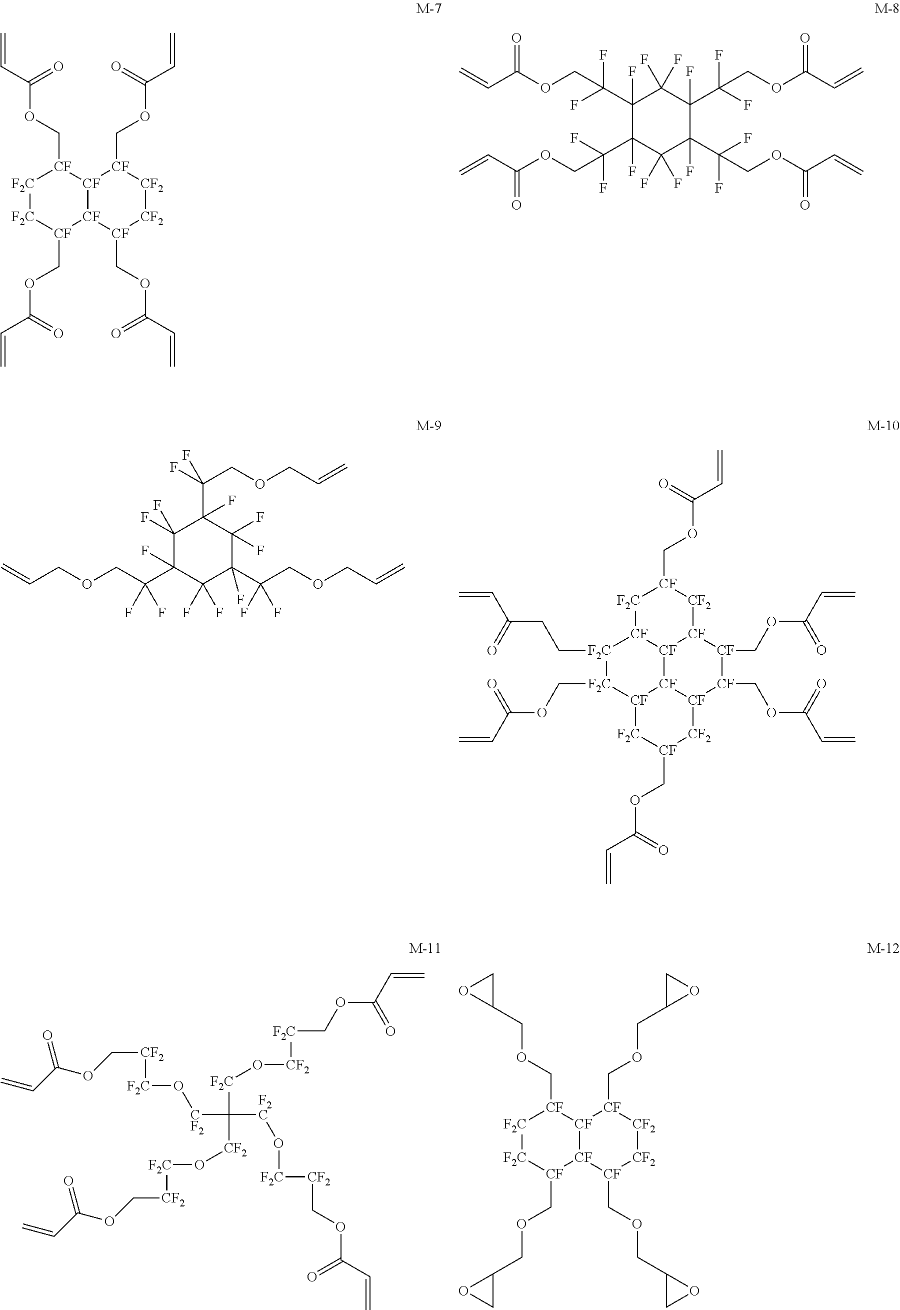

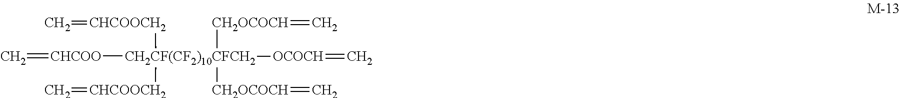

The fluorine content ratio of M-1 to M-13 is respectively 37.5 mass %, 46.2 mass %, 48.6 mass %, 47.7 mass %, 49.8 mass %, 45.8 mass %, 36.6 mass %, 39.8 mass %, 44.0 mass %, 35.1 mass %, 44.9 mass %, 36.2 mass %, and 39.0 mass %.

From the point of view of cross-linking density, the fluorine-containing polyfunctional monomers described above preferably have a fluorine-containing core section Rf where the calculated values of the molecular weight between crosslinks are all 300 or less when polymerizing all of the polymeric groups of the fluorine-containing polyfunctional monomers. In a polymer where all of the polymeric groups of the fluorine-containing polyfunctional monomers are polymerized, when three or more carbon atoms in total or carbon atoms which are substituted by silicon atoms are (a) and three or more carbon atoms in total or silicon atoms which are substituted by oxygen atoms are (b), the calculated value of the molecular weight between crosslinks indicates a molecular weight of an atomic group which is interposed by (a) and (a), (b) and (b), or (a) and (b). For example, description will be given using M-2 as an example out of the fluorine-containing polyfunctional monomers described above. Assuming all of the polymeric groups in M-2 are polymerized, M-2 is represented by Formula (4).

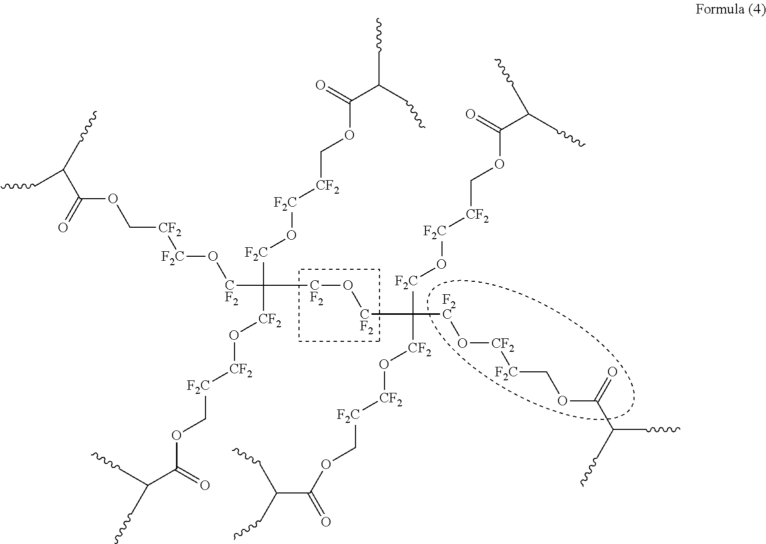

In this case, the partial structure which is a target for the calculation of the molecular weight between crosslinks which is defined above is a portion which is surrounded by the dashed line in Formula (4) and the calculated values of the molecular weight between crosslinks are respectively C₂F₄O=116.0 and C₅H₂F₆O₃=224.1 and both are 300 or less.

The calculated value of the molecular weight between crosslinks is more preferably 250 or less and even more preferably 200 or less. When the molecular weight between crosslinks exceeds 300 when polymerizing all of the polymeric groups of the fluorine-containing polyfunctional monomers, the hardness when making a coated film decreases and, furthermore, the antifouling property or the scratch resistance deteriorates.

As a method for producing the fluorine-containing polyfunctional monomers, a method of introducing 3 or more polymeric groups, preferably 5 or more polymeric groups, and more preferably 6 or more polymeric groups after substituting 80 mol % or more, preferably 90 mol % or more, of the hydrogen atoms with fluorine atoms by carrying out liquid-phase fluorination on a compound which has an ester bond, a dialkoxy group, and/or a halogen atom is favorable. The liquid-phase fluorination is, for example, described in U.S. Pat. No. 5,093,432A.

In the compound which is used for liquid-phase fluorination, there is a demand for the compound to be dissolved in a fluorine-based solvent which is used when carrying out the liquid-phase fluorination or for the compound to be a liquid; however, there is no particular limit other than this. From the point of view of the solubility or reactivity, a compound in which fluorine is included beforehand may be used. In addition, the compound which has an ester bond, a dialkoxy group, and/or a halogen atom is favorable since it is possible to set the reaction point when introducing polymeric groups after the liquid-phase fluorination.

Introducing the fluorine atoms by the liquid-phase fluorination makes it possible to make the fluorine content ratio extremely high in other portions than the polymeric groups which are introduced later and it is possible to obtain a fluorine-containing polyfunctional monomer which gives a polymer with an extremely low refractive index.

(Fluorine-containing Polymer)

It is possible to use a fluorine-containing polyfunctional monomer as a fluorine-containing polymer using various types of polymerization methods. During the polymerization, individual polymerization or copolymerization may be carried out and, moreover, the fluorine-containing polyfunctional monomer may be used as a cross-linking agent.

As other monomers which are to be copolymerized, it is possible to use commonly used monomers which are known in the art; however, examples of specifically representative monomers include radical polymeric monomers such as methyl(meth)acrylate, ethyl(meth)acrylate, propyl(meth)acrylate, 2-trifluoroethyl(meth)acrylate, 2,3-pentafluoropropyl(meth)acrylate, 1H,1H,5H-octafluoropentyl(meth)acrylate, 1H,1H,7H-dodecafluoroheptyl(meth)acrylate, 1H, 1H,9H-hexadecafluorononyl(meth)acrylate, 2-(perfluorobutyl)ethyl(meth)acrylate, 2-(perfluorohexyl)ethyl(meth)acrylate, 2-(perfluorooctyl)ethyl(meth)acrylate, pentaerythritol triacrylate, pentaerythritol tetraacrylate, pentaerythritol pentaacrylate, pentaerythritol hexaacrylate, allyl alcohol, ethylallyl ether, α-fluoroacrylic acid methyl ester, vinyl acetate, ethylvinyl ketone, and butyl vinyl ketone,

condensed polymeric monomers such as tetraethoxysilane, ethyltrimethoxysilane, chlorotrimethoxysilane, aminopropyltriethoxysilane, vinyltrimethoxysilane, γ-glycidoxypropyltriethoxysilane, γ-methacryloxypropyltrimethoxysilane, γ-mercaptopropyltrimethoxysilane, or ones which are represented by chemical formulas below,

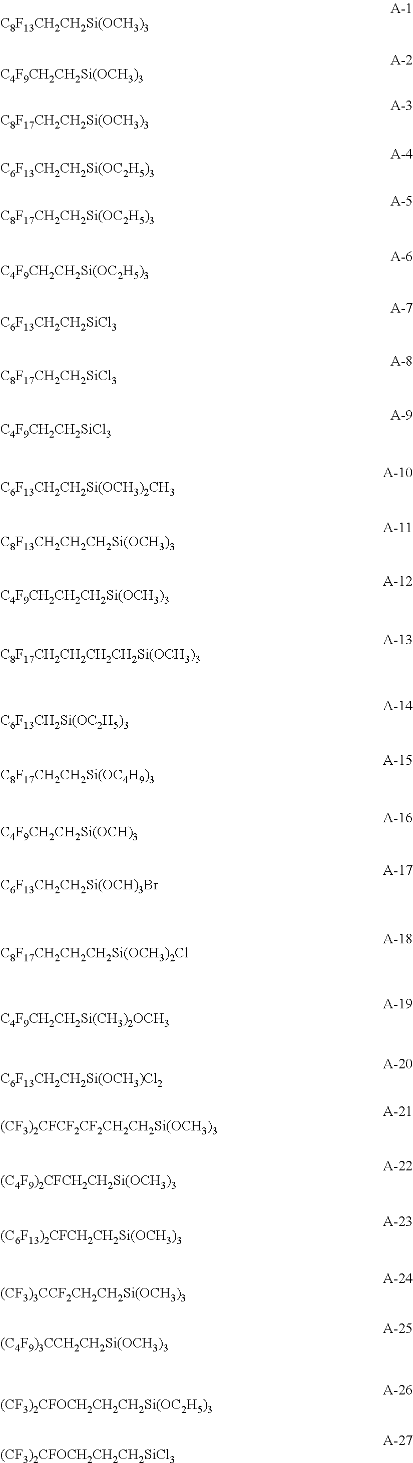

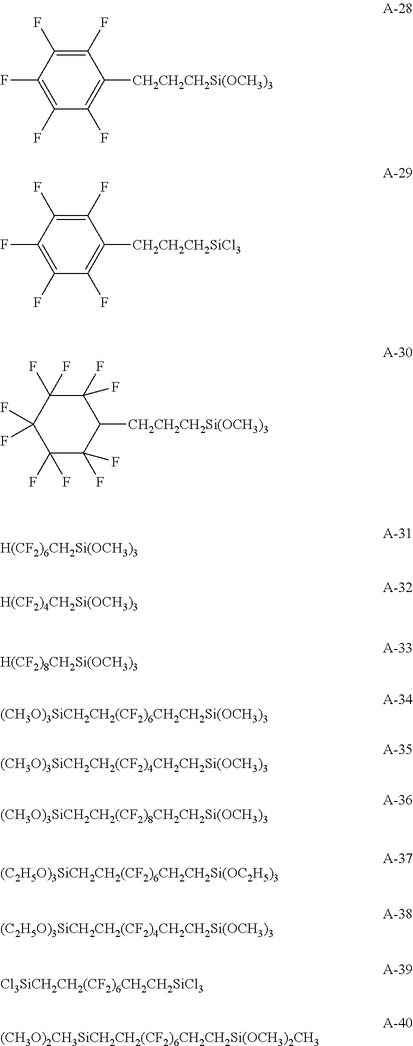

cation polymeric monomers such as glycerol diglycidyl ether, glycerol triglycidyl ether, 1,1,1-trimethylol propane triglycidyl ether, sorbitol polyglycidyl ether, bisphenol-A-diglycidyl ether, hydroquinone diglycidyl ether, resorcin diglycidyl ether, fluoroglycinol triglycidyl ether, triglycidyl isocyanurate, ethylvinyl ether, and cyclohexylvinyl ether, and the like. Among these, from the point of view of the polymeric property, radical or cation polymeric monomers are preferable, and radical polymeric monomers are more preferable.

The polymerizing reaction is preferably performed by block polymerization or solution polymerization. In particular, in order to obtain a thin film, polymerization may be performed after coating a curable resin composition which includes the fluorine-containing polyfunctional monomers described above on a substrate and volatilizing a solvent. Examples of a method for initiating the polymerization include a method which uses a radical initiator, a method which irradiates light or radiation, a method which adds acid, a method which irradiates light after adding a photoacid generator, a method which dehydrates and condenses through heating, and the like. The polymerization methods and methods for initiating the polymerization are, for example, described in “Polymer Synthesis Methods”, Revised Edition by Teiji Tsuruta (published by Nikkan Kogyo Shinbun Ltd. in 1971) or on pages 124 to 154 of “Experimental Methods for Polymer Synthesis” by Takayuki Otsu and Masayoshi Kinoshita published by Kagaku-Dojin Publishing Co., Inc. in 1972.

Examples of usable olvents include ethyl acetate, butyl acetate, acetone, methylethyl ketone, methylisobutyl ketone, cyclohexanone, tetrahydrofuran, dioxane, N,N-dimethyl formamide, N,N-dimethyl acetamide, benzene, toluene, acetonitrile, methylene chloride, chloroform, dichloroethane, methanol, ethanol, 1-propanol, 2-propanol, 1-butanol, and the like. These may be used individually or two or more types may be mixed.

It is possible for the initiator of the radical polymerization to take the form of either an initiator which generates radicals through the effect of heat or an initiator which generates radical through the effect of light.

As the compound which initiates the radical polymerization through the effect of heat, it is possible to use organic or inorganic peroxide, organic azo or diazo compounds, and the like.

In detail, examples of organic peroxides include benzoyl peroxide, halogen benzoyl peroxide, lauroyl peroxide, acetyl peroxide, dibutyl peroxide, cumene hydroperoxide, butyl hydroperoxide, and the like, examples of inorganic peroxides include hydrogen peroxide, ammonium persulfate, potassium persulfate, and the like, examples of organic azo compounds include 2-azo-bis-isobutyronitrile, 2-azo-bis-propionitrile, 2-azo-bis-cyclohexane dinitrile, and the like, and examples of diazo compounds include diazoamino benzene, p-nitrobenzene diazonium, and the like.

In a case of using a compound which initiates the radical polymerization through the effect of light, the coating film curing is performed through the irradiation of active energy rays.

Examples of the photo-radical polymerization initiators include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, and the like. Examples of acetophenones include 2,2-diethoxy acetophenone, p-dimethyl acetophenone, 1-hydroxy dimethyl phenyl ketone, 1-hydroxy cyclohexyl phenyl ketone, 2-methyl-4-methylthio-2-morpholino propiophenone, and 2-benzyl-2-dimethyl amino-1-(4-morpholino phenyl)-butanone. Examples of benzoins include benzoin benzene sulfonic acid ester, benzoin toluene sulfonic acid ester, benzoin methyl ether, benzoin ethyl ether, and benzoin isopropyl ether. Examples of benzophenones include benzophenone, 2,4-dichloro benzophenone, 4,4-dichloro benzophenone, and p-chloro benzophenone. Examples of phosphine oxides include 2,4,6-trimethyl benzoyl diphenyl phosphine oxide. It is also possible to use a sensitizing coloring material with the photo-radical polymerization initiators.

The added amount of the radical polymerization initiator described above is not particularly limited as long as it is an amount with which it is possible for the radical reaction group described above to initiate the polymerization reaction; however, the amount is generally preferably 0.1 mass % to 15 mass % with respect to all of the solid content in the curable resin composition, more preferably 0.5 mass % to 10 mass %, and particularly preferably 2 mass % to 5 mass %.

The polymerization temperature is not particularly limited, but may be appropriately adjusted according to the type of the initiator. In addition, heating is not particularly necessary in a case of using a photo-radical polymerization initiator but heating may be carried out.

In addition to the description above, it is also possible to include various types of additive agents in the curable resin composition which forms a fluorine-containing polymer from the point of view of the coating film hardness, refractive index, antifouling property, water resistance, chemical resistance, and slippage.

For example, it is possible to add inorganic oxide fine particles such as (hollow) silica, a silicone-based or fluorine-based antifouling agent, a slipping agent, or the like. In a case of adding the above, a range of 0 mass % to 30 mass % with respect to all of the solid content of the curable resin composition is preferable, a range of 0 mass % to 20 mass % is more preferable, and a range of 0 mass % to 10 mass % is particularly preferable.

The heat-shielding material of the present invention preferably contains low refractive index particles in the low refractive index layer.

The low refractive particles described above are preferably hollow particles or porous particles.

In the heat-shielding material of the present invention, the low refractive index particles are preferably silica from the point of view of adjusting the refractive index of the low refractive index layer.

The low refractive index particles described above are preferably formed by being selected from at least one or more of a group formed of amorphous synthetic silica, colloidal silica, hollow silica, porous silica, magnesium fluoride, and hollow magnesium fluoride. Among these, hollow silica and porous silica are more preferably used and hollow silica is particularly preferably used.

The low refractive index layer preferably has a hard coat property. In a case where the low refractive index layer has a hard coat property, the low refractive index layer is preferably formed by a composition which includes monomers and a polymerization initiator.

<Metal Particle-Containing Layer>

The metal particle-containing layer described above is a layer which contains at least one type of metal particles. The metal particles described above are preferably flat metal particles (flat metal particles) and the flat metal particles are preferably biased to one surface of the metal particle-containing layer described above.

—1-1. Metal Particles—

In the heat-shielding material of the present invention, the metal particles described above preferably have 50% by number or more of flat metal particles and more preferably have 50% by number or more of flat metal particles with a hexagonal shape to a circular shape.

In the heat-shielding material of the present invention, flat metal particles in which the principle planar surface of the flat metal particles is planarly oriented in a range of 0° to ±30° on average with respect to one surface of the metal particle-containing layer are 50% by number or more of all the flat metal particles.

The material of the metal particles described above is not particularly limited and it is possible to appropriately select the material according to the purpose; however, from the point that the reflection rate of heat rays (near infrared rays) is high, silver, gold, aluminum, copper, rhodium, nickel, platinum, and the like are preferable, and, among these, silver is more preferable.

—1-2. Flat Metal Particles—

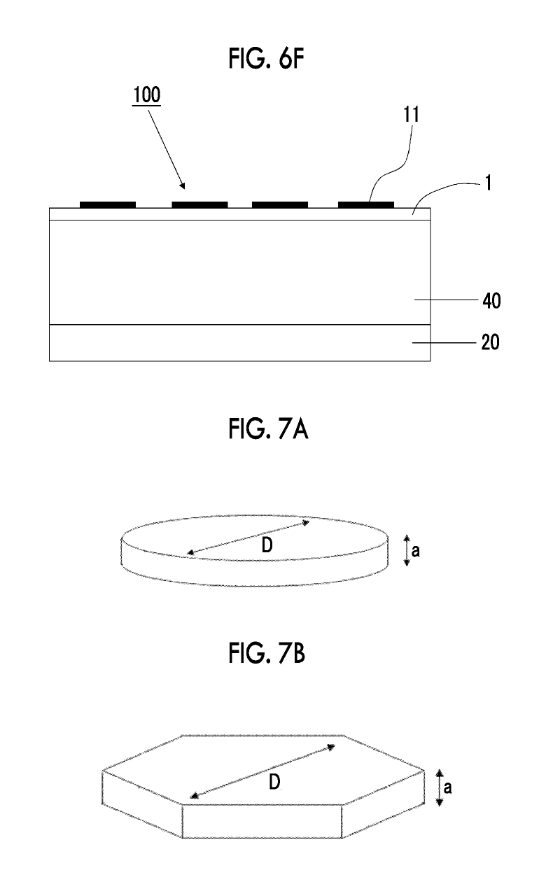

The flat metal particles described above are not particularly limited as long as the particles are formed by two principle planar surfaces (refer to FIGS. 7A and 7B), it is possible to appropriately select the particles according to the purpose, and examples thereof include hexagonal shaped particles, circular shaped particles, triangular shaped particles, and the like. Among these, from the point that the visible light transmittance is high, a polygonal shape of a hexagonal shape or higher to a circular shape is more preferable, and a hexagonal shape or a circular shape is particularly preferable.

In the present specification, a circular shape refers to a shape where the number of sides which have length of 50% or more of the average circle equivalent diameter of the flat metal particles which will be described below is 0 per flat metal particle. The flat metal particles with a circular shape described above are not particularly limited as long as there are no corners and the shape is circular when observing the flat metal particles from above the principle planar surface using a transmission electron microscope (TEM) and it is possible to appropriately select the particles according to the purpose.

In the present specification, a hexagonal shape refers to a shape where the number of sides which have a length of 20% or more of the average circle equivalent diameter of the flat metal particles which will be described below is 6 per flat metal particle. Here, the other polygons are also the same. The flat metal particles with a hexagonal shape described above are not particularly limited as long as the shape is hexagonal when observing the flat metal particles from above the principle planar surface using a transmission electron microscope (TEM) and it is possible to appropriately select the particles according to the purpose, for example, the angles of the hexagonal shape may be acute angles or may be obtuse angles; however, the angle is preferably an obtuse angle from the point that it is possible to reduce the absorption in the visible light region. The degree of the obtuse angle is not particularly limited and it is possible to appropriately select the angle according to the purpose.

The flat metal particles with a hexagonal shape or a circular shape out of the metal particles which are present in the metal particle-containing layer described above are preferably 50% by number or more with respect to the total number of the metal particles, more preferably 65% by number or more, and particularly preferably 70% by number or more. When the ratio of the flat metal particles described above is 50% by number or more, the visible light transmittance is high.

[1-2-1. Planar Orientation]

In the heat-shielding material of the present invention, regarding the flat metal particles with a hexagonal shape or a circular shape described above, the principle planar surfaces of at least 50% by number or more of all the flat metal particles are set with a planar orientation in a range of 0° to ±30° on average with respect to one surface (a substrate surface in a case where the heat-shielding material has a substrate) of the metal particle-containing layer, more preferably set with a planar orientation in a range of to 20° on average, and layer, more preferably set with a planar orientation in a range of 0° to ±20° on average, and particularly preferably set with a planar orientation in a range of 0° to ±10° on average. In addition, the flat metal particles which are set with a planar orientation in a range of 0° to ±30° on average are more preferably 70% by number or more and even more preferably 90% by number or more.

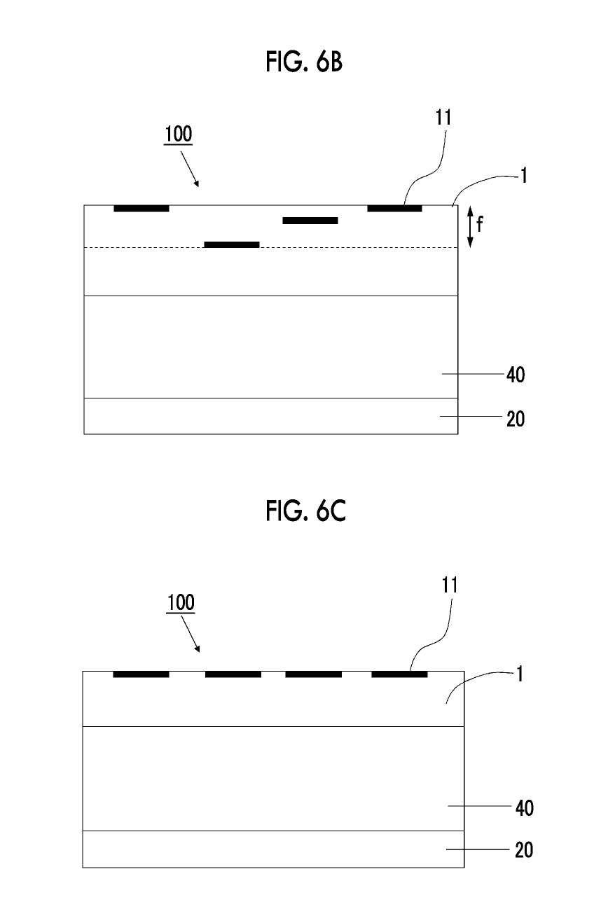

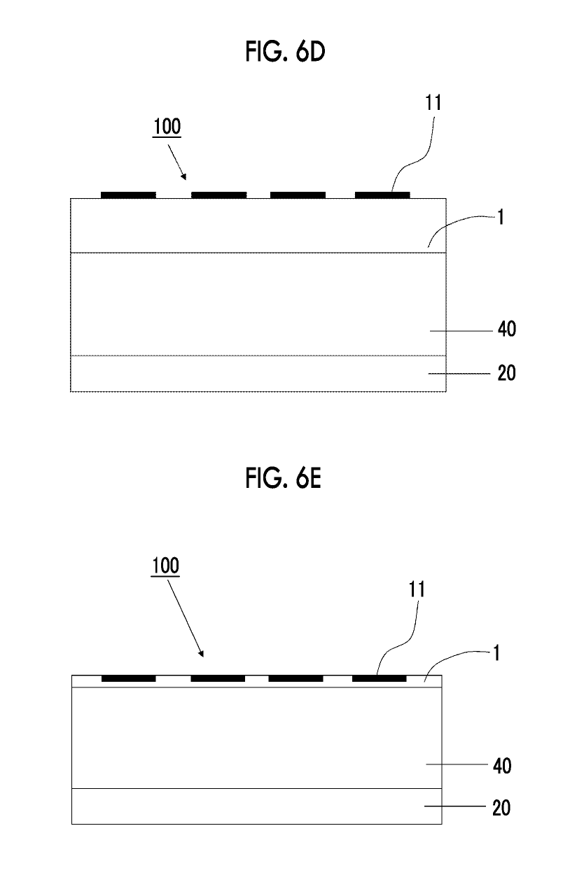

The state in which the flat metal particles described above are present is not particularly limited and it is possible to appropriately select the state according to the purpose; however, the flat metal particles are preferably lined up as in FIGS. 6C to 6F which will be described below.

Here, FIGS. 6A to 6F are schematic cross-sectional diagrams which illustrate states in which the metal particle-containing layer which includes the flat metal particles is present in the heat-shielding material of the present invention. FIGS. 6D to 6F illustrate states in which the flat metal particles 11 are present in the metal particle-containing layer 1. FIG. 6A is a diagram which illustrates an angle (±θ) between the planar surface of the substrate and the principle planar surface (the surface which determines the circle equivalent diameter D) of the flat metal particles 11. FIG. 6B illustrates a range f in which the heat-shielding material of the metal particle-containing layer 1 is present in the depth direction.

In FIG. 6A, the angle (±θ) between the surface of the substrate and the principle planar surface (the surface which determines the circle equivalent diameter D) of the flat metal particles 11 or an extended line of the principle planar surface corresponds to the predetermined ranges in the planar orientations described above. That is, the planar orientation refers to a state in which the inclination angle (±θ) shown in FIG. 6A is small when observing the cross-section of the heat-shielding material and, in particular, FIG. 6C illustrates a state in which the surface of the substrate and the principle planar surface of the flat metal particles 11 are in contact, that is, a state in which θ is 0°. When the angle of the planar orientation of the principle planar surface of the flat metal particles 11 with respect to the surface of the substrate, that is, θ in FIG. 6A, exceeds ±30°, the reflection rate of the heat-shielding material at a predetermined wavelength (for example, a near infrared light region from the visible light region wavelength side) decreases.

Evaluation of whether the principle planar surface of the flat metal particles are set with a planar orientation with respect to one surface (the substrate surface in a case where the heat-shielding material has a substrate) of the metal particle-containing layer described above is not particularly limited and it is possible to appropriately select the evaluation according to the purpose and, for example, the evaluation may use a method for producing an appropriate cross-sectional segment and observing and evaluating the metal particle-containing layer (the substrate in a case where the heat-shielding material has a substrate) and flat metal particles in this segment. In detail, examples thereof include a method of producing a cross-sectional sample or a cross-sectional segment sample of the heat-shielding material using a microtome and focused ion beam (FIB) and evaluating the heat-shielding material from images which are obtained by observing using various types of microscopes (for example, a field emission-type scanning electron microscope (FE-SEM), a transmission electron microscope (TEM), and the like) and the like.

The observation of the cross-sectional sample or the cross-sectional segment sample which is produced as described above is not particularly limited as long as it is possible to confirm whether the principle planar surfaces of the flat metal particles are set with a planar orientation with respect to one surface (the substrate surface in a case where the heat-shielding material has a substrate) of the metal particle-containing layer in the sample and it is possible to appropriately select the observation according to the purpose and examples thereof include observation using FE-SEM, TEM, and the like. The observation may be performed using FE-SEM in the case of the cross-sectional sample described above and TEM in the case of the cross-sectional segment sample described above. In a case of evaluating using FE-SEM, it is preferable to have a spatial resolution with which it is possible to clearly determine the shape and the inclination angle (±θ in FIG. 6A) of the flat metal particles.

[1-2-2. Average Particle Diameter (Average Circle Equivalent Diameter) and Variation Coefficient]

It is possible to obtain the projected area of particles using a method known in the art which measures an area in an electron micrograph and compensates for the magnification ratio of the image. The circle equivalent diameter is represented by a diameter of a circle which has the same area as the projected area of the individual particles obtained by the method described above. The particle diameter distribution (particle size distribution) is obtained from statistics of the circle equivalent diameter D of 200 flat metal particles and it is possible to obtain the average particle diameter (the average circle equivalent diameter) by calculating the arithmetical mean. It is possible to obtain the variation coefficient in the particle size distribution of the flat metal particles described above from a value (%) where the standard deviation of the particle size distribution is divided by the average particle diameter (the average circle equivalent diameter) described above.

In the heat-shielding material of the present invention, the variation coefficient in the particle size distribution of the flat metal particles is preferably 35% or less, more preferably 30% or less, and particularly preferably 20% or less. The variation coefficient described above is preferably 35% or less since the reflection wavelength region of the heat rays in the heat-shielding material is sharp.

The size of the metal particles described above is not particularly limited, it is possible to appropriately select the size according to the purpose, and the average particle diameter is preferably 10 nm to 500 nm, more preferably 20 nm to 300 nm, and even more preferably 50 nm to 200 nm.

[1-2-3. Thickness and Aspect Ratio of Flat Metal Particles]

In the heat-shielding material of the present invention, the thickness of the flat metal particles described above is preferably 20 nm or less, more preferably 14 nm or less, and particularly preferably 11 nm or less. The lower limit value of the thickness of the flat metal particle described above is not particularly limited; however, the thickness of the flat metal particles described above is more preferably 5 nm to 14 nm and particularly preferably 5 nm to 11 nm. The thickness of the flat metal particles is preferably set to be 20 nm or less since it is possible to improve the visible light transmittance of the heat-shielding material and reduce the transmitted light haze. In this point, the thickness of the flat metal particle is preferably as thin as possible; however, the lower limit value of the thickness of the flat metal particle is determined from the point of view of the desired moisture and the heat durability and lightfastness of the heat-shielding material.

The aspect ratio of the flat metal particles described above is not particularly limited and it is possible to appropriately select the aspect ratio according to the purpose; however, since the reflection rate in the infrared light region with a wavelength of 800 nm to 1,800 nm is high, 2 to 80 is preferable, 6 to 40 is more preferable, and 10 to 35 is particularly preferable. When the aspect ratio described above is 2 or more, control is easy in a range where the reflection wavelength is longer than 800 nm and, when the aspect ratio is 40 or less, control is easy in a range where the reflection wavelength is shorter than 1,800 nm and a sufficient heat-reflecting performance is obtained.

The aspect ratio described above has the meaning of a value where the average particle diameter (the average circle equivalent diameter) of the flat metal particles is divided by the average particle thickness of the flat metal particles. The particle thickness is equivalent to the distance between the principle planar surfaces of the flat metal particles and, for example, is as illustrated by a in FIGS. 7A and 7B, and measurement is possible using an atomic force microscope (AFM) or a transmission electron microscope (TEM).

The method for measuring the average particle thickness using the AFM described above is not particularly limited, it is possible to appropriately select the method according to the purpose, and examples thereof include a method of dripping a particle dispersant which contains flat metal particles onto the glass substrate, drying the particle dispersant, and measuring the thickness of one particle, and the like.

The method for measuring the average particle thickness using the TEM described above is not particularly limited, it is possible to appropriately select the method according to the purpose, and examples thereof include a method for measuring the thickness of the particles by dripping a particle dispersant which contains flat metal particles onto a silicon substrate and, after drying the particle dispersant, carrying out a coating treatment by carbon vapor deposition and metal vapor deposition, producing a cross-sectional segment using a focused ion beam (FIB), and observing the cross-section described above using TEM or the like.

[1-2-4. Thickness of Metal Particle-Containing Layer and Range where Flat Metal Particles are Present]

In the heat-shielding material of the present invention, the coated film thickness d of the metal particle-containing layer which contains the flat metal particles described above is preferably 5 nm to 120 nm, more preferably 7 nm to 80 nm, and particularly preferably 10 nm to 40 nm.

In the heat-shielding material of the present invention, in a case where the coated film thickness d of the metal particle-containing layer is d>D/2 with respect to the average circle equivalent diameter D of the metal particles, 80% by number or more of the flat metal particles with a hexagonal shape or a circular shape described above are preferably present in a range of d/2 from the surface of the metal particle-containing layer described above, and more preferably present in a range of d/3, and 60% by number or more of the flat metal particles with a hexagonal shape or a circular shape described above are even more preferably exposed on one surface of the metal particle-containing layer described above. That the flat metal particles are present in a range of d/2 from the surface of the metal particle-containing layer has the meaning that at least some of the flat metal particles are included in the range of d/2 from the surface of the metal particle-containing layer. That is, the flat metal particles illustrated in FIG. 6D where some flat metal particles protrude from the surface of the metal particle-containing layer are also treated as flat metal particles which are present in the range of d/2 from the surface of the metal particle-containing layer. Here, FIG. 6D has the meaning that a small portion in the thickness direction of each of the flat metal particles is embedded in the metal particle-containing layer and each of the flat metal particles is not laminated on the surface of the metal particle-containing layer. FIGS. 6B to 6D are schematic diagrams which represent a case where the thickness d of the metal particle-containing layer described above is d>D/2 and, specifically, FIG. 6B is a diagram which represents that 80% by number or more of the flat metal particles are included in a range of f and f<d/2.

In addition, that the flat metal particles are exposed on one surface of the metal particle-containing layer described above has the meaning that a part of one surface of the flat metal particles protrudes from the surface of the metal particle-containing layer.

Here, it is possible to measure the flat metal particle presence distribution in the metal particle-containing layer described above, for example, using an image where a cross-sectional sample of the heat-shielding material is observed using SEM.

In the heat-shielding material of the present invention, for the coated film thickness d of the metal particle-containing layer, a case where, with respect to the average circle equivalent diameter D of the metal particles, d<D/2 is preferable, d<D/4 is more preferable, and d<D/8 is even more preferable. When the coating thickness of the metal particle-containing layer is reduced, the angle range of the planar orientation of the flat metal particles tends to be close to 0° and it is possible to maximally utilize the plasmon reflection effect due to the flat metal particles, which is preferable. When the coating thickness of the metal particle-containing layer is reduced, arrangement variations in the thickness direction of each of the flat metal particles are small and easily lined up at the same surface height and it is possible to maximally utilize the plasmon reflection effect due to the flat metal particles, which is preferable. FIGS. 6E and 6F are schematic diagrams which represent a case where the thickness d of the metal particle-containing layer described above is d<D/2.

In the heat-shielding material of the present invention, as shown in FIG. 6B, when the plasmon resonance wavelength of metal which configures the flat metal particles 11 in the metal particle-containing layer 1 is λ and the refractive index of a medium in the metal particle-containing layer 1 is n, the metal particle-containing layer 1 described above is preferably present in a range of (λ/n)/4 in the depth direction from the horizontal surface of the heat-shielding material. When in this range, the effect of the amplitudes of the reflection waves strengthening each other according to the phase of the reflection waves on an interface of each of the metal particle-containing layers on the upper side and the lower side of the heat-shielding material is sufficiently increased and the visible light transmittance and the heat ray maximum reflection rate are favorable.

The plasmon resonance wavelength λ of the metal which configures the flat metal particles in the metal particle-containing layer described above is not particularly limited and it is possible to appropriately select the metal according to the purpose; however, 400 nm to 2,500 nm is preferable in terms of adding the heat ray reflection performance and 700 nm to 2,500 nm is more preferable in terms of adding visible light transmittance.

[1-2-5. Medium of Metal Particle-Containing Layer]

The medium in the metal particle-containing layer described above is not particularly limited and it is possible to appropriately select the medium according to the purpose. In the heat-shielding material of the present invention, the metal particle-containing layer described above preferably includes a polymer and more preferably includes a transparent polymer. Examples of the polymer described above include a polyvinyl acetal resin, a polyvinyl alcohol resin, a polyvinyl butyral resin, a polyacrylate resin, a polymethyl methacrylate resin, a polycarbonate resin, a polyvinylchloride resin, a (saturated) polyester resin, a polyurethane resin, polymers such as natural polymers such as gelatin and cellulose, and the like. Among these, in the present invention, a main polymer of the polymer described above is preferably a polyvinyl alcohol resin, a polyvinyl butyral resin, a polyvinylchloride resin, a (saturated) polyester resin, or a polyurethane resin, more preferably a polyester resin and a polyurethane resin from the point of view that 80% by number or more of the flat metal particles with a hexagonal shape or a circular shape described above tend to be present in a range of d/2 from the surface of the metal particle-containing layer described above, and particularly preferably a polyester resin and a polyurethane resin from the point of view of further improving the rub resistance of the heat-shielding material of the present invention.

Among the polyester resins described above, a saturated polyester resin is more particularly preferable from the point of view that it is possible to add excellent weather resistance since a double bond is not included. In addition, it is more preferable to have a hydroxyl group or a carboxyl group in a molecular end terminal from the point of view that it is possible to obtain high hardness, durability, and heat resistance by curing using a water-soluble or water-dispersible curing agent and the like.

It is also possible to use commercially available products as the polymer described above and examples thereof include PLASCOAT Z-867 which is a water-soluble polyester resin produced by Goo Chemical Co., Ltd. and the like.

In addition, in the present specification, the main polymer of the polymer described above which is included in the metal particle-containing layer described above refers to polymer components which account for 50 mass % or more of the polymers which are included in the metal particle-containing layer described above.

The content of the polyester resin and the polyurethane resin described above with respect to the metal particles described above which are included in the metal particle-containing layer described above is preferably 1 mass % to 10,000 mass %, more preferably 10 mass % to 1,000 mass %, and particularly preferably 20 mass % to 500 mass %. By the binder which is included in the metal particle-containing layer described above being in the range described above or more, it is possible to improve the physical characteristics such as the rub resistance.

The refractive index n of the medium described above is preferably 1.4 to 1.7.

In the heat-shielding material of the present invention, when the thickness of the flat metal particle with a hexagonal shape to a circular shape described above is a, for 80% by number or more of the flat metal particles with a hexagonal shape or a circular shape described above, a/10 or more in the thickness direction is preferably covered by the polymer described above, a/10 to 10a in the thickness direction is more preferably covered by the polymer described above, and a/8 to 4a is particularly preferably covered by the polymer described above. In this manner, it is possible to further improve the rub resistance by embedding a certain ratio or more of the flat metal particles with a hexagonal shape or a circular shape described above in the metal particle-containing layer described above. That is, in the heat-shielding material of the present invention, the aspects in FIG. 6C or FIG. 6E are more preferable than the aspects in FIG. 6D or FIG. 6F.

[1-2-6. Area Ratio of Flat Metal Particles]

An area ratio [(B/A)×100] which is the ratio of a total value B of an area of the flat metal particles with respect to an area A (the total projected area A of the metal particle-containing layer described above when viewed from a direction orthogonal to the metal particle-containing layer) of a substrate when viewing the heat-shielding material from above is preferably 15% or more and more preferably 20% or more. When the area ratio described above is less than 15%, the maximum reflection rate of the heat rays decreases and the heat-shielding effect may not be sufficiently obtained.

Here, it is possible to measure the area ratio described above, for example, by image processing an image which is obtained by observing the heat-shielding material substrate from above using SEM or an image which is obtained by observation using an atomic force microscope (AFM).

[1-2-7 Array of Flat Metal Particles]

The array of the flat metal particles in the metal particle-containing layer described above is preferably even. Here, the array being even indicates that the variation coefficient (=standard deviation+average value) of the distance between closest adjacent particles for each particle is small when the distance (the distance between the closest adjacent particles) up to the closest adjacent particle with respect to each particle is converted to a numeric value with the center distance of particles. The variation coefficient of the distance between the closest adjacent particles is preferably as small as possible, preferably 30% or less, more preferably 20% or less, more preferably 10% or less, and ideally 0%. In a case where the variation coefficient of the distance between the closest adjacent particles is large, the concentration of the flat metal particles increases or aggregation between particles occurs in the metal particle-containing layer described above and there is a tendency for the haze to deteriorate, which is not preferable. It is possible to measure the distance between the closest adjacent particles by observing the metal particle-containing layer coated surface using an SEM or the like.

[1-2-8. Layer Configuration of Metal Particle-Containing Layer]

In the heat-shielding material of the present invention, as shown in FIGS. 6A to 6F, the flat metal particles are arranged in the form of a metal particle-containing layer which includes flat metal particles.

The metal particle-containing layer described above may be configured by a single layer as shown in FIGS. 6A to 6F or may be configured by a plurality of metal particle-containing layers. In a case of being configured by a plurality of metal particle-containing layers, it is possible to add a shielding performance according to the wavelength band in which it is desired to add a heat-shielding performance. Here, in a case where the metal particle-containing layer described above is configured by a plurality of metal particle-containing layers, in at least the metal particle-containing layer on the uppermost surface in the heat-shielding material of the present invention, when the thickness of the metal particle-containing layer on the uppermost surface described above is d′, 80% by number or more of the flat metal particles with a hexagonal shape or a circular shape described above are preferably present in a range of d′/2 from the surface of the metal particle-containing layer on the uppermost surface described above.

Here, it is possible to measure the thickness of each layer of the metal particle-containing layer described above, for example, by observing a cross-sectional sample of the heat-shielding material using SEM or observing a cross-sectional segment sample using TEM.

In addition, in a case of having other layers such as an over coat layer, for example, which will be described below on the metal particle-containing layer described above of the heat-shielding material, it is also possible to determine the border between the other layer and the metal particle-containing layer described above by the same method and it is possible to determine the thickness d of the metal particle-containing layer described above. Here, in a case of coating on the metal particle-containing layer described above using the same type of polymer as the polymer which is included in the metal particle-containing layer described above, it is normally possible to determine the border with the metal particle-containing layer described above using an image which is observed using SEM and it is possible to determine the thickness d of the metal particle-containing layer described above.

[1-2-10. Synthesis Method of Flat Metal Particles]

The synthesis method of the flat metal particles described above is not particularly limited, it is possible to appropriately select the method according to the purpose, and examples thereof include a liquid-phase method such as a chemical reduction method, a photochemical reduction method, and an electrochemical reduction method as a method for synthesizing flat metal particles with a hexagonal shape to a circular shape. Among these, in terms of the shape and the size control property, a liquid-phase method such as a chemical reduction method or a photochemical reduction method is particularly preferable. The flat metal particles with a hexagonal shape or a circular shape may be obtained by making an angle of the flat metal particles with a hexagonal shape to a triangular shape obtuse by performing, for example, an etching process with a solvent which dissolves silver such as nitric acid or sodium sulfite, an aging process using heat, or the like after synthesizing the flat metal particles with a hexagonal shape to a triangular shape.

As the synthesis method of the flat metal particles described above, other than the methods described above, metal particles (for example, Ag) may be crystal grown in a flat shape after fixing a seed crystal on a surface of a transparent substrate such as a film or glass in advance.

In the heat-shielding material of the present invention, a further process may be carried out on the flat metal particles in order to add desired characteristics. The further process described above is not particularly limited, it is possible to appropriately select the process according to the purpose, and examples thereof include forming a high refractive index shell layer, adding various types of additive agents such as a dispersant and an antioxidant, and the like.

—1-2-10-1. Forming High Refractive Index Shell Layer—

The flat metal particles described above may be covered by a high refractive index material with high visible light region transparency in order to further increase the visible light region transparency.

The high refractive index material described above is not particularly limited, it is possible to appropriately select the material according to the purpose, and examples thereof include TiOₓ, BaTiO₃, ZnO, SnO₂, ZrO₂, NbOₓ, and the like.

The method for covering the above is not particularly limited, it is possible to appropriately select the method according to the purpose, and the method may be, for example, a method of forming a TiOₓ layer on the surface of flat metal particles of silver by hydrolyzing tetrabutoxy titanium as reported on p. 2731-2735 of Langmuir, volume 16, 2000.

In addition, in a case where it is difficult to directly form a high refractive index metal oxide layer shell on the flat metal particles described above, a shell layer of SiO₂ or a polymer may be appropriately formed after synthesizing the flat metal particles as described above and the metal oxide layer described above may be further formed on the shell layer. In a case of using TiOₓ as a material of a high refractive index metal oxide layer, since there is a concern that the matrix which disperses flat metal particles will deteriorate since TiOₓ has photocatalytic activity, a SiO₂ layer may be appropriately formed after forming a TiOₓ layer in the flat metal particles according to the purpose.

—1-2-10-2. Adding Various Additives—

In the heat-shielding material of the present invention, in a case where the metal particle-containing layer described above includes a polymer and a main polymer of the polymer described above is a polyester resin, a cross-linking agent is preferably added from the point of view of the film strength. The cross-linking agent described above is not particularly limited and examples thereof include epoxy-based cross-linking agents, isocyanate-based cross-linking agents, melamine-based cross-linking agents, carbodiimide-based cross-linking agents, oxazoline-based cross-linking agents, and the like. Among these, carbodiimide-based and oxazoline-based cross-linking agents are preferable. Specific examples of a carbodiimide-based crossing agent include CARBODILITE V-02-L2 (produced by Nisshinbo Chemical Inc.) and the like. With respect to all the binders in the metal particle-containing layer described above, it is preferable to contain 1 mass % to 20 mass % of components which are derived from cross-linking agents, and more preferably 2 mass % to 20 mass %.

In addition, in the heat-shielding material of the present invention, in a case where the metal particle-containing layer described above includes a polymer, the addition is preferable from the point of view that the generation of cissing is suppressed and that a layer with favorable planarity is obtained. As the surfactant described above, specific examples of usable surfactants which are known in the art, such as anion-based and nonion-based surfactants, include RAPIZOL A-90 (produced by NOF Corporation), NAROACTY HN-100 (produced by SANYO CHEMICAL INDUSTRIES, Ltd.), and the like. With respect to all the binders in the metal particle-containing layer described above, it is preferable to contain 0.05 mass % to 10 mass % of a surfactant, and more preferably 0.1 mass % to 5 mass %.

The flat metal particles described above may adsorb an antioxidant such as mercapto tetrazole and ascorbic acid in order to prevent oxidation of metal such as silver which configures the flat metal particles described above. In addition, for the purpose of preventing oxidation, an oxidation sacrificial layer of Ni or the like may be formed on the surface of the flat metal particles. In addition, for the purpose of shielding oxygen, the flat metal particles may be covered by a metal oxide film of SiO₂ and the like.

In the flat metal particles described above, for the purpose of adding dispersibility, for example, a dispersing agent may be added such as a low molecular weight dispersing agent or a high molecular weight dispersing agent which includes at least any of a quaternary ammonium salt, an N element such as amines, an S element, or a P element.

Preservative:

When producing the heat-shielding material of the present invention, a preservative is preferably contained in a flat metal particle dispersing liquid from the point of view that the visible light transmittance is also improved while maintaining the heat-shielding performance. Here, the reason why containing the preservative makes it possible to improve the visible light transmittance while maintaining the heat-shielding performance is not clear.

Furthermore, without basis in any particular theory, the present inventors discovered that the putrefaction phenomenon due to microbes is related to stability over time and that introducing a preservative makes it possible to improve the stability over time of the flat metal particle dispersing liquid. When the stability over time of the flat metal particle dispersing liquid is improved, the preservation of the flat metal particle dispersing liquid is effectively possible and the productivity of the heat-shielding material of the present invention which will be described below is remarkably improved by producing and supplying the flat metal particle dispersing liquid for coating as a batch. Here, the flat metal particle dispersing liquid known in the art has poor stability over time and is not suitable for mass production and, while the antibacterial property which is exhibited by silver is expected in a case of using silver in particular, the flat metal particle dispersing liquid known in the art has poor stability over time.

In addition, without basis in any particular theory, it is possible to improve the filterability of a flat metal particle dispersing liquid by introducing a preservative to the flat metal particle dispersing liquid. Here, the filterability refers to the increase in pressure when passing liquid through a filtration filter being remarkably improved and it being possible to continuously send (a large amount of) liquid over a long period. When a liquid which is prepared using a flat metal particle dispersant as the raw material is supplied for the coating, by improving the filterability of the flat metal particle dispersing liquid, it is possible to remove aggregated particles or dust by inserting a filtration filter while transporting the liquid and it is possible to provide the high quality heat-shielding material of the present invention described below with few planar defects in a large area. In addition, the problem of decreased productivity as a result of stopping the transported liquid, that is, stopping coating due to an increase in the filtration pressure, is also solved. Here, since the flat metal particle dispersing liquid known in the art has poor filterability and the pressure increases such that it is not possible to transport the liquid when passing the liquid through the filtration filter, it is difficult to capture and remove aggregated particles or dust using the filtration filter and it is not easy to obtain a heat-shielding material with few coating planar defects.

By improving the stability over time of the flat metal particle dispersing liquid and improving the filterability, it is possible to attain high productivity by preparing and coating a large amount of coating raw materials as a batch and to provide a high quality heat-shielding material with few planar defects in a large area.

In the flat metal particle dispersing liquid of the present invention, the preservative described above is preferably a compound which is represented by General Formula (11) below or General Formula (12) below and more preferably a compound which is represented by General Formula (11) below.

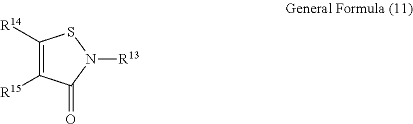

(In General Formula (11), R¹³ represents a hydrogen atom, an alkyl group, an alkenyl group, an aralkyl group, an aryl group, a heterocyclic group, (R¹⁶)(R′)—N—C(═O)—, or (R⁶)(R¹⁷)—N—C(═S)—. R¹⁴ and R¹⁵ each independently represent a hydrogen atom, an alkyl group, an aryl group, a cyano group, a heterocyclic group, an alkylthio group, an alkylsulfoxy group, or an alkylsulfonyl group, and R¹⁴ and R¹⁵ may bond with each other to form an aromatic ring. R¹⁶ and R¹⁷ each independently represent a hydrogen atom, an alkyl group, an aryl group, or an aralkyl group.)

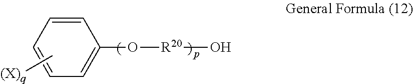

(In General Formula (12), R²⁰ represents a lower alkylene group. X represents a halogen atom, a nitro group, a hydroxy group, a cyano group, a lower alkyl group, a lower alkoxy group, —COR²¹, —N(R²²)(R²³), or —SO₂M. R²¹ represents a hydrogen atom, —OM, a lower alkyl group, an aryl group, an aralkyl group, a lower alkoxy group, an aryloxy group, an aralkyloxy group, or —N(R²⁴)(R²⁵). R²² and R²³ each independently represent a hydrogen atom, a lower alkyl group, an aryl group, an aralkyl group, —COR²⁶, or —SO₂R²⁶ and may be the same as or different from each other. R²⁴ and R²⁵ each independently represent a hydrogen atom, a lower alkyl group, an aryl group, and an aralkyl group and may be the same as or different from each other. R²⁶ represents a lower alkyl group, an aryl group, or an aralkyl group. M represents a hydrogen atom, an alkali metal atom, and an atomic group which is necessary for forming a monovalent cation. p represents 0 or 1. q represents an integer of 0 to 5.)

Description will be given of the compound which is represented by General Formula (11) described above.

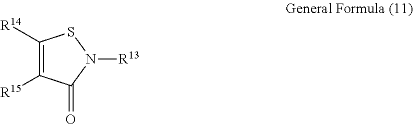

R¹³ represents a hydrogen atom, a straight-chain or branched-chain substituted or unsubstituted alkyl group (for example, methyl, ethyl, tert-butyl, n-octadecyl, 2-hydroxyethyl, 2-carboxyethyl, 2-cyanoethyl, sulfobutyl, and N,N-dimethylaminoethyl), a substituted or unsubstituted cyclic alkyl group (for example, cyclohexyl, 3-methylcyclohexyl, and 2-oxocyclopentyl), a substituted or unsubstituted alkenyl group (for example, allyl and methylallyl), a substituted or unsubstituted aralkyl group (for example, benzyl, p-methoxybenzyl, o-chlorobenzyl, and p-isopropylbenzyl), a substituted or unsubstituted aryl group (for example, phenyl, naphthyl, o-methylphenyl, m-nitrophenyl, and 3,4-dichlorophenyl), or a heterocyclic group (2-imidazolyl, 2-furyl, 2-thiazolyl, and 2-pyridyl), (R¹⁶)(R¹⁷)—N—C(O)—, or (R¹⁶(R¹⁷)—N—C(═S).

R¹⁴ and R¹⁵ each independently represent a hydrogen atom, a substituted or unsubstituted alkyl group (for example, methyl, ethyl, chloromethyl, 2-hydroxyethyl, tert-butyl, and n-octyl), a substituted or unsubstituted cyclic alkyl group (for example, cyclohexyl and 2-oxocyclopentyl), a substituted or unsubstituted aryl group (for example, phenyl, 2-methylphenyl, 3,4-dichlorophenyl, naphthyl, 4-nitrophenyl, 4-aminophenyl, and 3-acetoamidephenyl), a cyano group, a heterocyclic group (for example, 2-imidazolyl, 2-thiazolyl, and 2-pyridyl), a substituted or unsubstituted alkylthio group (for example, methylthio, 2-cyanoethylthio, and 2-ethoxycarbonylthio), a substituted or unsubstituted arylthio group (for example, phenylthio, 2-carboxyphenylthio, and p-methoxyphenylthio), a substituted or unsubstituted alkylsulfoxy group (for example, methylsulfoxy-hydroxyethylsulfoxy), and a substituted or unsubstituted alkylsulfonyl group (for example, methylsulfonyl and 2-bromoethylsulfonyl) and R¹⁴ and R¹⁵ may bond with each other to form an aromatic ring.

R¹⁶ and R¹⁷ each independently represent a hydrogen atom, a substituted or unsubstituted alkyl group (for example, methyl, ethyl, isopropyl, 2-cyanoethyl, 2-n-butoxycarbonylethyl, and 2-cyanoethyl), a substituted or unsubstituted aryl group (for example, phenyl, naphthyl, 2-methoxyphenyl, m-nitrophenyl, 3,5-dichlorophenyl, and 3-acetoamidephenyl), and a substituted or unsubstituted aralkyl group (for example, benzyl, phenethyl, p-isopropylbenzyl, o-chlorobenzyl, and m-methoxybenzyl).

Furthermore, a preferable case in General Formula (11) described above is where R¹³ represents a hydrogen atom and a lower alkyl group and R¹⁴ and R¹⁵ bond with each other to form an aromatic ring and a more preferable case is where R¹³ represents a hydrogen atom and R¹⁴ and R¹⁵ bond with each other to form a benzene ring.

Next, representative specific examples of a compound which is represented by General Formula (11) described above will be given below; however, the compound which is represented by General Formula (11) described above is not limited to the specific examples. Here, the specific examples below are the same as the specific examples of the compound which is represented by General Formula (II) in JP1991-119347A (JP-H3-119347A).

Here, among the compounds below, Compound II-25 or Compound II-44 are preferably used in the present invention and Compound II-25 is more preferably used.

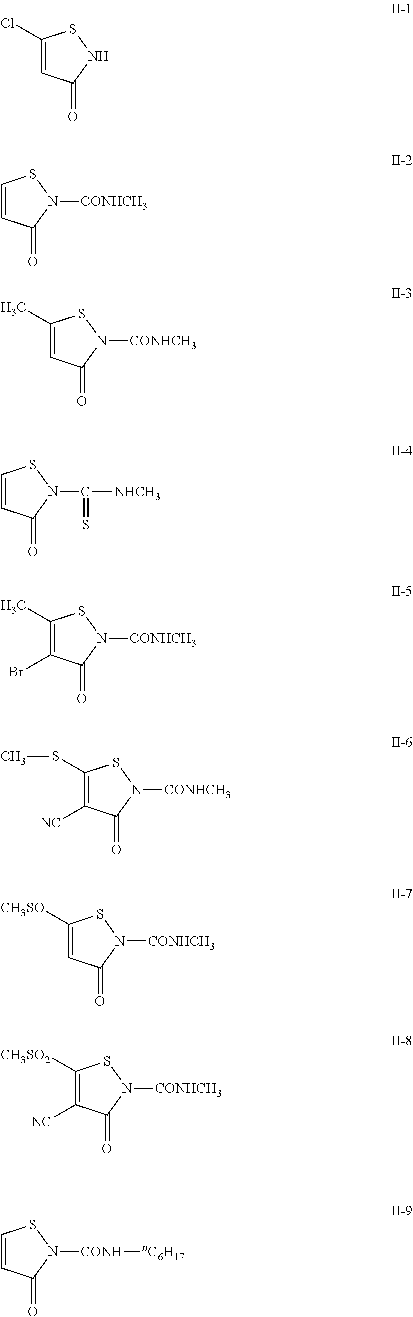

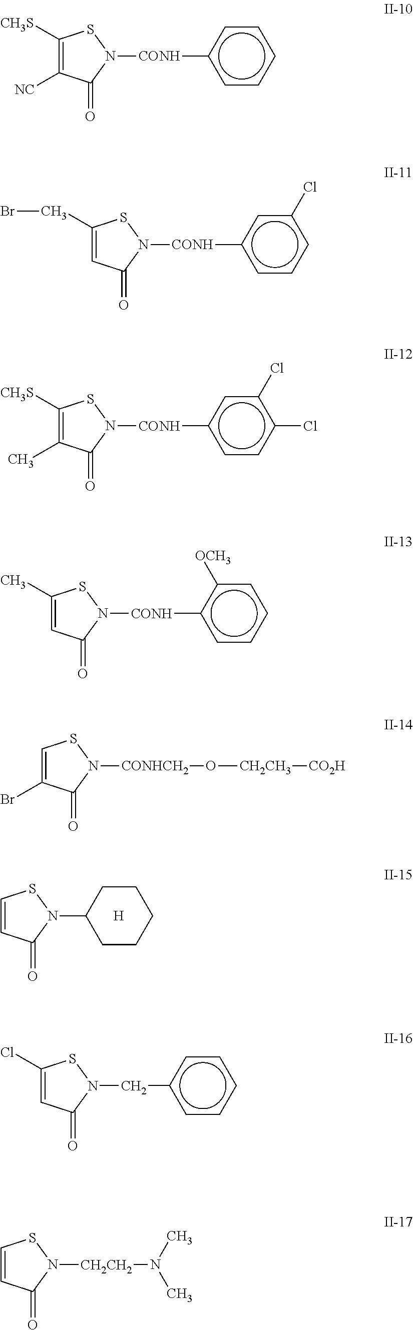

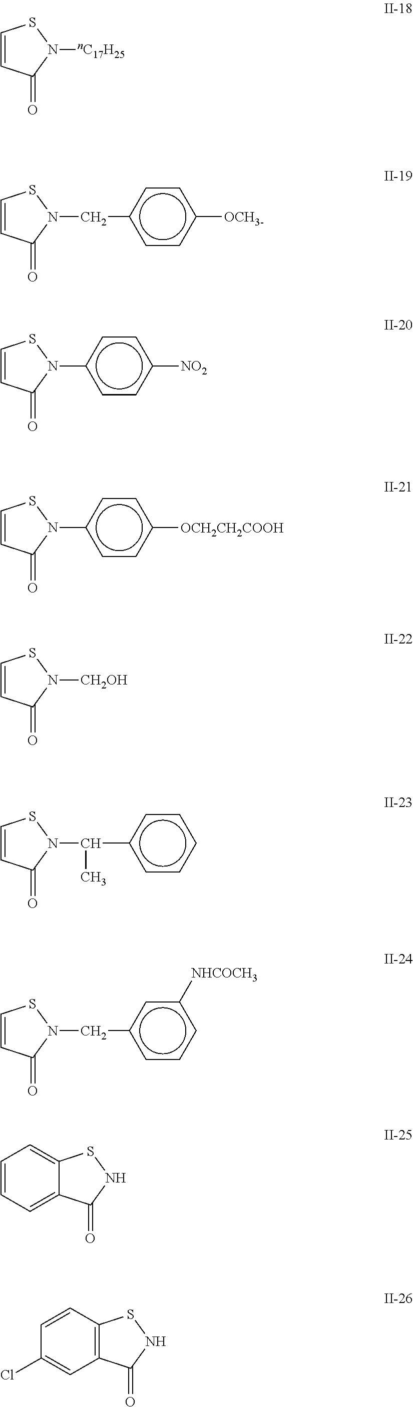

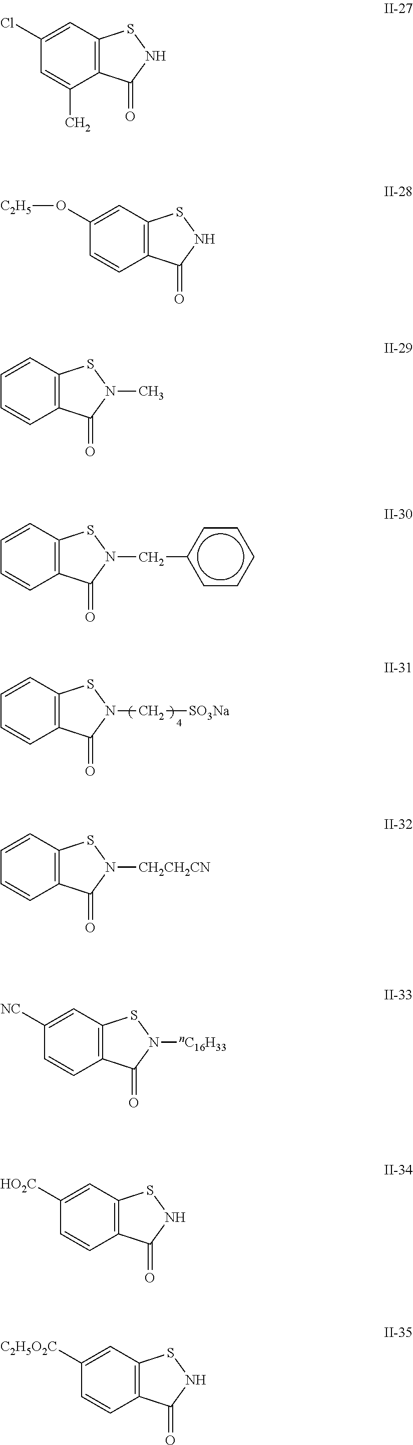

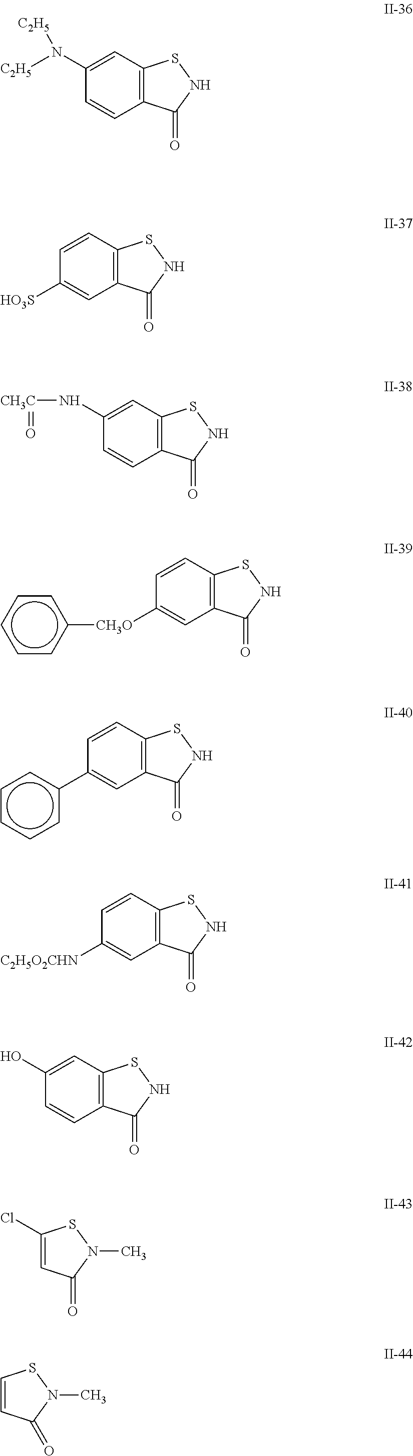

Next, description will be given of a compound which is represented by General Formula (12).

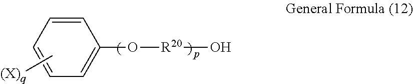

In General Formula (12), R²⁰ represents a lower alkylene group (for example, an ethylene group, a propylene group, a methylethylene group, and the like) and is particularly preferably an alkylene group with 1 to 6 carbon atoms.

X represents a halogen atom (for example, a chlorine atom, a bromine atom, and a fluorine atom), a nitro group, a hydroxyl group, a cyano group, a lower alkyl group (for example, methyl, ethyl, isopropyl, and tert-butyl), a lower alkoxy group-COR²¹, —N(R²²)(R²³), or —SO₂M.

R²¹ represents a hydrogen atom, —OM, a lower alkyl group (for example, methyl, n-butyl, and tert-octyl), an aryl group (for example, phenyl, 4-chlorophenyl, and 3-nitrophenyl), an aralkyl group (for example, benzyl, p-isopropylbenzyl, and o-methylbenzyl), a lower alkoxy group (for example, methoxy, n-butoxy, and 2-methoxyethoxy), an aryloxy group (for example, phenoxy, naphthoxy, and 4-nitrophenoxy), an aralkyloxy group (for example, benzyloxy, p-chlorobenzyloxy), or —N(R²⁴)(R²⁵).

R²² and R²³ each independently represent a hydrogen atom, a lower alkyl group (for example, methyl, ethyl, and 2-ethyhexyl), an aryl group (for example, phenyl, naphthyl, 2-methoxyphenyl, and 3-acetoamidephenyl), an aralkyl group (for example, benzyl and chlorobenzyl), —COR²⁶, or —SO₂R²⁶ and may be the same as or different from each other.

R²⁴ and R²³ each independently represent a hydrogen atom, a lower alkyl group (for example, methyl, isopropyl, and 2-cyanoethyl), an aryl group (for example, phenyl, 4-ethoxycarbonylphenyl, and 3-nitrophenyl), an aralkyl group (for example, benzyl and p-chlorobenzyl) and may be the same as or different from each other.

R²⁶ represents a lower alkyl group (for example, ethyl, 2-methoxyethyl, and 2-hydroxyethyl), an aryl group (for example, phenyl, naphthyl, 4-sulfophenyl, and 4-carboxyphenyl).

M represents a hydrogen atom, an alkali metal atom (for example, sodium or potassium), and an atomic group (for example, an ammonium cation or a phosphonium cation) which is necessary for forming a monovalent cation.

p represents 0 or 1.

q represents an integer of 0 to 5.

The preferable number of carbon atoms of the lower alkyl group and the lower alkoxy group which are represented by General Formula (12) described above is a range of 1 to 8. More preferably, R²⁰ is an alkyl group with 1 to 3 carbon atoms, X is a lower alkyl group, p is 1, and q is a compound which is represented by 0 or 1.

Representative specific examples will be given of the compound which is represented by General Formula (12) described above; however, the compound which is represented by General Formula (12) described above is not limited thereto. Here, the specific examples below are the same as the specific examples of the compound which is represented by General Formula (IV) in JP1991-199347A (JP-H3-199347A).

Here, among the compounds below, Compound IV-1 or Compound IV-18 is preferably used in the present invention and Compound IV-18 is more preferably used.

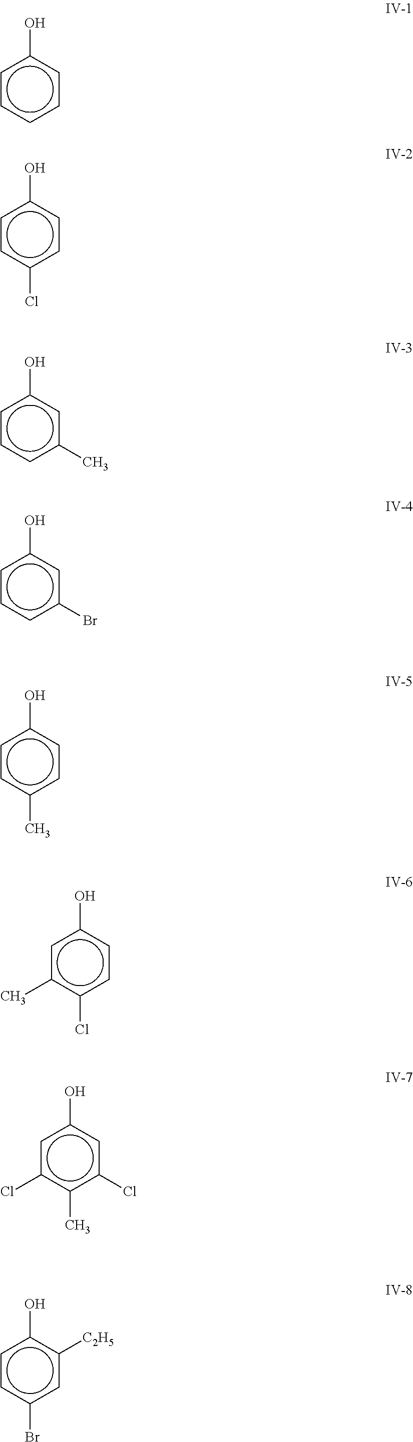

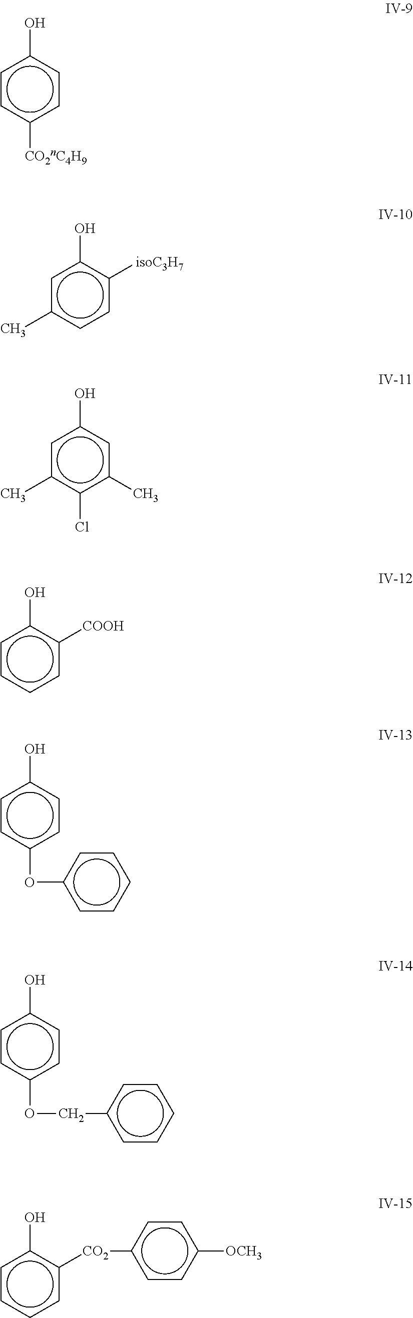

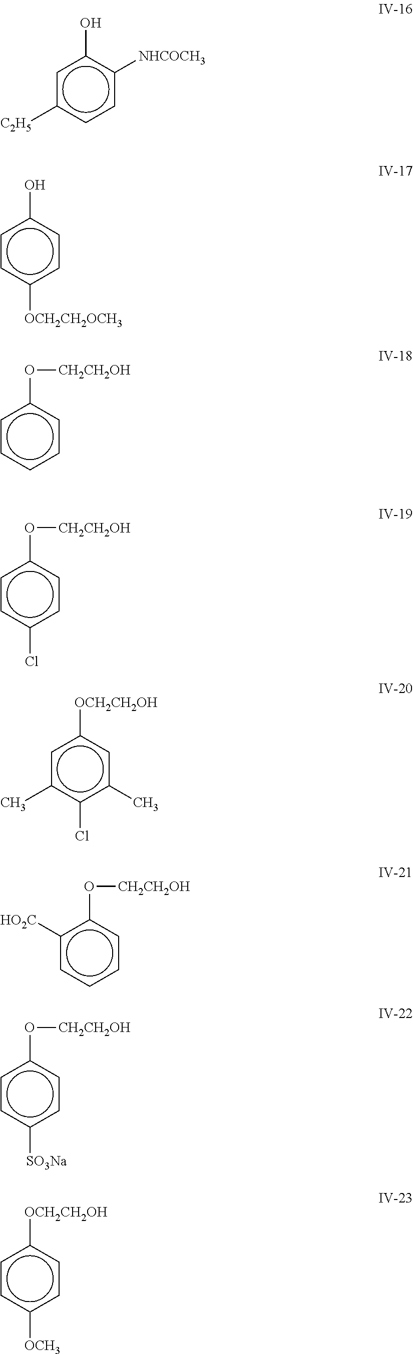

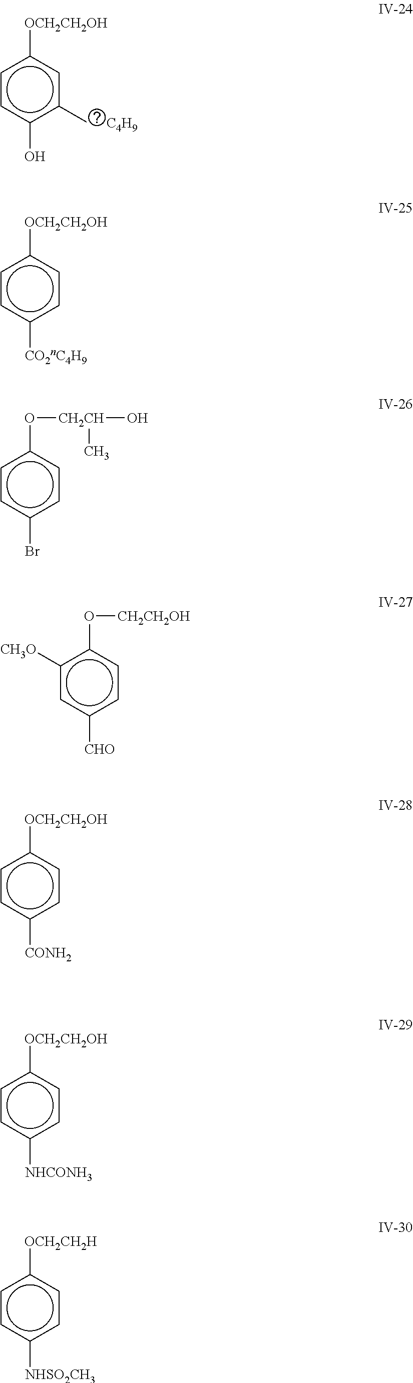

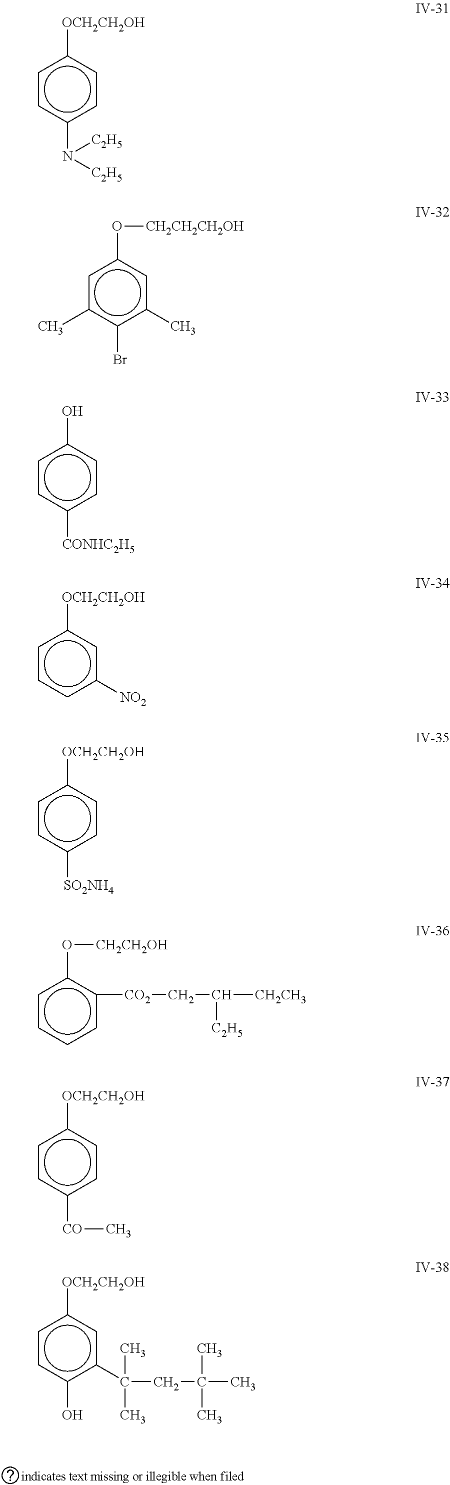

The majority of the exemplified compounds are commercially available as reagents easily obtained, and, moreover, easily synthesized by synthesis methods known in the art. For example, it is possible to easily synthesize some compounds where m=1 by the method described on page 669 in Vol 41 of J. Am. Chem. Soc. (1919).

The added amount of the preservative described above is appropriately in a range of 1 ppm to 500 ppm with respect to the total weight of the dispersing liquid in a case where the preservative described above is a compound which is represented by General Formula (11) described above and appropriately in a range of 10 ppm to 5,000 ppm with respect to the total weight of the dispersing liquid in a case where the preservative described above is a compound which is represented by General Formula (12) described above.

The preservative agent described above may be dissolved in water or an organic solvent such as methanol, isopropanol, acetone, and ethylene glycol and added to the flat metal particle dispersing liquid of the present invention as a solution or a method may be used in which the preservative agent is added to the flat metal particle dispersing liquid of the present invention after being emulsified and dispersed in the presence of a surfactant after being dissolved in a solvent with a high boiling point, a solvent with a low boiling point, or a mixture of both of the solvents, or the like.

Defoaming Agent:

In the present invention, a defoaming agent is preferably used in a step of preparing or re-dispersing the flat metal particles. When preparing or re-dispersing the particles, a reaction liquid or a coarse dispersing liquid may be stirred hard. Although it depends on the properties of the target liquid, since the foam is stabilized due to the presence of substances which decrease the surface tension, in many cases, foaming is promoted by the surfactant, the dispersing agent, or the like.

There are times when remarkable foaming occurs in a case where the liquid is stirred hard in the presence of a gas-liquid interface, a case of using a facility which uses a pressurized seal instead of a mechanical seal, and the like. In a case of an open system, there is a problem in that the foam may overflow from a container or the like and, even when there is no overflow, there may be a situation which is not preferable, such as a dispersing agent or the like drying and forming a coating film at the upper part of the foam. Even in a closed system, particles which are taken in the foam are subsequently separated from the particle growth or dispersion operation, which causes a loss of evenness.

As defoaming agents, it is possible to use agents selected from general defoaming agents such as a surfactant, or polyether-based, ester-based, higher alcohol-based, mineral oil-based, or silicone-based agents. Among these, a surfactant is preferably used since it is possible to exhibit a high defoaming effect with a small amount thereof and the stability over time is excellent.

In a case of use in a water-based agent, a surfactant with high lipophilicity which is easily dispersed on a liquid surface, that is, a surfactant with a low HLB value, is preferably used. In a case of use in a water-based agent, a surfactant with a HLB value of 7 or less is preferable, 5 or less is more preferable, and 3 or less is most preferable.

As a defoaming agent, it is also possible to use commercially available agents and, for example, it is possible to preferably use PLURONIC 31R1 (produced by BASF Japan Corp.) and the like.

<Infrared Ray Absorbing Compound-Containing Layer>

The heat-shielding material of the present invention may include an infrared ray absorbing compound-containing layer which contains a compound which has absorption in an infrared region. The layer which contains a compound which has absorption in an infrared region is also referred to below as an infrared ray absorbing compound-containing layer. Here, the infrared ray absorbing compound-containing layer may act as another functional layer (for example, a metal particle reflection adjusting layer).

The absorption peak wavelength of the infrared ray absorbing compound-described above is preferably shorter than the reflection peak wavelength of the metal particles described above from the point of view of efficiently shielding heat rays.

In the heat-shielding material of the present invention, the infrared ray absorbing compound described above is preferably included in the infrared ray absorbing compound-containing layer described above at 10 mg/m² to 190 mg/m². It is possible to improve the planarity of the heat-shielding material by the coloring material which is included in the infrared ray absorbing compound-containing layer described above being in the range of 190 mg/m² or less. As the method for controlling the coloring material which is included in the infrared ray absorbing compound-containing layer described above to be in this range, it is possible to use a method for adjusting a coloring material coating amount when film-forming the infrared ray absorbing compound-containing layer described above by coating and the like.

The upper limit value of the content of the coloring material which is included in the infrared ray absorbing compound-containing layer described above is preferably 150 mg/m² or less from the point of view of improving the planarity, more preferably 120 mg/m² or less from the point of view of improving the maximum reflection rate of the heat-shielding material and suppressing the transmittance in the maximum reflection wavelength, and particularly preferably 100 mg/m² or less.

On the other hand, the lower limit value of the content of the infrared ray absorbing compound which is included in the infrared ray absorbing compound-containing layer described above is preferably 10 mg/m² or more from the point of view of increasing the maximum reflection rate of the heat-shielding material and suppressing the transmittance in the maximum reflection wavelength, more preferably 20 mg/m² or more from the same point of view, and particularly preferably 30 mg/m² or more from the same point of view.

The density of the infrared ray absorbing compound described above in the infrared ray absorbing compound-containing layer described above is preferably 0.10 g/cm³ or more from the point of view of decreasing the transmittance in the maximum reflection wavelength and decreasing the portion of the absorption rate with respect to the reflection rate in the maximum reflection wavelength, more preferably 0.15 g/cm³ to 1.0 g/cm³, particularly preferably 0.15 g/cm³ to 0.40 g/cm³, and more particularly preferably 0.15 g/cm³ to 0.30 g/cm³.

(Configuration of Infrared Ray Absorbing Compound-containing Layer) In the heat-shielding material of the present invention, the film thickness of the infrared ray absorbing compound-containing layer described above is preferably 200 nm or less from the point of view of improving the planarity, more preferably 50 nm to 200 nm, and particularly preferably 100 nm to 200 nm from the point of view of increasing the maximum reflection rate and reducing the transmittance in the maximum reflection wavelength.

The refractive index of the infrared ray absorbing compound-containing layer described above is not particularly limited; however, although there is also a relationship with the film thickness, it is preferable to adjust the refractive index by changing the composition or adjusting the thickness so as to satisfy Conditions (1-1), (2-1), (3-1), (4-1), (5-1), and (6-1) described above from the point of view of increasing the visible light transmittance and increasing the infrared light reflection rate.

The infrared ray absorbing compound-containing layer described above may be arranged adjacent to the substrate described above or may be arranged via another layer therebetween. That is, in the heat-shielding material of the present invention, the infrared ray absorbing compound-containing layer described above may be arranged adjacent to the substrate described above and the infrared ray absorbing compound-containing layer described above may have at least one or more layers (lower layers) on a surface on the opposite side of the surface on the side which has a metal particle-containing layer. Description will be given of the lower layers below.

### (Infrared Ray Absorbing Compound)

The infrared ray absorbing compound described above is not particularly limited as long as the compound has absorption in the infrared region and it is possible to use coloring materials which are known in the art. Examples of the coloring material include a dye, a pigment, and the like, and an infrared ray absorbing pigment is preferable.

The pigments described above are not particularly limited and it is possible to use pigments which are known in the art. Examples thereof include the pigments described in “0032” to “0039” in JP2005-17322A and the like.

The dye described above is not particularly limited and it is possible to use dyes which are known in the art. A dye which may be stably dissolved or dispersed in an aqueous dispersion of a polymer is preferable and, moreover, the dyes preferably have a water-soluble group. Examples of the water-soluble groups include carboxyl groups and salts thereof, sulfo groups and salts thereof, and the like. Furthermore, a water-soluble dye which is represented by a cyanine-based dye or a barbituric acid oxonol-based dye which will be described below is preferable from the point of view of the environmental influence and of reducing the coating cost in terms of being able to carry out the coating by making a water solution without dissolution in an organic solvent. In addition, the dyes are preferably used as an assembly and particularly preferably used as a J assembly. By making a J assembly, it is easy to set the absorption wavelength of a dye which has an absorption maximum in the visible region to a desired near infrared ray region in a non-assembled state. In addition, it is possible to improve the durability of the dye such as the heat resistance, the moisture and heat resistance, and the lightfastness. In addition, a form in which the water solubility of the dyes is adjusted and made sparingly soluble or insoluble or, in other words, used as a lake dye, is also preferable. Due to this, it is possible to improve the durability of the dyes such as the heat resistance, the moisture and heat resistance, and the lightfastness, which is preferable.

In the heat-shielding material of the present invention, the coloring materials described above are preferably infrared ray absorbing coloring materials from the point of view of selectively reflecting the heat rays (near infrared rays).

As the infrared ray absorbing coloring materials described above, it is possible to preferably use the near infrared ray absorbing dyes which are described in JP2008-181096A, JP2001-228324A, JP2009-244493A, and the like, the near infrared ray absorbing compounds which are described in JP2010-90313A, and the like.

Examples of the infrared ray absorbing coloring materials described above include cyanine dyes, oxonol dyes, and pyrrolopyrrole compounds.

In the heat-shielding material of the present invention, the infrared ray absorbing compounds described above are preferably compounds which are represented by General Formula (1) below or compounds which are represented by General Formula (2) below, and more preferably a pyrrolopyrrole compound which is represented by General Formula (2) described above from the point of view of increasing the robustness and improving the preserving property.

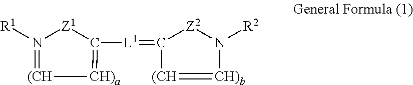

(In General Formula (1), Z¹ and Z² are each independently a non-metal atomic group which forms a 5-membered or 6-membered nitrogen-containing hetero ring. R¹ and R² are each independently an aliphatic group or an aromatic group. L is a methine chain formed by three methines. a and b are each independently 0 or 1.)

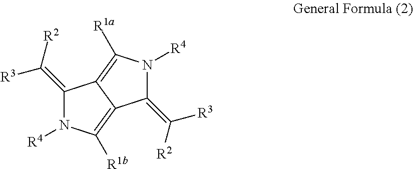

(In General Formula (2), R^{1a} and R^{1b} may be the same or different and each independently represent an alkyl group, an aryl group, or a heteroaryl group. R² and R³ each independently represent a hydrogen atom or a substituent group and at least one thereof is an electron withdrawing group and R² and R³ may bond with each other to form a ring. R⁴ represents a hydrogen atom, an alkyl group, an aryl group, a heteroaryl group, substituted boron, or a metal atom and may covalently bond or coordinatively bond with at least one or more groups of R^{1a}, R^{1b}, and R³.)

The preferable range of the compound which is represented by General Formula (1) described above is the same as the preferable range of General Formula (I) in JP2001-228324A.

The preferable range of the compound which is represented by General Formula (2) described above is the same as the preferable range of General Formula (1) in JP2009-263614A.

(1) Cyanine Dye

As the cyanine dye described above, methine dyes such as a pentamethine cyanine dye, a heptamethine cyanine dye, and a nonamethine cyanine dye are preferable, and the methine dyes which are described in JP2001-228324A and the like are preferable. A cyclic group of the cyanine dye preferably has a thiazole ring, an indolenine ring, or a benzoindolenine ring.

Examples of the cyanine dye described above which is used in the present invention include a cyanine dye which is represented by General Formula (1) described above, that is, General Formula (I) in JP2001-228324A and, among these, a pentamethine cyanine dye, a heptamethine cyanine dye, or a nonamethine cyanine dye (particularly an assembly thereof) is preferable, the pentamethine cyanine dye, the heptamethine cyanine dye, or the nonamethine cyanine dye (particularly assemblies thereof) which is represented by General Formula (II) in JP2001-228324A is more preferable, and the heptamethine cyanine dye which is represented by General Formula (II) in JP2001-228324A is particularly preferable.

(2) Oxonol Dyes

The oxonol dye described above is preferably an oxonol dye which is represented by General Formula (II) in JP2009-244493A and, among these, a barbituric acid oxonol dye which has a barbituric acid ring is more preferable.

(3) Pyrrolopyrrole Compound

The pyrrolopyrrole compound described above is preferably a pyrrolopyrrole compound which is represented by General Formula (2), that is, General Formula (1) in JP2009-263614A or JP2010-90313A, and more preferably a pyrrolopyrrole compound which is represented by any of General Formulas (2), (3), or (4) in JP2009-263614A or JP2010-90313A.

(Polymer)

The heat-shielding material of the present invention preferably includes a polymer in the infrared ray absorbing compound-containing layer described above. It is possible to use the polymer described above as a so-called binder in the infrared ray absorbing compound-containing layer described above.

In the heat-shielding material of the present invention, the mass ratio (polymer/coloring material ratio) of the polymer described above with respect to the coloring materials described above in the infrared ray absorbing compound-containing layer described above is preferably 5 or less from the point of view of reducing the transmittance in the maximum reflection wavelength and reducing the portion of the absorption rate with respect to the reflection rate in the maximum reflection wavelength. The mass ratio of the polymer described above with respect to the pigments described above in the infrared ray absorbing compound-containing layer described above is more preferably 0.1 to 4, and particularly preferably 0.2 to 3.0, and more particularly preferably 0.5 to 3.0.

The preferable range of the content of the polymer which is included in the infrared ray absorbing compound-containing layer described above is also related to the preferable range of the mass ratio of the polymer described above with respect to the coloring materials described above; however, for example, 350 mg/m² or less is preferable from the point of view of the planarity and 30 mg/m² or more is preferable from the point of view of adhesion to a substrate.

The type of the polymer described above is not particularly limited and it is possible to use a polymer which is known in the art and a transparent polymer is more preferably used. Examples of the polymer described above include a polyvinyl acetal resin, a polyvinyl alcohol resin, a polyvinyl butyral resin, a polyacrylate resin, a polymethyl methacrylate resin, a polycarbonate resin, a polyvinylchloride resin, a (saturated) polyester resin, a polyurethane resin, polymers such as natural polymers such as gelatin and cellulose, and the like. Among these, in the heat-shielding material of the present invention, the polymer described above is preferably a polyester, polyurethane, or polyacrylate resin, and more preferably polyester or polyurethane from the point of view of adhesion to a substrate.

In the heat-shielding material of the present invention, the polymer described above is preferably an aqueous dispersion from the point of view of the environmental influence and the point of reducing the coating cost.

In the present invention, as the polymer described above, it is possible to preferably use PLASCOAT Z-592 (produced by Goo Chemical Co., Ltd.) which is a water-soluble polyester resin, HYDRAN HW-350 (produced by DIC Corporation) which is a water-soluble polyurethane resin, and the like.

(Filler)

In addition, the heat-shielding material of the present invention preferably contains the filler described above in at least either layer of an infrared ray absorbing compound-containing layer or a metal particle reflection adjusting refractive index layer, and more preferably includes the filler described above in the infrared ray absorbing compound-containing layer.

The type or the content of the filler which is included in the infrared ray absorbing compound-containing layer is the same as the type or the content of the filler which is included in the metal particle reflection adjusting refractive index layer, and the preferable range thereof is also the same.

<Substrate>

The heat-shielding material of the present invention preferably has a substrate.

The substrate described above is not particularly limited and it is possible to use the substrate which is known in the art.

The substrate described above is not particularly limited as long as the substrate is an optically transparent substrate, it is possible to appropriately select the substrate according to the purpose, and examples thereof include a substrate with visible light transmittance of 70% or more, preferably 80% or more, a substrate of which the transmittance in the near infrared ray region is high, and the like.

The shape, structure, size, material, and the like of the substrate described above are not particularly limited and it is possible to appropriately select the above according to the purpose. Examples of the shape described above include a flat form and the like, the structure described above may be a single layer structure or a laminated structure, and it is possible to appropriately select the size described above according to the size or the like of the heat-shielding material described above.

The material of the substrate described above is not particularly limited, it is possible to appropriately select the material according to the purpose, and examples thereof include a film formed by a polyolefin-based resin such as polyethylene, polypropylene, poly4-methylpentene-1, and polybutene-1; a polyolefin-based resin such as polyethylene terephthalate and polyethylene naphthalate; a polycarbonate-based resin, a polyvinylchloride resin, a polyphenylene sulfide-based resin, a polyether sulfone-based resin, a plyethylene sulfide-based resin, a polyphenylene ether-based resin, a styrene-based resin, an acrylic resin, a polyamide-based resin, a polyimide-based resin, a cellulose-based resin such as cellulose acetate, and the like, or a laminated film thereof. Among these, a polyethylene terephthalate film is particularly favorable.

The thickness of the substrate described above is not particularly limited and it is possible to appropriately select the thickness according to the purpose of use of the heat-shielding material and the thickness is generally approximately 10 μm to 500 μm but is preferably as thin as possible from the point of view of the demand for film-thinning. The thickness of the substrate described above is preferably 10 μm to 100 μm, more preferably 20 μm to 75 μm, and particularly preferably 35 μm to 75 μm. When the thickness of the substrate described above is sufficiently thick, there is a tendency for adhesion faults to not easily occur. In addition, when the thickness of the substrate described above is sufficiently thin, there is a tendency for the body as the material to not be excessively strong and for processing to be easy when adhering to construction materials or cars as a heat-shielding material. Furthermore, by the substrate being sufficiently thin, there is a tendency for the visible light transmittance to increase and it is possible to suppress the raw material cost.

In addition, in a case where the reflection on the substrate needs to be suppressed, that is, in a case of using the substrate as the layer C described above, a substrate with a refractive index of 1.55 or more is more preferably used.

The refractive index nC in the wavelength λ where it is desired to prevent the reflection of the layer C described above is preferably larger than a refractive index nB in the wavelength λ where it is desired to prevent the reflection of the layer B described above from the point of view that optical interference with the reflection light of the metal particle-containing layer described above occurs even between the layer B and the layer C and it is possible to obtain a better antireflection effect. In particular, in a case where the layer C is a substrate, by using a substrate with a refractive index of 1.5 or more of which the refractive index in the wavelength λ where it is desired to prevent the reflection is larger than that of normal glass (of which the refractive index n is 1.5 or less), it is easy to make a refractive index which is larger than the refractive index n2 of the layer B and use is possible as the layer C utilizing the refractive index of the substrate itself, which is preferable.

<Other Layers and Components>

### <<Adhesive Layer>>

The heat-shielding material of the present invention preferably has an adhesive layer. The adhesive layer described above is able to include an ultraviolet ray absorbing agent.

The material which is able to be used for forming the adhesive layer described above is not particularly limited, it is possible to appropriately select the material according to the purpose, and examples thereof include a polyvinyl butyral (PVB) resin, an acryl resin, a styrene/acryl resin, a urethane resin, a polyester resin, a silicone resin, and the like. These may be used as one type individually or two or more types may be used together. It is possible to coat these materials to form an adhesive layer.

Furthermore, an anti-static agent, a lubricant, an anti-blocking agent, and the like may be added to the adhesive layer described above.

The thickness of the adhesive layer described above is preferably 0.1 μm to 10 μm.

<<Hard Coat Layer>>

In order to add scratch resistance, it is favorable for the heat-shielding material of the present invention to also include a hard coat layer which has a hard coat property. It is possible to include metal oxide particles in the hard coat layer. A layer may include a compound which has absorption in the infrared region described above and a layer may contain the metal oxide particles which will be described below.

The hard coat layer described above is not particularly limited, it is also possible to appropriately select the type and the forming method according to the purpose, and examples thereof include a thermosetting type or photocuring type resin such as an acrylic resin, a silicone-based resin, a melamine-based resin, a urethane-based resin, an alkyd-based resin, and a fluorine-based resin. The thickness of the hard coat layer described above is not particularly limited and it is possible to appropriately select the thickness according to the purpose; however, the thickness is preferably 1 μm to 50 μm. When further forming an antireflection layer and/or an antiglare layer on the hard coat layer described above, it is possible to obtain a functional film which has the antireflection property and/or the antiglare property in addition to the scratch resistance, which is favorable. In addition, the metal oxide particles described above may be contained in the hard coat layer described above.

The hard coat layer described above itself may be a low refractive index layer which is included in the heat-shielding material of the present invention and may have a layer configuration formed by the low refractive index layer being laminated on the hard coat layer described above.

<<Overcoat Layer>>

In the heat-shielding material of the present invention, in order to prevent the oxidation and sulfuration of flat metal particles due to substance movement and to add scratch resistance, the heat-shielding material of the present invention may have an overcoat layer which is adjacent to the surface of the metal particle-containing layer described above where the flat metal particles with a hexagonal shape or a circular shape described above are exposed. In addition, the heat-shielding material may have an overcoat layer between the metal particle-containing layer described above and the ultraviolet ray absorbing layer which will be described below. In a case where flat metal particles are unevenly distributed on a surface of the metal particle-containing layer in particular, the heat-shielding material of the present invention may have an overcoat layer in order to prevent contamination during a manufacturing step due to the flat metal particles being peeled off, to prevent disorder in the flat metal particle array when coating another layer, and the like.

An ultraviolet ray absorbing agent may be included in the overcoat layer described above. The overcoat layer described above is not particularly limited and it is possible to appropriately select the overcoat layer according to the purpose; however, for example, the overcoat layer is formed to contain a binder, a matting agent, and a surfactant and further contain other components as necessary. The binder described above is not particularly limited, it is possible to appropriately select the binder according to the purpose, and examples thereof include a thermosetting type or photocuring type resin such as an acrylic resin, a silicone-based resin, a melamine-based resin, a urethane-based resin, an alkyd-based resin, and a fluorine-based resin. The thickness of the overcoat layer described above is preferably 0.01 μm to 1,000 μm, more preferably 0.02 μm to 500 μm, particularly preferably 0.1 μm to 10 μm, and more particularly preferably 0.2 μm to 5 μm.

<<Lower Layer>>

The heat-shielding material of the present invention preferably has at least one or more layers (also referred to below as lower layers) between the metal particle-containing layer described above and the substrate described above from the point of view of prioritizing the improvement of the changes in the reflection strength after moisture and heat over time rather than the visible light transmittance.

As the lower layer, it is possible to use the same binder material, filler, and additive agent as the metal particle reflection adjusting refractive index layer and the preferable ranges thereof are also the same.

The refractive index of the lower layer described above is not particularly limited; however, although also related to the film thickness, it is preferable to adjust the refractive index by changing the composition or to adjust the thickness so as to satisfy Conditions (1-1), (2-1), (3-1), (4-1), (5-1), and (6-1) described above from the point of view of increasing the visible light transmittance and increasing the infrared light reflection rate. Here, a layer between the substrate described above and the metal particle-containing layer described above, that is, the lower layer described above, the infrared ray absorbing compound-containing layer described above, and the metal particle reflection adjusting refractive index layer are collectively referred to as an under coat layer; however, the present invention imparts functions to each layer by multilayering the so-called under coat layers.

<<Ultraviolet Ray Absorbing Agent>>

The heat-shielding material of the present invention preferably has a layer where an ultraviolet ray absorbing agent is included.

It is possible to appropriately select the layer which contains the ultraviolet ray absorbing agent described above according to the purpose and the layer may be an adhesive layer and may also be a layer (for example, an overcoat layer or the like) between the adhesive layer described above and the metal particle-containing layer described above. In either case, the ultraviolet ray absorbing agent described above is preferably added in a layer which is arranged on the side where the metal particle-containing layer described above is irradiated with sunlight.

The ultraviolet ray absorbing agent described above is not particularly limited, it is possible to appropriately select the ultraviolet ray absorbing agent according to the purpose, and examples thereof include a benzophenone-based ultraviolet ray absorbing agent, a benzotriazol-based ultraviolet ray absorbing agent, a triazine-based ultraviolet ray absorbing agent, a salicylate ultraviolet ray absorbing agent, a cyanoacrylate-based ultraviolet ray absorbing agent, and the like. These may be used as one type individually or two or more types may be used together.

The benzophenone-based ultraviolet ray absorbing agent described above is not particularly limited, it is possible to appropriately select the benzophenone-based ultraviolet ray absorbing agent according to the purpose, and examples thereof include 2,4 hydroxy-4-methoxy-5-sulfobenzophenone and the like.

The benzotriazole-based ultraviolet ray absorbing agent described above is not particularly limited, it is possible to appropriately select the benzotriazole-based ultraviolet ray absorbing agent according to the purpose, and examples thereof include 2-(5-chloro-2H-benzotriazol-2-yl)-4-methyl-6-tert-butylphenol (TINUVIN 326), 2-(2-hydroxy-5-methylphenyl)benzotriazole, 2-(2-hydroxy-5-tertiary butylphenyl) benzotriazole, 2-(2-hydroxy-3-5-ditertiary butylphenyl)-5-chlorobenzotriazole, and the like.

The triazine-based ultraviolet absorbing agent is not particularly limited, it is possible to appropriately select the triazine-based ultraviolet absorbing agent according to the purpose, and examples thereof include a mono(hydroxyphenyl) triazine compound, a bis(hydroxyphenyl) triazine compound, a tris(hydroxyphenyl) triazine compound, and the like. Examples of the mono(hydroxyphenyl) triazine compound described above include 2-[4-[(2-hydroxy-3-dodecyloxypropyl)oxy]-2-hydroxyphenyl]-4,6-bis (2,4-dimethylphenyl)-1,3,5-triazine, 2-[4-[(2-hydroxy-3-tridecyloxy propyl)oxy]-2-hydroxyphenyl]-4,6-bis(2,4-dimethylphenyl)-1,3,5-triazine, 2-(2,4-dihydroxyphenyl)-4,6-bis(2,4-dimethylphenyl)-1,3,5-triazine, 2-(2-hydroxy-4-isooctyloxyphenyl)-4,6-bis(2,4-dimethylphenyl)-1,3,5-triazine, 2-(2-hydroxy-4-dodecyloxyphenyl)-4,6-bis(2,4-dimethylphenyl)-1,3,5-triazine, and the like. Examples of the bis(hydroxyphenyl) triazine compound include 2,4-bis (2-hydroxy-4-propyloxyphenyl)-6-(2,4-dimethyl phenyl)-1,3,5-triazine, 2,4-bis (2-hydroxy-3-methyl-4-propyloxyphenyl)-6-(4-methylphenyl)-1,3,5-triazine, 2,4-bis (2-hydroxy-3-methyl-4-hexyloxyphenyl)-6-(2,4-dimethyl phenyl)-1,3,5-triazine, 2-phenyl-4,6-bis[2-hydroxy-4-[3-(methoxyheptaethoxy)-2-hydroxypropyloxy]phenyl]-1,3,5-triazine, and the like. Examples of the tris(hydroxyphenyl) triazine compound include 2,4-bis(2-hydroxy-4-butoxy phenyl)-6-(2,4-dibutoxy phenyl)-1,3,5-triazine, 2,4,6-tris(2-hydroxy-4-octyloxy phenyl)-1,3,5-triazine, 2,4,6-tris[2-hydroxy-4-(3-butoxy-2-hydroxypropyloxy) phenyl]-1,3,5-triazine, 2,4-bis[2-hydroxy-4-[1-(isooctyloxy carbonyl) ethoxy]phenyl]-6-(2,4-dihydroxyphenyl)-1,3,5-triazine, 2,4,6-tris[2-hydroxy-4-[1-(isooctyloxy carbonyl) ethoxy]phenyl]-1,3,5-triazine, 2,4-bis[2-hydroxy-4-[1-(isooctyloxy carbonyl) ethoxy]phenyl]-6-[2,4-bis[1-(isooctyloxy carbonyl) ethoxy]phenyl]-1,3,5-triazine, and the like.

The salicylate-based ultraviolet ray absorbing agent described above is not particularly limited, it is possible to appropriately select the salicylate-based ultraviolet ray absorbing agent according to the purpose, and examples thereof include phenyl salicylate, p-tert-butylphenyl salicylate, p-octylphenyl salicylate, 2-ethylhexyl salicylate, and the like.

The cyanoacrylate-based ultraviolet ray absorbing agent described above is not particularly limited, it is possible to appropriately select the cyanoacrylate-based ultraviolet ray absorbing agent according to the purpose, and examples thereof include 2-ethylhexyl-2-cyano-3,3-diphenyl acrylate, ethyl-2-cyano-3,3-diphenyl acrylate, and the like.

The binder described above is not particularly limited and it is possible to appropriately select the binder according to the purpose; however, it is preferable to have high visible light transmittance or solar radiation transmittance and examples thereof include an acryl resin, polyvinyl butyral, polyvinyl alcohol, and the like. Here, since the reflection effect due to flat metal particles is weakened when the binder absorbs heat rays, it is preferable to select materials which do not have absorption in the region of 450 nm to 1,500 nm as the ultraviolet ray absorbing layer which is formed between the heat ray source and the flat metal particles, or to reduce the thickness of the ultraviolet ray absorbing layer.

The thickness of the ultraviolet ray absorbing layer described above is preferably 0.01 μm to 1,000 μm, and more preferably 0.02 μm to 500 μm. The absorption of ultraviolet rays may not be sufficient when the thickness described above is less than 0.01 μm and the transmittance of the visible light may decrease when the thickness exceeds 1,000 μm.

It is not possible to generally regulate the content of the ultraviolet ray absorbing layer described above since it is different from the ultraviolet ray absorbing layer to be used; however, it is preferable to appropriately select the content which gives a desired ultraviolet ray transmittance in the heat-shielding material of the present invention.

The ultraviolet ray transmittance described above is preferably 5% or less and more preferably 2% or less. When the ultraviolet ray transmittance described above exceeds 5%, the hue of the flat metal particle layer described above may change due to the ultraviolet rays of the sunlight.

<<Metal Oxide Particles>>

Even when the heat-shielding material of the present invention contains at least one type of metal oxide particles in order to absorb long wave infrared rays, it is preferable from the point of view of the balance between the heat-shielding and manufacturing cost. In this case, metal oxide particles are preferably included in a hard coat layer or the rear surface layer of another substrate. When the heat-shielding material of the present invention is arranged such that a flat metal particle-containing layer is on the side in the incident direction of the heat rays such as sunlight, some of the heat rays are reflected by the metal particle-containing layer; however, some of the heat rays are transmitted. In a case of providing an infrared ray absorbing agent-containing hard coat layer 7A on the substrate surface on the opposite side of the coated surface of the metal particle-containing layer as in FIG. 3, FIG. 4A, FIG. 4B, and FIG. 5A, it is possible to further absorb some of the heat rays which pass through the metal particle-containing layer in the infrared ray absorbing agent-containing hard coat layer 7A and it is possible to further reduce the amount of heat which passes through the heat-shielding material with this configuration, which is preferable.

The material of the metal oxide particles described above is not particularly limited, it is possible to appropriately select the material according to the purpose, and examples thereof include tin-doped indium oxide (abbreviated below as “ITO”), antimony-doped tin oxide (abbreviated below as “ATO”), zinc oxide, zinc antimonate, titanium oxide, indium oxide, tin oxide, antimony oxide, glass ceramics, 6 lanthanum boride (LaB₆), cesium tungsten oxide (Cs_{0.33}WO₃, abbreviated below as “CWO”), and the like. Among these, ITO, ATO, CWO, and 6 lanthanum boride (LaB₆) are more preferable from the point of view that the heat ray absorbing abilities are excellent and that it is possible to manufacture a heat-shielding material which has a wide ranging heat ray absorbing performance by combination with the flat metal particles, and ITO is particularly preferable from the point of view that 90% or more of the infrared rays at 1,200 nm or more are shielded and the visible light transmittance is 90% or more.

The volume average particle diameter of a primary particle of the metal oxide particles described above is preferably 0.1 μm or less in order not to reduce the visible light transmittance.

The shape of the metal oxide particle described above is not particularly limited, it is possible to appropriately select the shape according to the purpose, and examples thereof include a circular shape, a needle shape, a board shape, and the like.

The content of the metal oxide particles described above is not particularly limited and it is possible to appropriately select the content according to the purpose; however, 0.1 g/m² to 20 g/m² is preferable, 0.5 g/m² to 10 g/m² is more preferable, and 1.0 g/m² to 4.0 g/m² is even more preferable.

The amount of sunlight which is felt on the skin may increase when the content described above is less than 0.1 g/m² and the visible light transmittance may deteriorate when the content exceeds 20 g/m². On the other hand, when the content described above is 1.0 g/m² to 4.0 g/m², there is an advantage in the point that it is possible to prevent the two points described above.

Here, it is possible to calculate the content of the metal oxide particles described above, for example, by measuring the number and the average particle diameter of the metal oxide particles in a set area from observing a super foil section TEM image and a surface SEM image of the heat-shielding layer described above and dividing the mass (g), which is calculated based on the number and the average particle diameter described above and the specific gravity of the metal oxide particles, by the set area (m²) described above. In addition, it is also possible to carry out the calculation by dissolving the metal oxide fine particles in the set area of the metal oxide particle-containing layer described above in methanol and dividing the mass (g) of the metal oxide fine particles which is measured by fluorescent X-rays measurement by the set area (m²) described above.

<Method for Manufacturing Heat-Shielding Material of the Present Invention>

The method for manufacturing the heat-shielding material of the present invention is not particularly limited and it is possible to appropriately select the method according to the purpose.

—Method for Forming Low Refractive Index Layer—

Examples of a method for forming a low refractive index layer include a method of coating a coating liquid which includes the fluorine-containing polyfunctional monomers described above or the low refractive particles described above on a surface of the substrate described above, the hard coat layer, the infrared ray absorbing agent-containing hard coat layer, or the like using a dip coater, a die coater, a slit coater, a bar coater, a gravure coater, and the like and a method of setting the planar orientation using a method such as an LB film method, a self-organization method, and a spraying method.

In a case of coating and forming the low refractive index layer described above, other additive agents such as solvents and surfactants other than the infrared ray absorbing compounds described above or the polymers described above may be added to the coating liquid.

The solvent which is used when forming a low refractive index layer is not particularly limited and it is possible to use water or an organic solvent which is known in the art and examples thereof include various solvents such as water, toluene, xylene, methylethyl ketone, methylisobutyl ketone, acetone, methyl alcohol, ethyl alcohol, N-propyl alcohol, 1-propyl alcohol, propylene glycol monomethyl ether, propylene glycol monomethyl ether acetate, cyclohexanone, cyclohexanol, ethyl acetate, methyl acetate, ethyl lactate, methyl lactate, and caprolactam by matching the solubility of the compound which is used for forming the low refractive index layer.

The solvent described above may be used in a combination of two or more types in addition to using one type individually. There are also cases where it is preferable to use a combination of two or more types of different solvents with different boiling points by matching the drying conditions after coating.

—Method for Forming Infrared Ray Absorbing Compound-Containing Layer—

The method for forming an infrared ray absorbing compound-containing layer is not particularly limited, it is possible to appropriately select the method according to the purpose, and examples thereof include a method for coating a dispersing liquid which has the coloring materials described above using a dip coater, a die coater, a slit coater, a bar coater, a gravure coater, and the like and a method for setting the planar orientation using a method such as an LB film method, a self-organization method, and a spraying method. The infrared ray absorbing compound-containing layer described above is preferably formed by coating. That is, the infrared ray absorbing compound-containing layer described above is preferably a coloring material coated layer. Furthermore, among these, a method of coating by a bar coater is preferable.

In a case of forming the infrared ray absorbing compound-containing layer described above by coating, other additive agents such as solvents and surfactants may be added to the coating liquid in addition to the infrared ray absorbing compounds described above or the polymers described above.

The solvent described above is not particularly limited, it is possible to use water or an organic solvent which is known in the art and examples thereof include various solvents such as water, toluene, xylene, methylethyl ketone, methylisobutyl ketone, acetone, methyl alcohol, N-propyl alcohol, 1-propyl alcohol, propylene glycol monomethyl ether, propylene glycol monomethyl ether acetate, cyclohexanone, cyclohexanol, ethyl lactate, methyl lactate, and caprolactam. In the present invention, an aqueous solvent is preferably used from the point of view of the environmental effect and the point of reducing the coating cost.

The solvent described above may be used in a combination of two or more types in addition to using one type individually. In the present invention, in detail, it is more preferable to use an aqueous solvent where water and methanol are combined.

Examples of the other additive agents include the surfactants or the additive agents described in paragraphs “0027” to “0031” in JP2005-17322A.

The surfactant described above is not particularly limited but may be any of an aliphatic, aromatic, or fluorine-based surfactant and may also be any of a nonion-based, anion-based, or cation-based surfactant. Examples of the surfactants described above include those described in JP2011-218807A and the like.

In detail, RAPIZOL A-90 produced by NOF Corporation, NAROACTY CL95 produced by SANYO CHEMICAL INDUSTRIES, Ltd., and the like are preferably used as the surfactant described above.

The surfactant described above may be used in a combination of two or more types in addition using one type individually.

In a case of forming the infrared ray absorbing compound-containing layer described above by coating, the preferably ranges of the infrared ray absorbing compound coating amount and the polymer coating amount are respectively the same as the preferable ranges of the content of the infrared ray absorbing compounds described above and the content of the polymers described above which are included in the infrared ray absorbing compound-containing layer described above.

In a case of forming the infrared ray absorbing compound-containing layer described above by coating, it is preferable to form the infrared ray absorbing compound-containing layer described above by using a method which is known in the art to dry and solidify the coating liquid described above after coating. The drying method is preferably drying by heat.

—Method for Forming Metal Particle-Containing Layer—

The method for forming a metal particle-containing layer is not particularly limited, it is possible to appropriately select the method according to the purpose, and examples thereof include a method of coating a dispersing liquid (a flat metal particle dispersing liquid) which has the flat metal particles described above on a surface of the lower layer of the substrate described above using a dip coater, a die coater, a slit coater, a bar coater, a gravure coater, and the like and a method of setting the planar orientation using a method such as an LB film method, a self-organization method, and a spraying method.

Here, the planar orientation may be promoted by passing the layer through pressure rollers such as a calendar roller and a laminating roller after coating the flat metal particles.

—Method for Forming Overcoat Layer—

The overcoat layer is preferably formed by coating. The coating method at this time is not particularly limited, it is possible to use the method which is known in the art, and examples thereof include a method of coating a dispersing liquid which contains the ultraviolet ray absorbing agent described above using a dip coater, a die coater, a slit coater, a bar coater, or a gravure coater.

—Method for Forming Hard Coat Layer—

The hard coat layer is preferably formed by coating. The coating method at this time is not particularly limited, it is possible to use the method which is known in the art, and examples thereof include a method of coating a dispersing liquid which contains the ultraviolet ray absorbing agent described above using a dip coater, a die coater, a slit coater, a bar coater, or a gravure coater.

—Method for Forming Adhesive Layer—

The adhesive layer described above is preferably formed by coating. For example, it is possible to carry out the lamination on a surface of a lower layer of the substrate described above, the metal particle-containing layer described above, the ultraviolet ray absorbing layer described above, or the like. The coating method at this time is not particularly limited and it is possible to use a method which is known in the art.

It is possible to laminate an adhesive agent layer in a dry state by producing a film by coating and drying an adhesive agent on a mold releasing film in advance and laminating the adhesive agent surface of the film described above and the heat-shielding material surface of the present invention. The method for laminating at this time is not particularly limited and it is possible to use a method which is known in the art.

[Window Glass]

As shown in the example in FIG. 5A, in a case of adding functional properties to types of existing window glass using the heat-shielding material of the present invention, the adhesive agent is preferably laminated and adhered to the indoor side of the window glass. At this time, the infrared ray reflection layer is preferably arranged on the sunlight side if possible since it is possible to reflect infrared rays incident to the room in advance and, from this point of view, the adhesive layer is preferably laminated such that the metal particle-containing layer is arranged on the sunlight incident side. In detail, it is preferable to provide the adhesive layer on the metal particle-containing layer or a functional layer such as an overcoat layer or the like which is provided on the metal particle-containing layer and adhere the adhesive layer to the window glass via the adhesive layer. When adhering the heat-shielding material on the window glass, it is preferable to coat the adhesive layer or prepare the heat-shielding material which is provided by lamination and to provide the heat-shielding material on the window glass via the adhesive layer after spraying a water solution which includes a surfactant (mainly anion-based) onto the window glass surface and the adhesive layer surface of the heat-shielding material described above in advance. Since the adhesiveness of the adhesive layer decreases while the moisture is evaporated, it is possible to adjust the position of the heat-shielding material on the glass surface. It is possible to fix the heat-shielding material described above on the window glass surface after wiping away the moisture which remains between the window glass and the heat-shielding material from the glass center out toward the ends using a squeegee or the like after determining the adhering position of the heat-shielding material described above with respect to the window glass. Doing this makes it possible to install the heat-shielding material on the window glass.

The heat-shielding material of the present invention is not particularly limited as long as the aspect thereof is used for selectively reflecting (absorbing as necessary) heat rays (near infrared rays) and may be appropriately selected according to the purpose and examples thereof include films or lamination structures for vehicles, films or lamination structures for construction materials, films for agriculture, and the like. Among these, in terms of the energy saving effect, films or lamination structures for vehicles and films or lamination structures for construction materials are preferable.

### EXAMPLES

More detailed description will be given below of features of the present invention using Examples.

It is possible to appropriately change the materials, the usage amount, the portion, the process content, the process order, and the like which are shown in the Examples below within a scope which does not depart from the spirit of the invention. Therefore, the range of the present invention is not to be interpreted as limited by the specific examples which will be shown below.

### Manufacturing Examples

### Preparation and Evaluation of Flat Metal Particles

### Preparation of Flat Metal Particle Dispersing Liquid

13 L of ion-exchanged water was measured using a reactor vessel of NTKR-4 (manufactured by Nippon Metal Industry Co., Ltd.) and, while stirring using a chamber which is provided with an agitator where four propellers made of NTKR-4 and four paddles made of NTKR-4 are attached to a shaft made of SUS 316L, 1.0 L of a 10 g/L trisodium citrate (anhydride) water solution was added and the temperature was kept at 35° C. 0.68 L of a 8.0 g/L polystyrene sulfonic acid water solution was added and 0.041 L of a sodium borohydride water solution which was prepared to be 23 g/L using a sodium hydroxide water solution of 0.04 N was further added. 13 L of a 0.10 g/L silver nitrate water solution was added at 5.0 L/min.

1.0 L of a 10 g/L trisodium citrate (anhydride) water solution and 11 L of ion-exchanged water were added and 0.68 L of a 80 g/L hydroquinone sulfonic acid potassium water solution was further added. Stirring was increased to 800 rpm and, after adding 8.1 L of a 0.10 g/L silver nitrate water solution at 0.95 L/min, the temperature was decreased to 30° C.

8.0 L of a 44 g/L methylhydroquinone water solution was added and, subsequently, all of a gelatin water solution at 40° C. which will be described below was added. The stirring was increased to 1,200 rpm and all of a silver sulfite white sediment mixed liquid which will be described below was added.

In the phase when the pH of the prepared liquid stopped changing, 5.0 L of a 1 N NaOH water solution was added at 0.33 L/min. After that, 0.18 L of a 2.0 g/L 1-(m-sulfophenyl)-5-mercapto tetrazole sodium water solution (adjusted to pH=7.0±1.0 and dissolved, using NaOH and citric acid (anhydride)) was added and 0.078 L of 70 g/L 1,2-benzisothiazoline-3-one (dissolved after adjusting the water solution to alkalinity using NaOH) was further added. A silver flat particle dispersing liquid A3 was prepared in this manner.

—Preparation of Gelatin Water Solution—

16.7 L of ion-exchanged water was measured in a dissolving tank made of SUS 316L. While performing low-speed stirring using an agitator made of SUS 316L, 1.4 kg of alkali processed bovine bone gelatin (GPC weight average molecular weight 200,000) on which a deionizing process was carried out was added. Furthermore, 0.91 kg of alkali processed bovine bone gelatin (GPC weight average molecular weight 21,000) on which a deionizing process, a protease process, and an oxidizing process using hydrogen peroxide were carried out was added. After that, the temperature was raised to 40° C. and the gelatin was completely dissolved by adding and dissolving the gelatin at the same time.

—Preparation of Silver Sulfite White Sediment Mixed Liquid—

8.2 L of ion-exchanged water was measured in a dissolving tank made of SUS 316L and 8.2 L of an silver nitrate water solution was added at 100 g/L. A mixed liquid which includes white sediment of silver sulfite was prepared by adding 2.7 L of a sodium sulfite water solution of 140 g/L for a short period while performing high speed stirring using an agitator made of SUS 316L. The mixed liquid was prepared directly before use.

When the silver flat particle dispersing liquid A3 was diluted using ion-exchanged water and the spectral absorption was measured using a spectrophotometer (U-3500 manufactured by Hitachi Ltd.), the absorption peak wavelength was 900 nm and the full width at half maximum was 270 nm.

The physical characteristics of the silver flat particle dispersing liquid A3 were pH=9.4 (measured using KR5E manufactured by AS ONE Corp.), electric conductance 8.1 mS/cm (measured using CM-25R manufactured by DKK-TOA Corp.), and viscosity 2.1 mPa-s (measured using SV-10 manufactured by A & D Co., Ltd.) at 25° C. The obtained silver flat particle dispersing liquid A3 was put in a 20 L union container II type container (made of low density polyethylene, vendor: AS ONE Corp.) and stored at 30° C.

—Desalinizing and Re-Dispersing Flat Metal Particle Dispersing Liquid—

800 g of the silver flat particle dispersing liquid A3 described above was taken into a centrifuge tube and adjusted to pH=9.2±0.2 at 25° C. using 1N NaOH and/or 1N sulfuric acid. After setting the temperature to 35° C. and performing a centrifugal separation operation at 9000 rpm for 60 minutes using a centrifugal separator (himac CR22G III, angle rotor R9A manufactured by Hitachi Koki Co., Ltd.), 784 g of a supernatant was discarded. A 0.2 mM NaOH water solution was added to the precipitated silver flat particles to make 400 g in total and a coarse dispersing liquid was obtained by stirring by hand using a stirring bar. A coarse dispersing liquid for 24 was prepared by the same operation to make 9600 g in total and added and mixed in a tank made of SUS 316L. Furthermore, 10 mL of a 10 g/L solution (diluted by a mixed liquid of methanol:ion-exchanged water=1:1 (volume ratio)) of PLURONIC 31R1 (produced by BASF Japan Corp.) were added. Using an auto mixer 20 model (the stirrer is a HOMOMIXER MARK II) manufactured by PRIMIX Corp., a batch type dispersing process was carried out on the coarse dispersing liquid mixture in the tank at 9,000 rpm for 120 minutes. The liquid temperature during the dispersing was kept to 50° C. After the temperature was decreased to 25° C. after the dispersing, a single pass filtration was performed using a PROFILE II filter (manufactured by Pall Corp., product model MCY 1001Y030H13).

In this manner, a desalinizing process and re-dispersing process were carried out on the silver flat particle dispersing liquid A3 and a silver flat particle dispersing liquid B3 was prepared.

When the spectral transmittance of the silver flat particle dispersing liquid B3 was measured with the same method as the silver flat particle dispersing liquid A3, the absorption peak wavelength and the full width at half maximum were substantially the same as the results for the silver flat particle dispersing liquid A3.

The physical characteristics of the dispersing liquid B3 were pH=7.6, the electric conductance was 0.37 mS/cm, and the viscosity was 1.1 mPa·s at 25° C. The obtained silver flat particle dispersing liquid B3 was put in a 20 L union container II type container and stored at 30° C.

—Evaluation of Flat Metal Particles—

It was confirmed that flat particles with a hexagonal shape, a circular shape, or a triangular shape were generated in the silver flat particle dispersing liquid A3. An image of the silver flat particle dispersing liquid A which was obtained by observing using TEM was imported into image processing software Image J and image processing was carried out. Image analysis was performed on 500 particles which were arbitrarily extracted from TEM images of a fields of view and the area circle equivalent diameter was calculated. According to the results of a population-based statistics process, the average diameter was 120 nm.

The silver flat particle dispersing liquid A3 was measured using a laser diffraction, scattered particle diameter and particle size distribution measuring apparatus Microtrack MT 3300 II (manufactured by Nikkiso Co., Ltd., in which the particle transmittance was set to reflection) and the results of median diameters D50=48 nm, D10=33 nm, D90=70 nm, and the average particle diameter (volume weighing) 51 nm were obtained.

In addition, when the flat metal particles were measured, the result was 97% by number.

When the silver flat particle dispersing liquid B3 was measured in the same manner, substantially the same results as for the silver flat particle dispersing liquid A3 were obtained including the shape of the particle size distribution.

The silver flat particle dispersing liquid B3 was dripped onto a silicon substrate and dried and thickness of each of the silver flat particles was measured by an FIB-TEM method. 10 of the silver flat particles in the silver flat particle dispersing liquid B3 were measured and the average thickness was 8.2 nm.

Following the preparation method of the silver flat particle dispersing liquid A3, the added amounts of various types of chemicals, the adding speed, the stirring rotation speed, and the temperature were appropriately adjusted, silver flat particle dispersing liquids A1 and A2 which contain silver flat particles which have different average diameters and average thicknesses were prepared, and, following the method of preparing the silver flat particle dispersing liquid B3 from the silver flat particle dispersing liquids A1 and A2, the silver flat particle dispersing liquids B1 and B2 were prepared.

The measurement results of the shape of the silver flat particles which are included in the silver flat particle dispersing liquids B1 to B3 are shown in Table 1.

TABLE 1

| Silver flat particle | Flat particle shape | | |
|---|---|---|---|
| dispersing liquid | Thickness [nm] | Diameter [nm] | Aspect ratio |
| A1, B1 | 15.0 | 205 | 13.7 |
| A2, B2 | 10.3 | 145 | 14.1 |
| A3, B3 | 8.2 | 120 | 14.6 |

<Production of Heat-shielding Material>

Description will be given below of the production of the heat-shielding material. The raw materials which were used for preparing the coating liquid were appropriately processed and used by diluting the purchased original materials, making a dispersion, and the like.

(Preparation of Coating Liquid M1 for Metal Particle-Containing Layer)
-Silver Flat Particle-Containing Heat-Shielding Layer Coating Liquid-

| | |
|---|---|
| Aqueous urethane resin: HYDRAN HW350 | 0.27 parts by mass |
| (produced by DIC Corporation, solid content | |
| 30 mass %) | |
| Silver flat particle dispersing liquid B1 | 16.24 parts by mass |
| 1-(methylureidephenyl)-5-mercapto tetrazole | 0.61 parts by mass |
| (produced by Wako Pure Chemical Industries, | |
| Ltd., an alkali water solution with solid | |
| content 2 mass % was prepared) | |
| Surfactant A: REPEARL 870P (produced by Lion | 0.96 parts by mass |
| Corporation., solid content 1 mass % | |
| ion-exchanged water dilution) | |
| Surfactant B: NAROACTY CL-95 (produced by | 1.19 parts by mass |
| SANYO CHEMICAL INDUSTRIES, Ltd., solid | |
| content 1 mass % ion-exchanged water dilution) | |
| Methanol | 30.00 parts by mass |
| Distilled water | 50.73 parts by mass |

After the prepared liquid of the coating liquid M1 for the metal particle-containing layer described above, the coating liquids M2 and M3 for the metal particle-containing layer were prepared by replacing the silver flat particle dispersing liquid B1 with B2 and B3 respectively.

—Preparation of Colloidal State Silica Fine Particle Dispersion A—

0.10 kg of AEROSIL OX-50 (produced by Evonik Industries) which is colloidal state silica fine particles with an average primary particle diameter of 40 nm was measured in a container made of SUS 304, 0.9 kg of ion-exchanged water was added, and coarse dispersion was performed at 3000 rpm for 60 minutes using a desktop-type quick homomixer LR-1 (manufactured by Mizuho Industrial Co., Ltd.). Subsequently, by transferral to an ultrasonic dispersing tank which is provided with an ultrasonic oscillator (model S-8540-12, 40 kHz) manufactured by Branson Corp. (Vendor: Branson operations department of Emerson Japan, Ltd.) and performing dispersion at a set output 80% for 4 hours, a colloidal state silica fine particle dispersion A with 10 mass % of solid content was prepared.

The average particle diameter was 165 nm when performing the measurement by setting the relative refractive index to 140a0001 using a laser diffraction/scattered particle diameter distribution measuring apparatus LA-920 (manufactured by Horiba Ltd.).

(Preparation of Coating Liquid O for Overcoat Layer)

| | |
|---|---|
| Colloidal state silica fine particles: | 0.0033 parts by mass |
| SNOWTEX XL (average particle diameter | |
| 50 nm) (produced by Nissan Chemical | |
| Industries, Ltd., solid content 10 | |
| mass % distilled water dilution) | |
| Colloidal state silica fine particle | 0.079 parts by mass |
| dispersion A | |
| Acryl polymer water dispersion: AS-563A | 0.13 parts by mass |
| (produced by Daicel Fine Chem Ltd., solid | |
| content 27.5 mass %) | |
| Wax: CELAZOLE 524 (produced by Chukyo | 0.78 parts by mass |
| Yushi Co., Ltd., solid content 3 mass % | |
| distilled water dilution) | |
| Cross-linking agent: CARBODILITE V-02-L2 | 0.46 parts by mass |
| (produced by Nisshinbo Chemical Inc., | |
| solid content density 20 mass % distilled | |
| water dilution) | |
| Surfactant A: REPEARL 870P (produced by | 0.63 parts by mass |
| Lion Corporation., solid content 1 | |
| mass % distilled water dilution) | |
| Surfactant B: NAROACTY CL-95 (produced | 0.87 parts by mass |
| by SANYO CHEMICAL INDUSTRIES, | |
| Ltd., solid content 1 mass % | |
| distilled water dilution) | |
| Urethane polymer water solution: | 1.12 parts by mass |
| OLESTER-UD350 (produced by Mitsui | |
| Chemical Corp., solid content 38 mass %) | |
| Distilled water | 95.93 parts by mass |

(Coating liquid B1 for Rear Surface First Layer)
-Infrared Ray Absorbing agent-Containing Hard Coat Layer-

| | |
|---|---|
| ITO particle coating: PI-3 (produced by | 100 parts by mass |
| Mitsubishi Materials Electronic Chemicals | |
| Co., Ltd., solid content 40 mass %, ITO | |
| content 28%) | |

ITO coating PI-3 (produced by Mitsubishi Materials Electronic Chemicals Co., Ltd.) is a heat ray cut coating having ITO (tin dope indium oxide), a dispersing agent, polyacrylate, an initiator, toluene, 4-hydroxy-4-methyl-2-pentanone, 2-methyl-1-propanol, and ethanol as the main components thereof. The ITO content is 28 mass %.

(Coating liquid B2 for Rear Surface First Layer)
-Hard Coat Layer-

| | |
|---|---|
| UV curable resin: OPSTAR KZ6661 | 100 parts by mass |
| (produced by JSR Corporation, | |
| solid content 50 mass %) | |

(Preparation of Coating Liquid L1 for Uppermost Layer)
-Low Refractive Index Layer-

| | |
|---|---|
| Curable monomers: Solution which contains | 646 parts by mass |
| a compound M-11 by 4% (solvent: | |
| methylethyl ketone) | |
| Curable monomers: KAYAEAD PET-30 | 7 parts by mass |
| (produced by NIPPON KAYAKU Co., Ltd.) | |
| Hollow silica dispersing liquid: | 306 parts by mass |
| THRULYA 4320 (produced by JGC C&C) | |
| Photopolymerization initiator: | 1 part by mass |
| IRGACURE 127 (produced by BASF Japan | |
| Corp.) | |
| Solvent: methylethyl ketone (produced | 1,400 parts by mass |
| by Wako Pure Chemical Industries, Ltd.) | |
| Solvent: cyclohexanone (produced by | 130 parts by mass |
| Wako Pure Chemical Industries, Ltd.) | |

(Preparation of Coating Liquid L2 for Uppermost Layer)
-Low Refractive Index Layer-

| | |
|---|---|
| Curable resin: UNIDIC EKS-675 | 174 parts by mass |
| (produced by DIC Corporation) | |
| Hollow silica dispersing liquid: | 74 parts by mass |
| THRULYA 4320 (produced by JGC C&C) | |
| Photopolymerization initiator: IRGACURE | 1 part by mass |
| 127 (produced by BASF Japan Corp.) | |
| Solvent: methylisobutylethyl ketone | 2300 parts by mass |
| (produced by Wako Pure Chemical | |
| Industries, Ltd.) | |
| Solvent: cyclohexanone (produced by | 150 parts by mass |
| Wako Pure Chemical Industries, Ltd.) | |

(Preparation of Coating Liquid L3 for Uppermost Layer)
-Low Refractive Index Layer-

| | |
|---|---|
| Curable resin: UNIDIC EKS-675 (produced by DIC | 274 parts by mass |
| Corporation) | |
| Curable resin: FH-700 (produced by DIC | 50 parts by mass |
| Corporation) | |
| Photopolymerization initiator: IRGACURE 127 | 1 part by mass |
| (produced by BASF Japan Corp.) | |
| Solvent: methylethyl ketone (produced by Wako | 4200 parts by mass |
| Pure Chemical Industries, Ltd.) | |
| Solvent: cyclohexanone (produced by Wako Pure | 270 parts by mass |
| Chemical Industries, Ltd.) | |

(Preparation of Coating Liquid L4 for Uppermost Layer)
-Low Refractive Index Layer-,

| | |
|---|---|
| Curable resin: UNIDIC EKS-675 (produced by DIC | 150 parts by mass |
| Corporation) | |
| Curable resin: FH-700 (produced by DIC | 75 parts by mass |
| Corporation) | |
| Photopolymerization initiator: IRGACURE 127 | 1 part by mass |
| (produced by BASF Japan Corp.) | |
| Solvent: methylethyl ketone (produced by Wako | 3400 parts by mass |
| Pure Chemical Industries, Ltd.) | |
| Solvent: cyclohexanone (produced by Wako Pure | 200 parts by mass |
| Chemical Industries, Ltd.) | |

(Preparation of Coating Liquid I1 for Metal
Particle Reflection Adjusting Refractive Index Layer)
-First metal particle reflection adjusting refractive index layer
(visible light reflection rate reducing high refractive index layer)-

| | |
|---|---|
| Aqueous urethane resin: HYDRAN HW350 | 11.77 parts by mass |
| (produced by DIC Corporation, | |
| solid content 30 mass %) | |
| Surfactant B: NAROACTY CL-95 | 1.11 parts by mass |
| (produced by SANYO CHEMICAL | |
| INDUSTRIES, Ltd., solid content | |
| 1 mass % ion-exchanged water | |
| dilution) | |
| Cross-linking agent: CARBODILITE V-02-L2 | 7.56 parts by mass |
| (produced by Nisshinbo Chemical Inc., | |
| solid content density 20 mass % | |
| ion-exchanged water dilution) | |
| Distilled water | 73.27 parts by mass |

(Preparation of coating liquid I2 for metal
particle reflection adjusting refractive index layer)
-Second Metal Particle Reflection Adjusting Refractive Index Layer
(Visible Light Reflection Rate Reducing High Refractive Index Layer)-

| | |
|---|---|
| Aqueous urethane resin: Hydran HW350 | 1.71 parts by mass |
| (produced by DIC Corporation, solid | |
| content 30 mass %) | |
| Hollow silica particles: Thrulya 4110 | 3.16 parts by mass |
| (average particle diameter 60 nm, produced by | |
| JGC C&C, solid content 20 mass %) | |
| Surfactant B: Naroacty CL-95 (produced | 1.19 parts by mass |
| by SANYO CHEMICAL INDUSTRIES, | |
| Ltd., solid content 1 mass % | |
| ion-exchanged water dilution) | |
| Methanol | 26.84 parts by mass |
| Distilled water | 67.10 parts by mass |

### Comparative Example 3

### Production of Heat-Shielding Material 101

PET film (Cosmoshine A4300 manufactured by TOYOBO Co., Ltd., width: 1320 mm, thickness: 75 μm, processed with a double-side easy adhesive layer, refractive index 1.66), which is a substrate in a roll form, was transported at speed of 15 m/min, the coating liquid M1 of the metal particle-containing layer was coated on one side of the substrate using a wire bar so as to be 10.6 mL/m², a drying process is carried out at 140° C., and a metal particle-containing layer which includes silver flat particles was provided. The film thickness after the coating and drying was 10 nm.

After coating and drying the metal particle-containing layer, a coating liquid O for an overcoat layer was coated on the metal particle-containing layer using a wire bar so as to be 5.30 mL/m², a drying process was carried out at 135° C., and an overcoat layer (a protective layer) was provided.

The film thickness after the coating and drying was 33 nm and the refractive index was 1.51. After coating the overcoat layer, the coated substrate was wound under the temperature and humidity conditions of 23±2° C. and relative humidity 55±5% and a coated film B in a roll form was obtained. The wound length was 2200 m.

The coated film B in a roll form described above was wound and transported, a coating liquid B1 of the rear surface first layer was coated on the opposite surface (rear surface) of the surface on which the overcoat layer was coated using a slot die coating method such that the film thickness after coating, drying, and UV curing was 1.5 μm, and a drying process was carried out at 90° C. Subsequently, a resin was cured by irradiating the dried coated layer with ultraviolet rays of 300 mJ/cm² using a 160 W/cm metal halide lamp (manufactured by Eye Graphics Co., Ltd.) under the atmosphere and an infrared ray absorbing agent-containing hard coat layer (a rear first layer) was provided.

A heat-shielding material 101 which was obtained in this manner was the heat-shielding material in Comparative Example 3.

### Comparative Example 1 and 2

### Production of Heat-Shielding Materials 102 and 103

After the production of the heat-shielding material 101, the heat-shielding materials 102 and 103 were obtained by replacing the coating liquid M1 with the coating liquid M2 and M3 respectively.

The heat-shielding materials 102 and 103 which were obtained in this manner were the heat-shielding materials in Comparative Examples 2 and 1 respectively.

### Example 3

### Production of Heat-Shielding Material 201

The heat-shielding material 201 was produced following the production of the heat-shielding material 101 and, subsequently, after coating and drying the infrared ray absorbing agent-containing hard coat layer (the rear surface first layer), the coating liquid L1 for the uppermost layer was coated on the infrared ray absorbing agent-containing hard coat layer (the rear surface first layer) using a slot die coating method such that the film thickness after coating, drying, and UV curing was 102 nm and a drying process was carried out at 120° C. Subsequently, a resin was cured by irradiating the dried coated layer with ultraviolet rays of 200 mJ/cm² using a 160 W/cm high pressure mercury lamp (manufactured by Eye Graphics Co., Ltd.) while carrying out nitrogen purging at an oxygen concentration of less than 1% and a low refractive index layer (an antireflection layer) with a thickness of 102 nm was provided on the infrared ray absorbing agent-containing hard coat layer (the rear surface first layer). In this manner, a low refractive index layer with a refractive index of 1.35 was obtained.

In this manner, samples of the heat-shielding material 201 were produced. Here, for the average thickness described above, a method of measuring by setting the difference between before coating and after coating as the thickness using a laser microscope VK-8510 (manufactured by Keyence Corp.), a method of calculating by observing a cross-section of the heat-shielding material using SEM or TEM, a method of calculating by performing cross-section cut processing and observation using an FIB-TEM method, and a method of calculating by measuring and fitting the reflection spectrum were appropriately used. In addition, a method of coating and observing only one target layer on the film which is the substrate was also appropriately used. The 10 point measurement average value was the film thickness of the target layer.

The heat-shielding material 201 which was obtained in this manner was the heat-shielding material in Example 3.

### Examples 1 and 2

### Production of Heat-Shielding Materials 202 and 203

Following the production of the heat-shielding material 201, the heat-shielding materials 202 and 203 were produced by replacing the coating liquid M1 with the coating liquids M2 and M3 respectively.

The heat-shielding materials 202 and 203 which were obtained in this manner were the heat-shielding materials in Examples 2 and 1 respectively.

### Examples 4 and 5 and Comparative Example 4

### Production of Heat-shielding Materials 204, 205, and 104

Following the production of the heat-shielding material 201, the heat-shielding materials 204, 205, and 104 were each produced by replacing the uppermost layer coating liquid L1 with the uppermost layer coating liquids L2, L3, and L4 respectively.

The heat-shielding materials 204, 205, and 104 which were obtained in this manner were the heat-shielding materials in Examples 4 and 5 and Comparative Example 4 respectively.

### Comparative Example 5

### Production of Heat-Shielding Material 105

PET film (Cosmoshine A4300 manufactured by TOYOBO Co., Ltd., width: 1320 mm, thickness: 75 μm, processed with a double-side easy adhesive layer, refractive index 1.66), which is a substrate in a roll form, was transported at speed of 15 m/min, the coating liquid 12 for the metal particle reflection adjusting refractive index layer was coated on one side of the substrate using a wire bar so as to be 5.3 mL/m², a drying process was carried out at 130° C., and a second metal particle reflection adjusting refractive index layer (a visible light reflection rate reducing low refractive index layer) was provided. After coating and drying, the film thickness was 102 nm and the refractive index was 1.40.

After coating and drying the second metal particle reflection adjusting refractive index layer (the visible light reflection rate reducing low refractive index layer), the coating liquid I1 for the metal particle reflection adjusting refractive index layer was coated on the second metal particle reflection adjusting refractive index layer (the visible light reflection rate reducing low refractive index layer) using a wire bar so as to be 5.30 mL/m², a drying process was carried out at 140° C., and a first metal particle reflection adjusting refractive index layer (a visible light reflection rate reducing high refractive index layer) was provided. After coating and drying, the film thickness was 200 nm and the refractive index was 1.60. After coating the first metal particle reflection adjusting refractive index layer (the visible light reflection rate reducing high refractive index layer), the coated substrate was wound under temperature and humidity conditions of 23±2° C. and relative humidity 70±5% and a coated film A′ in a roll form was obtained.

Subsequently, the coated film A′ in a roll form was wound and transported at speed of 15/min, the coating liquid M1 for the metal particle-containing layer was coated on the first metal particle reflection adjusting refractive index layer using a wire bar so as to be 10.6 mL/m², a drying process was carried out at 140° C., and a metal particle-containing layer which includes silver flat particles was provided. After coating and drying, the film thickness was 10 nm.

After coating and drying the metal particle-containing layer, a coating liquid O for an overcoat layer was coated on the metal particle-containing layer using a wire bar so as to be 5.30 mL/m², a drying process was carried out at 135° C., and an overcoat layer (a protective layer) was provided.

After coating and drying, the film thickness was 33 nm and the refractive index was 1.51. After coating the overcoat layer, the coated substrate was wound under temperature and humidity conditions of 23±2° C. and relative humidity 55±5% and a coated film B′ in a roll form was obtained. The wound length was 2200 m.

The coated film B′ in a roll form described above was wound and transported, a coating liquid B1 for the rear surface first layer was coated on the opposite surface (rear surface) of the surface on which the overcoat layer was coated using a slot die coating method such that the film thickness after coating, drying, and UV curing was 1.5 μm, and a drying process was carried out at 80° C. Subsequently, a resin was cured by irradiating the dried coated layer with ultraviolet rays of 500 mJ/cm² using a 160 W/cm metal halide lamp (manufactured by Eye Graphics Co., Ltd.) under an atmosphere and an infrared ray absorbing agent-containing hard coat layer (a rear surface first layer) was provided.

In this manner, a heat-shielding material 105 was produced.

The heat-shielding material 105 which was obtained in this manner was the heat-shielding material 105 in Comparative Example 5.

### Example 6

### Production of Heat-Shielding Material 206

The heat-shielding material 206 was produced following the production of the heat-shielding material 105 and subsequently, after coating and drying the infrared ray absorbing agent-containing hard coat layer (the rear surface first layer), the coating liquid L1 for the uppermost layer was coated on the infrared ray absorbing agent-containing hard coat layer (the rear surface first layer) using a slot die coating method such that the film thickness after coating, drying, and UV curing was 102 nm and a drying process was carried out at 120° C. Subsequently, a resin was cured by irradiating the dried coated layer with ultraviolet rays of 200 mJ/cm² using a 160 W/cm high pressure mercury lamp (manufactured by Eye Graphics Co., Ltd.) while carrying out nitrogen purging at an oxygen concentration of less than 1% and a low refractive index layer (an antireflection layer) with a thickness of 102 nm was provided on the infrared ray absorbing agent-containing hard coat layer (the rear surface first layer). In this manner, a low refractive index layer with a refractive index of 1.35 was obtained.

In this manner, a heat-shielding material 206 was produced.

The heat-shielding material 206 which was obtained in this manner was the heat-shielding material in example 6.

### Examples 8 to 11

### Production of Heat-Shielding Materials 208 to 211

Following the production of the heat-shielding material 201, when coating the coating liquid L1 for the uppermost layer, the coating amount of the coating liquid L1 for the uppermost layer in each sample was adjusted and the heat-shielding materials 208 to 211 of which the thickness of the low refractive index layer of each sample after curing was respectively 60 nm, 72 nm, 130 nm, and 140 nm were produced.

The heat-shielding materials 208 to 211 which were obtained in this manner were the heat-shielding materials in Examples 8 to 11.

### Comparative Example 6

### Production of Heat-Shielding Material 106

Following the production of the heat-shielding material 101, the process continued until the coated film B in a roll form was produced and then the process was changed as below.

The coated film B described above was wound and transported, a coating liquid B2 for the rear surface first layer was coated on the opposite surface (rear surface) of the surface on which the overcoat layer was coated using a slot die coating method such that the film thickness after coating, drying, and UV curing was 3.0 μm, and a drying process was carried out at 80° C. Subsequently, a resin was cured by irradiating the dried coated layer with ultraviolet rays of 500 mJ/cm² using a 160 W/cm metal halide lamp (manufactured by Eye Graphics Co., Ltd.) under the atmosphere and a hard coat layer (a rear surface first layer) was provided.

In this manner, a heat-shielding material 106 was produced.

The heat-shielding material 106 which was obtained in this manner was the heat-shielding material in Comparative Example 6.

### Example 7

### Production of Heat-Shielding Material 207

The heat-shielding material 207 was produced following the production of the heat-shielding material 106 and subsequently, after coating and drying the hard coat layer, the coating liquid L1 for the uppermost layer was coated on the hard coat layer using a slot die coating method such that the film thickness after coating, drying, and UV curing was 102 nm and a drying process was carried out at 120° C. Subsequently, a resin was cured by irradiating the dried coated layer with ultraviolet rays of 200 mJ/cm² using a 160 W/cm high pressure mercury lamp (manufactured by Eye Graphics Co., Ltd.) while carrying out nitrogen purging at an oxygen concentration of less than 1% and a low refractive index layer (an antireflection layer) with a thickness of 102 nm was provided on the hard coat layer (the rear surface first layer). In this manner, a low refractive index layer with a refractive index of 1.35 was obtained.

In this manner, samples of the heat-shielding material 207 were produced.

The heat-shielding material 207 which was obtained in this manner was the heat-shielding material in Example 7.

<Confirmation of Configuration of Heat-Shielding Material>

### —Planar Orientation of Flat Metal Particles—

Cross-sectional segment samples of the heat-shielding materials 101 to 106 and 201 to 211 produced as described above were each produced and the planar orientations of the flat metal particles were confirmed by TEM observation. As a result, the flat metal particles which were planarly oriented in the range of 0° to ±30° in the metal particle-containing layer were 97% by number of all the flat metal particles. The planar orientation of the flat metal particles in the range of 0° to ±30° in the metal particle-containing layer in each sample was within 0° to ±50.

<Evaluation of Heat-Shielding Material>

### —Visible Light Transmittance in Shielding Coefficient 0.690—

As optical characteristics, the visible light transmittance (VLT) and shielding coefficient (SC) which are obtained by the visible light transmittance test and the shielding coefficient test described in JIS A 5759 were evaluated. The measurement method of the spectral transmittance or the spectral reflection rate which are necessary for the evaluation were performed using the method described in JIS R 3106.

In each heat-shielding material sample, when changing the coating amount when forming a metal particle-containing layer, the VLT value and the SC value of the heat-shielding material change with a certain relationship. When increasing the coating amount of the metal particle-containing layer, the VLT value decreases and the SC value is small (which indicates that the heat-shielding performance increases as the transmitted light amount decreases and it becomes dark). That is, when comparing test samples, it is necessary to equalize the SC value to compare the VLT value (or equalize the VLT value to compare the SC value). For this reason, a VLT value for a desired SC value is obtained by a function (an approximation curve) which is obtained by producing a plurality of heat-shielding material sample groups by appropriately changing the coating amount of the metal particle-containing layer and obtaining the VLT value and the SC value of each sample, taking VLT and SC on the horizontal axis and the vertical axis respectively and plotting the data of the heat-shielding material sample groups. Due to this, it is possible to perform a fair evaluation. The manufacturing example described above showed the coating amount when forming a metal particle-containing layer with an example; however, in order to obtain the visible light transmittance in the shielding coefficient 0.690, samples of which the coating amounts were different when forming the metal particle-containing layer were produced and the visible light transmittance in the shielding coefficient 0.690 was obtained from the plots of the VLT value and the SC value described above.

Description will be given below of the method for producing the test samples.

Each of the overcoat layer surfaces of each heat-shielding material sample for the heat-shielding material sample group was cleaned and an adhesive material (an adhesive layer) was adhered thereto. PANACLEAN PD-S1 (adhesive layer 25 μm) manufactured by Panac Corp. was used as the adhesive material and a light-release separator (silicone coat PET) was peeled off and adhered to the overcoat layer surface. The other heavy-release separator (silicone coat PET) of the PD-S1 was peeled off and the optical characteristics were evaluated through being adhered to soda lime silicate glass (plate glass thickness: 3 mm), using a 0.5 mass % diluted liquid of REAL PERFECT (manufactured by LINTEC CORPORATION.) which is a film application liquid. Here, the plate glass described above, which was naturally dried after wiping away dirt with isopropyl alcohol, was used and, during the adhesion, pressed with a surface pressure of 0.5 kg/cm² using a rubber roller in an environment of 25° C. and relative humidity 65%.

The heat-shielding material sample groups (after the glass adhesion) were test samples.

It is possible to change the visible light transmittance and the shielding coefficient of the heat-shielding material according to the coating amount when forming the metal particle-containing layer. In each Example and each Comparative Example, a large number of heat-shielding materials were produced by changing the coating amount of the coating liquid for the metal particle-containing layer which includes the flat metal particle-containing liquid in each Example and Comparative Example and the visible light transmittance and the shielding coefficient were calculated with the method below.

The transmittance spectrum and reflection spectrum of the heat-shielding materials which were produced in each Example and Comparative Example were measured using an ultraviolet visible near infrared spectral apparatus (manufactured by JASCO Corporation, V-670, using an integrating sphere unit ISN-723) and the visible light transmittance and the shielding coefficient were calculated according to JISR 3106 and JISA 5759.

(1) Visible Light Transmittance

In each heat-shielding material, the transmittance of each wavelength which was measured up to 380 nm to 780 nm was calculated by correction according to the spectral visual sensitivity of each wavelength.

(2) Method for Measuring Shielding Coefficient

For each heat-shielding material, from the transmittance of each wavelength which was measured up to 300 nm to 2,500 nm, the calculation was carried out based on the method described in JISA 5759.

(3) Visible Light Transmittance in Shielding Coefficient 0.690

A graph in which the relationship between the visible light transmittance and the shielding coefficient was plotted was produced based on the obtained visible light transmittance and the shielding coefficient by setting the x axis as the visible light transmittance (unit %) and the y axis as the shielding coefficient (no unit).

The plots were approximated to a primary curve (a straight line) and the value (unit %) of the visible light transmittance at a certain shielding coefficient was obtained by interpolation with the obtained primary curve. In the present specification, the visible light transmittance in the shielding coefficient 0.690 was used to evaluate the optical characteristics.

The obtained results are described in Table 2 below. Here, the “visible light transmittance” in Table 2 below represents the visible light transmittance in the shielding coefficient 0.690.

The higher the visible light transmittance, the clearer the brightness of the scenery seen through the heat-shielding material, which is preferable.

—Lightfastness of Infrared Ray Maximum Reflection Rate—

### (1) Default

Regarding the heat ray maximum reflection rate of each heat-shielding material, in the measurement results of the reflection spectrum which was obtained by the measurement of the visible light transmittance in the shielding coefficient 0.690 described above, the maximum reflection rate in the range of 800 nm to 2,500 nm was the default (before Xe irradiation) infrared ray maximum reflection rate.

(2) After Xe irradiation

Using Super Xenon Weather Meter SX-75 manufactured by Suga Test Instruments Co., Ltd., irradiation was performed for 4 weeks under the conditions of 180 W/m², a black panel temperature of 63° C., and a relative humidity of 55%. Each sample was installed such that the Xe light was incident from the side of the glass on which each heat-shielding material was adhered. The spectral spectrum (the reflection rate) of each sample was measured after the Xe irradiation and the maximum reflection rate in the range of 800 nm to 2,500 nm was the infrared ray maximum reflection rate after the Xe irradiation.

(3) Change after Xe irradiation

A value where the infrared ray maximum reflection rate after the Xe irradiation was subtracted from the obtained default infrared ray maximum reflection rate was determined as the change (lightfastness) after the Xe irradiation. The smaller the change after the Xe irradiation, the better the heat-shielding performance of the heat-shielding material is maintained, which is preferable.

The obtained results are described in Table 2 below.

—Lightfastness of Transmitted Haze—

(1) Default

A transmitted light haze value (%) of each heat-shielding material was measured using a haze meter (NDH-5000, manufactured by Nippon Denshoku Industries Co., Ltd.). The smaller the value of the transmitted haze, the higher the contrast of the scenery which is seen through the heat-shielding material, which is preferable.

(2) After Xe Irradiation

Using Super Xenon Weather Meter SX-75 manufactured by Suga Test Instruments Co., Ltd., irradiation was performed for 4 weeks under the conditions of 180 W/m², a black panel temperature of 63° C., and a relative humidity of 55%. Each sample was installed such that the Xe light was incident from the side of the glass on which each heat-shielding material was adhered. The transmitted light haze value (%) was measured after the Xe irradiation of each sample and was set as the transmitted light haze (%) after the Xe irradiation.

(3) Change After Xe Irradiation

A value where the transmitted light haze value (%) after the Xe irradiation was subtracted from the obtained default transmitted light haze value (%) was determined as the change (lightfastness) after the Xe irradiation.

The obtained results are described in Table 2 below.

TABLE 2

| | Configuration of heat-shielding material | | | | | | | |
|---|---|---|---|---|---|---|---|---|
| | | | Metal particle-containing | | | | | |
| | | | layer | | | | | |
| | | | | Planarly | Hard coat | | | |
| | | | Planar | oriented | layer | | | |
| | | | orientation | flat metal | Infrared | | | |
| | | Heat- | of flat | particles | ray | Low refractive index layer | | |
| | Coating | shielding | metal | [% by | absorbing | Refractive | Thickness | n × d |
| | liquid | material | particles | number] | compound | index n | d [nm] | [nm] |
| Comparative | M1 | 103 | 0° to ±5° | 97 | ITO | — | — | — |
| Example 1 | | | | | | | | |
| Comparative | M2 | 102 | 0° to ±5° | 97 | ITO | — | — | — |
| Example 2 | | | | | | | | |
| Comparative | M3 | 101 | 0° to ±5° | 97 | ITO | — | — | — |
| Example 3 | | | | | | | | |
| Example 1 | M1 | 203 | 0° to ±5° | 97 | ITO | 1.35 | 102 | 137.7 |
| Example 2 | M2 | 202 | 0° to ±5° | 97 | ITO | 1.35 | 102 | 137.7 |
| Example 3 | M3 | 201 | 0° to ±5° | 97 | ITO | 1.35 | 102 | 137.7 |
| Example 4 | M3 | 204 | 0° to ±5° | 97 | ITO | 1.40 | 98 | 137.2 |
| Example 5 | M3 | 205 | 0° to ±5° | 97 | ITO | 1.45 | 95 | 137.8 |
| Comparative | M3 | 104 | 0° to ±5° | 97 | ITO | 1.50 | 92 | 138.0 |
| Example 4 | | | | | | | | |
| Comparative | M3 | 105 | 0° to ±5° | 97 | ITO | — | — | — |
| Example 5 | | | | | | | | |
| Example 6 | M3 | 206 | 0° to ±5° | 97 | ITO | 1.35 | 102 | 137.7 |
| Comparative | M3 | 106 | 0° to ±5° | 97 | None | — | — | — |
| Example 6 | | | | | | | | |
| Example 7 | M3 | 207 | 0° to ±5° | 97 | None | 1.35 | 102 | 137.7 |
| Example 8 | M3 | 208 | 0° to ±5° | 97 | ITO | 1.35 | 60 | 81.0 |
| Example 9 | M3 | 209 | 0° to ±5° | 97 | ITO | 1.35 | 72 | 97.2 |
| Example 10 | M3 | 210 | 0° to ±5° | 97 | ITO | 1.35 | 130 | 175.5 |
| Example 11 | M3 | 211 | 0° to ±5° | 97 | ITO | 1.35 | 140 | 189.0 |

| | Evaluation of heat-shielding material | | | | | | |
|---|---|---|---|---|---|---|---|
| | | Lightfastness of infrared ray | | | | | |
| | | maximum reflection rate | | | | | |
| | | | After Xe | | | | |
| | | Default | irradiation | | | | |
| | | Infrared | Infrared | Change | Lightfastness of transmitted haze | | |
| | | ray | ray | (lightfastness) | | After Xe | Change |
| | Visible light | maximum | maximum | after Xe | Default | irradiation | (lightfastness) |
| | transmittance | reflection | reflection | irradiation | Transmitted | Transmitted | after Xe |
| | [%] | rate [%] | rate [%] | [%] | haze [%] | haze [%] | irradiation [%] |
| Comparative | 73.2 | 26.0 | 24.0 | 2.0 | 2.6 | 2.7 | −0.1 |
| Example 1 | | | | | | | |
| Comparative | 74.0 | 27.0 | 23.0 | 4.0 | 1.8 | 2.1 | −0.3 |
| Example 2 | | | | | | | |
| Comparative | 75.3 | 28.0 | 23.0 | 5.0 | 1.0 | 1.5 | −0.5 |
| Example 3 | | | | | | | |
| Example 1 | 75.7 | 26.0 | 24.5 | 1.5 | 2.6 | 2.6 | 0.0 |
| Example 2 | 76.5 | 27.0 | 25.2 | 1.8 | 1.8 | 1.9 | −0.1 |
| Example 3 | 77.8 | 28.0 | 25.0 | 3.0 | 1.0 | 1.2 | −0.2 |
| Example 4 | 77.1 | 28.0 | 24.0 | 4.0 | 1.0 | 1.3 | −0.3 |
| Example 5 | 76.2 | 28.0 | 23.5 | 4.5 | 1.0 | 1.4 | −0.4 |
| Comparative | 75.6 | 28.0 | 23.1 | 4.9 | 1.0 | 1.5 | −0.5 |
| Example 4 | | | | | | | |
| Comparative | 79.2 | 30.5 | 25.5 | 5.0 | 1.0 | 1.5 | −0.5 |
| Example 5 | | | | | | | |
| Example 6 | 81.8 | 30.5 | 28.7 | 1.8 | 1.0 | 1.2 | −0.2 |
| Comparative | 75.5 | 28.0 | 23.0 | 5.0 | 1.0 | 1.5 | −0.5 |
| Example 6 | | | | | | | |
| Example 7 | 78.0 | 28.0 | 26.2 | 1.8 | 1.0 | 1.2 | −0.2 |
| Example 8 | 80.1 | 28.0 | 25.1 | 2.9 | 1.0 | 1.2 | −0.2 |
| Example 9 | 80.7 | 28.0 | 25.8 | 2.2 | 1.0 | 1.2 | −0.2 |
| Example 10 | 80.7 | 28.0 | 25.8 | 2.2 | 1.0 | 1.2 | −0.2 |
| Example 11 | 80.4 | 28.0 | 25.1 | 2.9 | 1.0 | 1.2 | −0.2 |

From Table 2 above, it is understood that the heat-shielding performance, the visible light transmittance, and the lightfastness in the heat-shielding material of the present invention are excellent.

On the other hand, it is understood that the heat-shielding materials in Comparative Examples 1 to 3 in which a low refractive index layer was not provided were poor in the heat-shielding performance and the visible light transmittance in the case of Comparative Examples 1 and 2 in which the lightfastness was excellent and were poor in the lightfastness in the case of Comparative Example 3 in which the heat-shielding performance and the visible light transmittance were excellent.

It is understood that the heat-shielding material in Comparative Example 4 in which the refractive index of the low refractive index layer exceeded the upper limit value of the present invention was poor in the lightfastness.

It is understood that the heat-shielding material in Comparative Example 5 in which the first and second metal particle reflection adjusting refractive index layers were provided without providing a low refractive index layer was poor in the lightfastness.

The heat-shielding material in Comparative Example 6 in which a layer where an infrared ray absorbing agent was not added was used as a hard coat layer without providing a low refractive index layer was poor in the lightfastness.

### EXPLANATION OF REFERENCES

1: METAL PARTICLE-CONTAINING LAYER
2: METAL PARTICLE REFLECTION ADJUSTING REFRACTIVE INDEX LAYER
2A: FIRST METAL PARTICLE REFLECTION ADJUSTING REFRACTIVE INDEX LAYER
2B: SECOND METAL PARTICLE REFLECTION ADJUSTING REFRACTIVE INDEX LAYER
5: OVERCOAT LAYER
6: ADHESIVE LAYER
7: HARD COAT LAYER
7A: INFRARED RAY ABSORBENT-CONTAINING HARD COAT LAYER
8: WINDOW GLASS (GLASS FOR WINDOW GLASS)
8A: SURFACE ON THE OUTDOOR SIDE OF THE WINDOW GLASS
11: FLAT METAL PARTICLE
20: LOW REFRACTIVE INDEX LAYER
40: SUBSTRATE (SUPPORTING BODY)
100: HEAT-SHIELDING MATERIAL
100A: SURFACE ON THE INDOOR SIDE OF THE HEAT-SHIELDING MATERIAL
a: (AVERAGE) THICKNESS OF METAL PARTICLES
D: (AVERAGE) PARTICLE DIAMETER OR (AVERAGE) CIRCLE EQUIVALENT DIAMETER OF METAL PARTICLES
f: RANGE IN WHICH FLAT METAL PARTICLES ARE PRESENT IN DEPTH DIRECTION

What is claimed is:

1. A heat-shielding material comprising:
a substrate;
a metal particle-containing layer which contains flat metal particles with a hexagonal shape to a circular shape; and
a low refractive index layer with a refractive index of 1.45 or less,
wherein flat metal particles in which a principle planar surface of the flat metal particles is set with a planar orientation in a range of 0° to ±30° on average with respect to the other surface of the metal particle-containing layer are 50% by number or more of all the flat metal particles, and
the low refractive index layer is arranged on an uppermost surface on an indoor side when installing the heat-shielding material on a window glass.

2. The heat-shielding material according to claim 1,
wherein an average particle thickness of the flat metal particles is 11 nm or less.

3. The heat-shielding material according to claim 1,
wherein a refractive index n and a thickness d of the low refractive index layer satisfy a relationship of Formula (1) below,
(550 nm÷4)×0.7<n×d<(550 nm÷4)×1.3. Formula (1)

4. The heat-shielding material according to claim 1,
wherein an aspect ratio of the flat metal particles is 2 to 80.

5. The heat-shielding material according to claim 1, further comprising:
low refractive index particles in the low refractive index layer,
wherein the low refractive index particles are hollow particles or porous particles.

6. The heat-shielding material according to claim 5,
wherein the low refractive index particles are silica.

7. The heat-shielding material according to claim 1,
wherein the low refractive index layer is formed by curing a curable resin composition which includes a fluorine-containing polyfunctional monomer,
the fluorine-containing polyfunctional monomer has three or more polymeric groups selected from a (meth)acryloyl group, an allyl group, an alkoxysilyl group, an α-fluoroacryloyl group, an epoxy group, and —C(O)OCH═CH₂,
a fluorine content ratio is 35.0 mass % or more of molecular weight of the fluorine-containing polyfunctional monomer,
a calculated value of all of the molecular weight between crosslinks is 300 or less when polymerizing the polymeric groups, and
the heat-shielding material is represented by Formula (1) below;
Rf{-(L)ₘ-Y}ₙ Formula (1):
in the formula, Rf represents a n-valent group selected from f-1 to f-10 below; n represents an integer of 3 or greater; L represents any of an alkylene group with 1 to 10 carbon atoms, an arylene group with 6 to 10 carbon atoms, —O—, —S—, —N(R)—, a group which is obtained by combining an alkylene group with 1 to 10 carbon atoms with —O—, —S—, or —N(R)—, or a group which is obtained by combining an arylene group with 6 to 10 carbon atoms and —O—, —S—, or —N(R)—; here, R represents a hydrogen atom or an alkyl group with 1 to 5 carbon atoms, m represents 0 or 1, Y represents a polymeric group selected from a (meth)acryloyl group, an allyl group, an alkoxysilyl group, an α-fluoroacryloyl group, an epoxy group, and —C(O)OCH═CH₂; 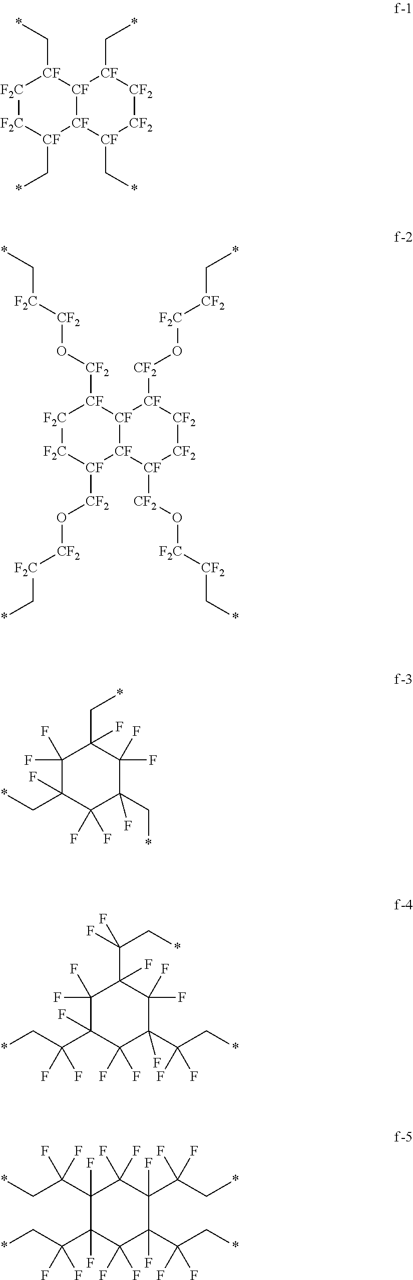 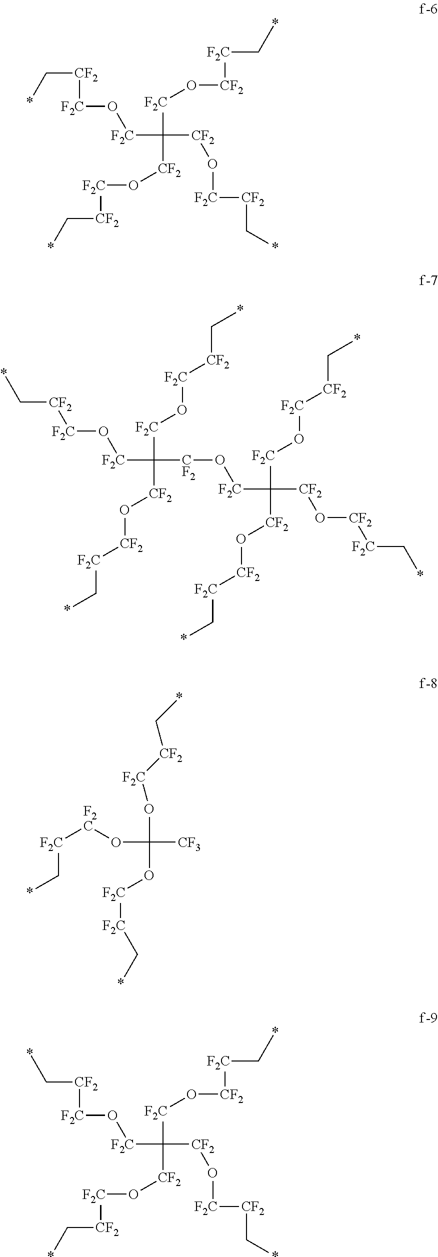 [SMILES: *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C* ; *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C* ; *CC(F)(F)C(F)(F)OC(OC(F)(F)C(F)(F)C*)(OC(F)(F)C(F)(F)C*)C(F)(F)F ; *CC(F)(F)C(F)(F)OC(F)(F)C(C(F)(F)OC(F)(F)C(F)(F)C*)(C(F)(F)OC(F)(F)C(F)(F)C*)C(F)(F)OC(F)(F)C(F)(F)C*] 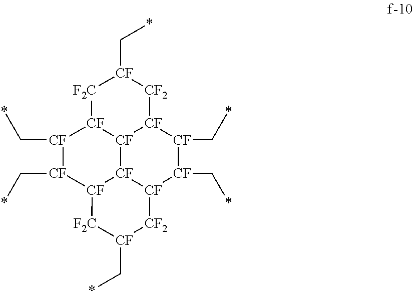
in f-1 to f-10, * represents a position where -(L)ₘ-Y is bonded.

8. The heat-shielding material according to claim 1,
wherein the low refractive index layer, the substrate, and the metal particle-containing layer are laminated in this order.

9. The heat-shielding material according to claim 1,
wherein the low refractive index layer, the substrate, the metal particle-containing layer, and a glass for a window glass are laminated in this order.

10. The heat-shielding material according to claim 1, further comprising:
a hard coat layer between the low refractive index layer and the substrate.

11. A window glass comprising:
the heat-shielding material according to claim 1.
